(19) United States
(12) Patent Application Publication
(10) Pub. No.: US 2025/0229865 A1
(43) Pub. Date: Jul. 17, 2025

(54) RIDING BAG TRANSPORT CART/CYCLE

(71) Applicant: Eric W. Reimers, Missoula, MT (US)

(72) Inventors: Eric W Reimers, Missoula, MT (US); Dale H. Truett, Missoula, MT (US)

(21) Appl. No.: 19/031,706

(22) Filed: Jan. 18, 2025

Related U.S. Application Data
(63) Continuation-in-part of application No. 18/406,429, filed on Jan. 8, 2024.
Application No. 18/406,429 is a continuation of application No. 17/582,076, filed on Jan. 24, 2022, now Pat. No. 11,866,125.
Application No. 17/582,076 is a continuation of application No. 16/423,025, filed on May 26, 2019, now Pat. No. 11,260,935.
(60) Provisional application No. 62/677,332, filed on May 29, 2018.
(60) Provisional application No. 62/677,315, filed on May 29, 2018.

(51) Int. Cl. B62M 6/45; B62J 1/08; B62J 11/05; B62K 11/02; B62K 11/14; B62M 6/70

(52) U.S. Cl. CPC B62M 6/45; B62J 1/08; B62J 11/05; B62K 11/02; B62K 11/14; B62M 6/70

(57) ABSTRACT

A rideable golf cart adapted to transport a rider and a golf bag for use on a golf course. The cart includes a frame and a seat, a front wheel and steering components, a rear wheel, a bag support structure, and a motor/control subassembly.

This application is a continuation-in-part application of U.S. nonprovisional application Ser. No. 18/406,429, filed Jan. 8, 2024, which is a continuation of U.S. nonprovisional application Ser. No. 17/582,076, filed Jan. 24, 2022, now U.S. Pat. No. 11,866,125, which is a continuation of U.S. nonprovisional application Ser. No. 16/423,025, filed on May 26, 2019, now U.S. Pat. No. 11,260,935, which claims the benefit of U.S. provisional applications No. 62/677,332 and 62/677,315 by the same inventors, filed May 29, 2018.

### TECHNICAL FIELD

The present invention relates generally to accessories for golfers and particularly to personal power-assisted golf bag carts and methods for transporting golf bags and the golfer.

### BACKGROUND OF THE INVENTION

Although the purists in the golf community insist that the only way to properly play golf is to carry the golf bag, either personally or through the use of a caddy, many golfers prefer to use carts to transport the golf bags and associated equipment. While riding carts are required by many courses, a great number of players desire to gain at least some of the exercise benefits of more compact and efficient means of transporting themselves and their equipment during the round while avoiding the often higher costs of renting a multiplayer cart from the course. For this reason walking carts are popular, but a riding personal cart would be even better for those who wish to limit their exertions.

For many years pull carts, usually two-wheeled, were the norm. However, powered options, such as electric bag carts are fairly popular and gyroscopic two wheeled units with room for a rider and bag have been introduced.

Nonetheless, demand continues for more compact, more stable, more convenient, and lighter golf bag carts, particularly personal riding powered carts.

### SUMMARY OF THE INVENTION

Accordingly, it is an object of the present invention to provide a riding golf bag cycle, or cart, for transporting a golf bag and rider in a highly stable manner.

Another object of the invention is to provide a riding personal golf cart/cycle which does not cause meaningful damage to fairways, rough, and other “through the green” areas of golf courses.

A further object of the present invention is to provide a riding cart system with convenient support of the golf bag between the legs of the rider.

Yet another object of the invention is to provide a riding powered cart which has a minimal footprint.

Another object of the invention is to provide a riding pedal-powered golf cart which is steerable by the rider and has sufficient power assist available to negotiate typical golf course terrain.

A further object of the present invention is to provide a single passenger riding golf bag cart which partially collapses to a storage mode for transport.

Briefly, one preferred embodiment of the present invention is a personal riding golf cart/cycle adapted to transport a rider and a golf bag. The cart/cycle has the general shape of a two wheeled cycle and/or scooter. The cart/cycle is generally symmetrical about a longitudinal plane and includes a plurality of compatible subassemblies, each providing important functions to the whole. The subassemblies (each also designated as an “sba”) may include: a cycle frame subassembly; a personal support subassembly; a front wheel/steering subassembly; a rear wheel subassembly; a bag support subassembly; a pedal subassembly, a motor-assist subassembly and a control subassembly. In some embodiments the user rides, steers, and controls the speed from a height-adjustable seat having an elevation above approximately the highest point on the front of the rear wheel and above the pedals and a portion of the golf bag. In some embodiments the golf bag and its contents are supported at an angle between the golfer's legs, which extend downward to pedals on either side of the frame. An electrical power-assist motor may be situated in the rear wheel hub is powered by a battery mounted on the frame and is controlled by control elements mounted on the steering unit. Portions of the personal riding golf cart/cycle are collapsible for convenient transport and storage.

An advantage of the present invention is that it provides a simple, relatively lightweight, and comfortable single user powered riding golf cart which in some embodiments functions like a pedal-powered bicycle, but may include a motor assist for climbing hills and negotiating difficult terrain. Another advantage of the invention is that in some embodiments it is bilaterally symmetrical and relatively thin such that multiple units may be parked in a smaller space than conventional riding carts.

A further advantage of the invention is that a single passenger cart significantly improves the speed of playing a round, since it is not necessary to deal with two balls in play in widespread separations.

Yet another advantage of the present invention is that the cycle structure provides a familiar and comfortable means of transport for the golfer and equipment around the golf course.

Still another advantage of the present invention is that its wide tires minimize potential damage to turf and thus may be considered by many courses to be usable on the fairways and rough (grass covered portions) of the course, rather than restricted to cart paths, thus drastically aiding the comfort of the golfer and reducing the time taken to play a round of golf.

Another advantage of the present invention is that embodiments having partially collapsible aspects make it convenient for transport between home and also at the golf course and locations, rather than exclusively for storage at the course, although the preferred embodiment is adapted to transport on common bike-carriers.

A still further embodiments an advantage of the present riding golf bag cart/cycle invention is that no straps or similar restraints are usually necessary to keep the golf bag in place and provide easy access to the clubs during use, although such straps or similar restraints may be provided for some embodiments.

Yet another advantage of some embodiments is that the open frame of the bag support subassembly permits easy access to the pockets of the golf bag, so that the golfer may store and retrieve golf balls and accessories.

Another advantage of the present invention is that it provides the “feel” and locational convenience of a walking round, with significantly less stress or wear and tear on the golfer's body.

Still another advantage of some embodiments of the present invention is that it may be operated using only pedal power, using only motor power, or both together, depending on the terrain and the desires of the rider.

An additional advantage of the present invention is that the limited power of the motor component facilitates the use of the cart/cycle on streets so that the rider can use it for transport other than on a golf course.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended

FIG. 1 is a front right elevational view of the riding cycle golf bag cart of the present invention, illustrating (in phantom) a golf bag carried thereon;

FIG. 2. is a left elevational view of the riding cycle golf bag cart of the present invention;

FIG. 3 is a right side elevational view of the present invention;

FIG. 4 a rear right side perspective view of the presently preferred embodiment of the invention;

FIG. 5. is a front elevational view of the invention;

FIG. 6. is a rear elevational view of the rideable golf bag cart/cycle of the present invention, showing a rider in phantom;

FIG. 7 is a top view of the preferred embodiment;

FIG. 8 is a bottom view; and

FIG. 9 is a front view, similar to FIG. 5, showing the collapsed mode of the invention.

FIG. 10A is a partial perspective view of an embodiment;

FIG. 10B is a partial perspective view of an embodiment;

FIG. 11A is a partial perspective cross-sectional view of an embodiment;

FIG. 11B is a partial perspective view of an embodiment;

FIG. 11C is a partial perspective view of an embodiment;

FIG. 12 is a front left perspective view of a powered riding golf bag cart/cycle of an alternate embodiment of the invention, illustrating a silhouette of a golf bag carried thereon;

FIG. 13 is a top rear left side perspective view of an alternate embodiment of the invention;

FIG. 14 is a cut away view of the invention, showing a frame tube to base segment connection;

FIG. 15 is a front left perspective view of an alternate embodiment of the invention, showing the frame tube to running board connection;

FIG. 16 is a top rear left side perspective view of the present invention;

FIG. 17 is a partial cut away view of an alternate embodiment of the invention, showing a shock absorber within a shock absorber housing;

FIG. 18 is a partial front left perspective view of an alternate embodiment of the invention, showing a handlebar assembly;

FIG. 19 is a top rear left side view of an alternate embodiment of the invention, showing a frame assembly;

FIG. 20 is a front left perspective view of the powered riding golf bag cart/cycle in a folded state;

FIG. 21 is a left elevational view of the riding golf bag cart/cycle of the invention, showing a golf bag silhouette;

FIG. 22 is a top view of the invention, shown without a golf bag;

FIG. 23 is a left elevation view of the powered riding golf bag cart/cycle in a folded state;

FIG. 24 is a top view of the invention, in a folded state;

FIG. 25 is a front left perspective view of an alternate embodiment of powered riding golf bag cart/cycle, illustrating a golf bag carried thereon;

FIG. 26 is a top rear right side perspective view of the present invention, shown with a golf bag;

FIG. 27 is a left elevational view of the riding golf bag cart/cycle of an alternate embodiment, showing the golf bag and a rider silhouette;

FIG. 28A is a top view of the invention, showing a golf bag silhouette;

FIG. 28B is a top view of the invention, showing two golf bag silhouettes;

FIG. 29 is a rear left perspective view of an alternative embodiment of powered riding golf bag cart/cycle;

FIG. 30 is a front elevational view of the alternative embodiment of the invention, showing a golf bag silhouette;

FIG. 31 is a front left perspective view of an alternative embodiment of powered riding golf bag cart/cycle;

FIG. 32 is a front left perspective view of an alternate embodiment of the invention, showing the frame tube to running board connection;

FIG. 33 is a front left perspective view of the invention alternate embodiment, in a folded state;

FIG. 34 is a rear left perspective view of an alternate embodiment of the invention;

FIG. 35A is a partial rear left perspective view of an alternate embodiment of the invention, showing the handle bar assembly;

FIG. 35B is a partial front left perspective view of an alternate embodiment of the invention, showing the handle bars in the non-storage state;

FIG. 35C is a partial left elevation view of an alternate embodiment of the invention, showing the handle bars in the non-storage state;

FIG. 36A is a partial rear left perspective view of an alternate embodiment of the invention, showing the handle bar assembly with rotated pivot tubes;

FIG. 36B is a partial front left perspective view of an alternate embodiment of the invention, showing the rotated pivot tubes;

FIG. 36C is a partial left elevation view of an alternate embodiment of the invention, showing the rotated pivot tubes;

FIG. 37A is a partial rear left perspective view of an alternate embodiment of the invention, showing the handle bar assembly with rotated pivot tubes and forward rotated handlebars;

FIG. 37B is a partial front left perspective view of an alternate embodiment of the invention, showing the handle bar assembly with forward rotated pivot tubes and forward rotated handlebars;

FIG. 37C is a partial left elevation view of an alternate embodiment of the invention, showing the handle bar assembly with forward rotated pivot tubes and forward rotated handlebars;

FIG. 38A is a partial rear left perspective view of an alternate embodiment of the invention, showing the handle bar assembly with rotated pivot tubes and forward rotated handlebars and forward rotated upper bag cradle;

FIG. 38B is a partial front left perspective view of an alternate embodiment of the invention, showing the handle bar assembly with rotated pivot tubes and forward rotated handlebars and forward rotated upper bag cradle;

FIG. 38C is a partial left elevation view of an alternate embodiment of the invention, showing the handle bar assembly with rotated pivot tubes and forward rotated handlebars and forward rotated upper bag cradle;

FIG. 39 is a front elevational view of an alternate embodiment of the invention, shown with a golf bag;

FIG. 40 is a rear elevational view of an alternate embodiment of the invention, shown with a golf bag;

FIG. 41 is a left elevational view of an alternate embodiment of the invention, shown with a golf bag;

FIG. 42 is a top view of an alternate embodiment of the invention, shown with a golf bag;

FIG. 43 is a front left perspective view of the invention alternate embodiment, in a folded state;

FIG. 44 is a left elevation view of the invention alternate embodiment, in a folded state;

FIG. 45 is a top view of the invention alternate embodiment, in a folded state;

FIG. 46 is a front left perspective view of the invention alternate embodiment, showing a golf bag;

FIG. 47 is a front elevational view of an alternate embodiment of the invention, shown with a golf bag;

FIG. 48 is a rear elevational view of an alternate embodiment of the invention, shown with a golf bag;

FIG. 49 is a right elevation view of an alternate embodiment of the invention, shown with a golf bag;

FIG. 50 is a left elevation view of an alternate embodiment of the invention, shown with a golf bag;

FIG. 51 is a top view of an alternate embodiment of the invention, shown with a golf bag;

FIG. 52 is a bottom view of an alternate embodiment of the invention, shown with a golf bag;

FIG. 53 is a left elevation view of an alternate embodiment of the invention, shown in a folded state;

FIG. 54 is a front left perspective view of the invention alternate embodiment, showing a golf bag;

FIG. 55 is a front elevational view of an alternate embodiment of the invention, shown with a golf bag;

FIG. 56 is a rear elevational view of an alternate embodiment of the invention, shown with a golf bag;

FIG. 57 is a right elevation view of an alternate embodiment of the invention, shown with a golf bag;

FIG. 58 is a left elevation view of an alternate embodiment of the invention, shown with a golf bag;

FIG. 59 is a top view of an alternate embodiment of the invention, shown with a golf bag;

FIG. 60 is a bottom view of an alternate embodiment of the invention, shown with a golf bag;

FIG. 61 is a left elevation view of an alternate embodiment of the invention, shown in a folded state;

FIG. 62 is a front left perspective view of the invention alternate embodiment, showing a golf bag;

FIG. 63 is a front elevational view of an alternate embodiment of the invention, shown with a golf bag;

FIG. 64 is a rear elevational view of an alternate embodiment of the invention, shown with a golf bag;

FIG. 65 is a right elevation view of an alternate embodiment of the invention, shown with a golf bag;

FIG. 66 is a left elevation view of an alternate embodiment of the invention, shown with a golf bag;

FIG. 67 is a top view of an alternate embodiment of the invention, shown with a golf bag;

FIG. 68 is a bottom view of an alternate embodiment of the invention, shown with a golf bag;

FIG. 69 is a left elevation view of an alternate embodiment of the invention, shown in a folded state;

FIG. 70 is a front left perspective view of the invention alternate embodiment, showing a golf bag;

FIG. 71 is a front elevational view of an alternate embodiment of the invention, shown with a golf bag;

FIG. 72 is a rear elevational view of an alternate embodiment of the invention, shown with a golf bag;

FIG. 73 is a right elevation view of an alternate embodiment of the invention, shown with a golf bag;

FIG. 74 is a left elevation view of an alternate embodiment of the invention, shown with a golf bag;

FIG. 75 is a top view of an alternate embodiment of the invention, shown with a golf bag;

FIG. 76 is a bottom view of an alternate embodiment of the invention, shown with a golf bag;

FIG. 77 is a left elevation view of an alternate embodiment of the invention, shown in a folded state;

FIG. 78 is a front left perspective view of the invention alternate embodiment, showing a golf bag;

FIG. 79 is a front elevational view of an alternate embodiment of the invention, shown with a golf bag;

FIG. 80 is a rear elevational view of an alternate embodiment of the invention, shown with a golf bag;

FIG. 81 is a right elevation view of an alternate embodiment of the invention, shown with a golf bag;

FIG. 82 is a left elevation view of an alternate embodiment of the invention, shown with a golf bag;

FIG. 83 is a top view of an alternate embodiment of the invention, shown with a golf bag;

FIG. 84 is a bottom view of an alternate embodiment of the invention, shown with a golf bag;

FIG. 85 is a left elevation view of an alternate embodiment of the invention, shown in a folded state;

FIG. 86 is a front left perspective view of the invention alternate embodiment, showing a golf bag;

FIG. 87 is a front elevational view of an alternate embodiment of the invention, shown with a golf bag;

FIG. 88 is a rear elevational view of an alternate embodiment of the invention, shown with a golf bag;

FIG. 89 is a right elevation view of an alternate embodiment of the invention, shown with a golf bag;

FIG. 90 is a left elevation view of an alternate embodiment of the invention, shown with a golf bag;

FIG. 91 is a top view of an alternate embodiment of the invention, shown with a golf bag;

FIG. 92 is a bottom view of an alternate embodiment of the invention, shown with a golf bag;

FIG. 93 is a left elevation view of an alternate embodiment of the invention, shown in a folded state;

FIG. 94 is a front left perspective view of the invention alternate embodiment, showing a golf bag;

FIG. 95 is a front elevational view of an alternate embodiment of the invention, shown with a golf bag;

FIG. 96 is a rear elevational view of an alternate embodiment of the invention, shown with a golf bag;

FIG. 97 is a right elevation view of an alternate embodiment of the invention, shown with a golf bag;

FIG. 98 is a left elevation view of an alternate embodiment of the invention, shown with a golf bag;

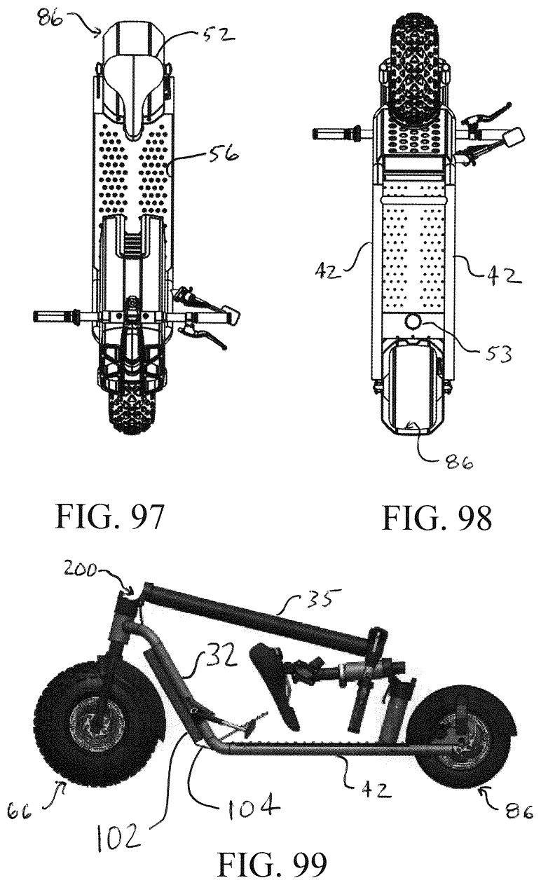

FIG. 97 is a top view of an alternate embodiment of the invention, shown with a golf bag;

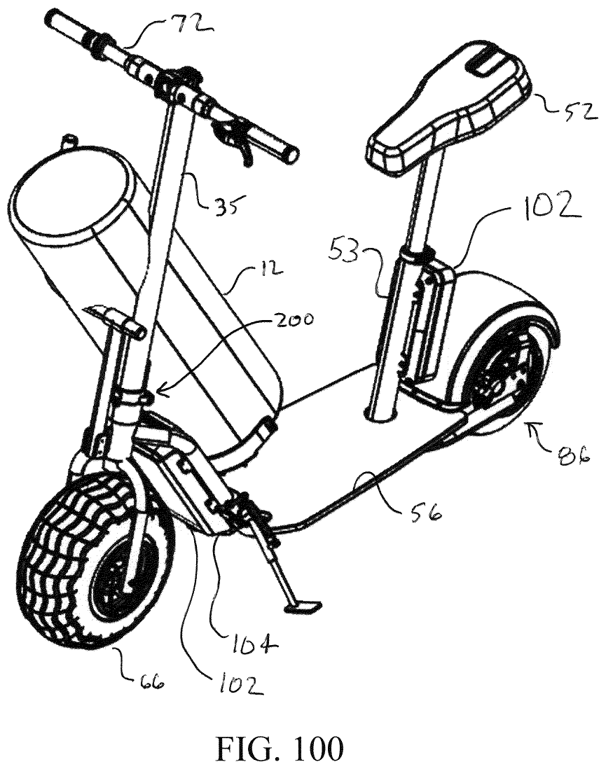

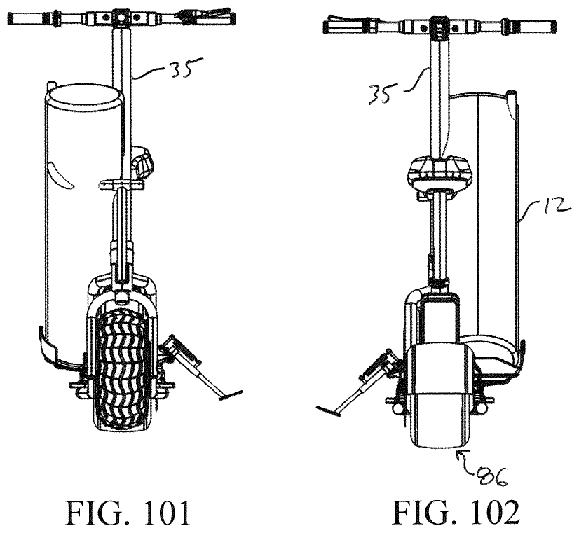

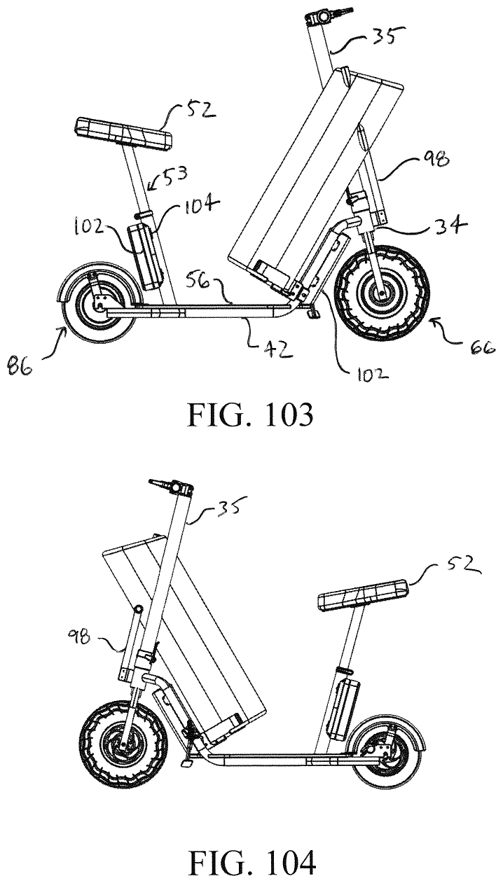

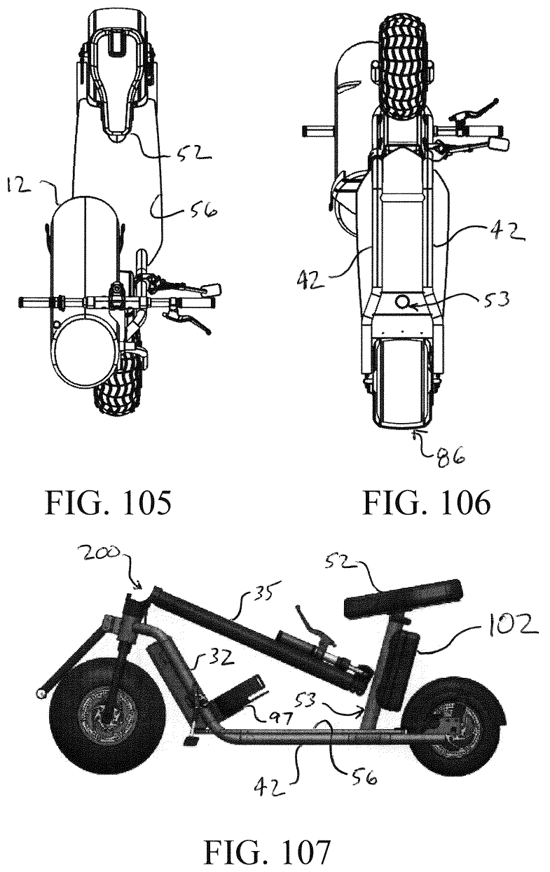

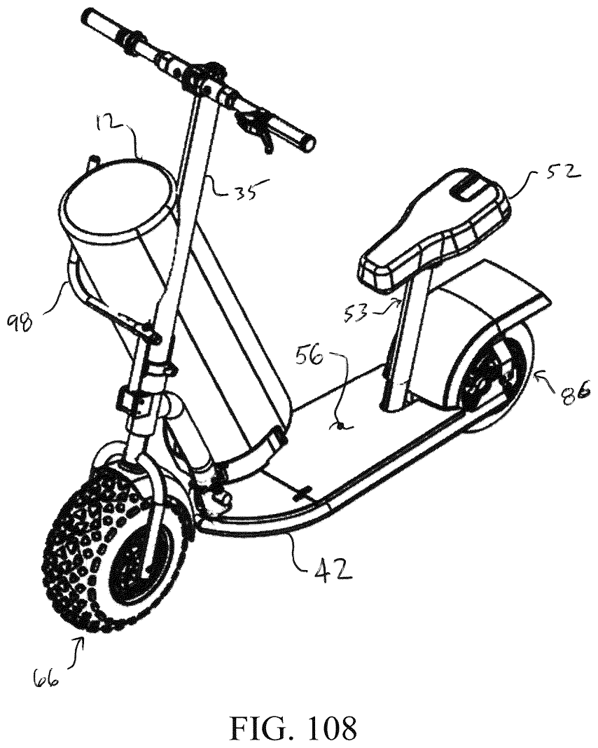

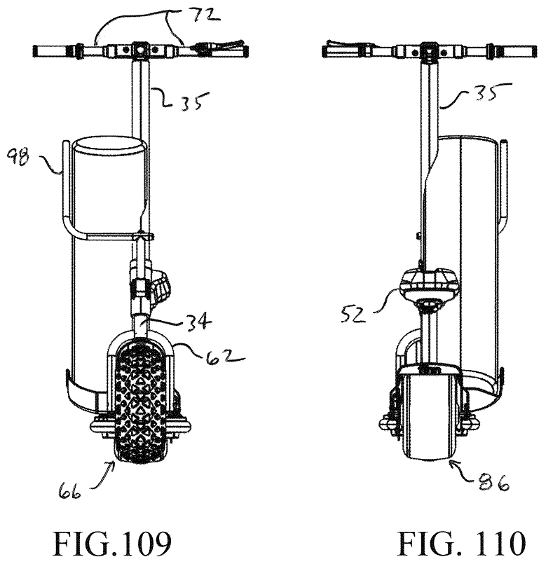

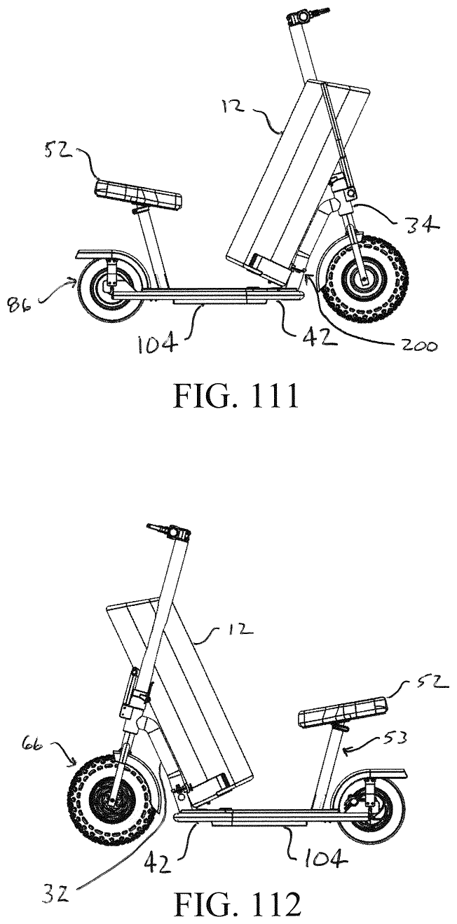

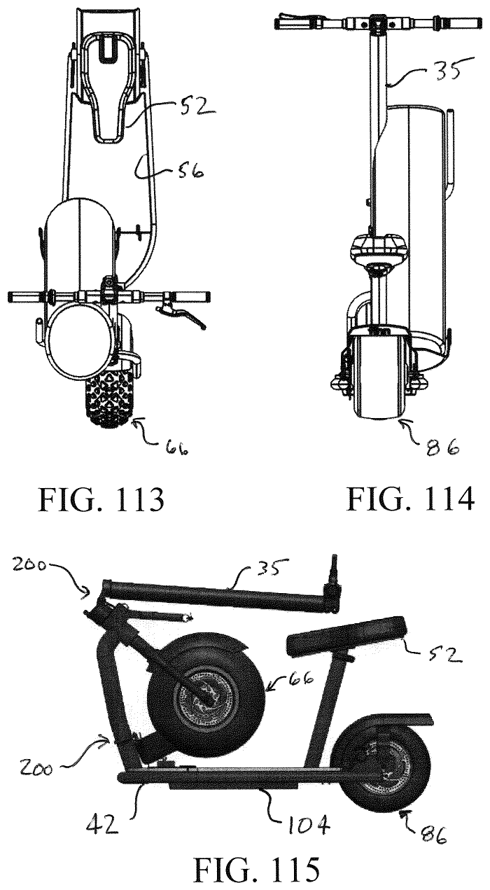

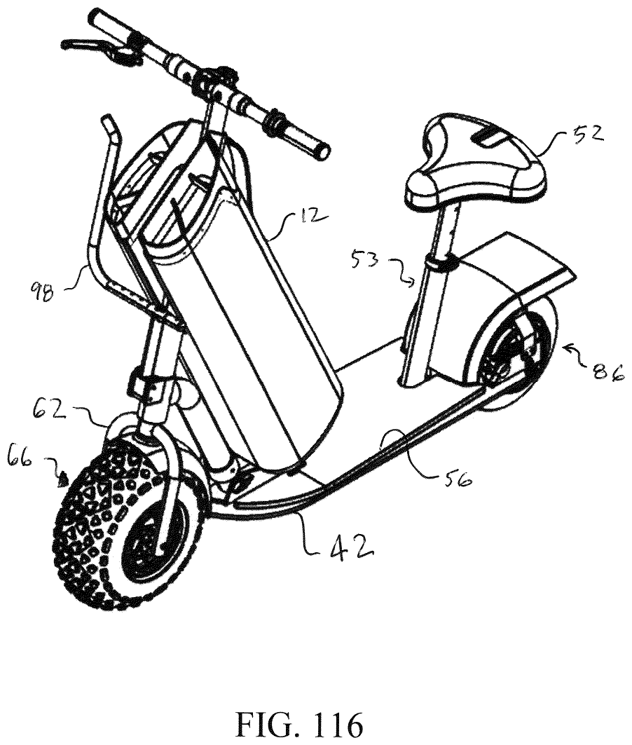

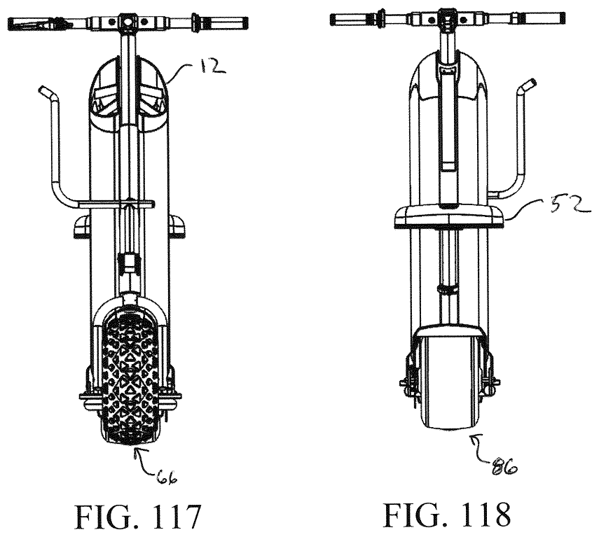

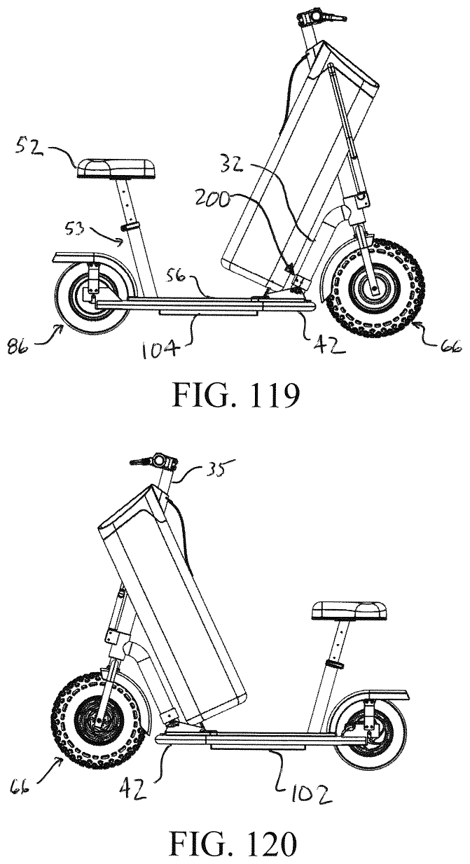

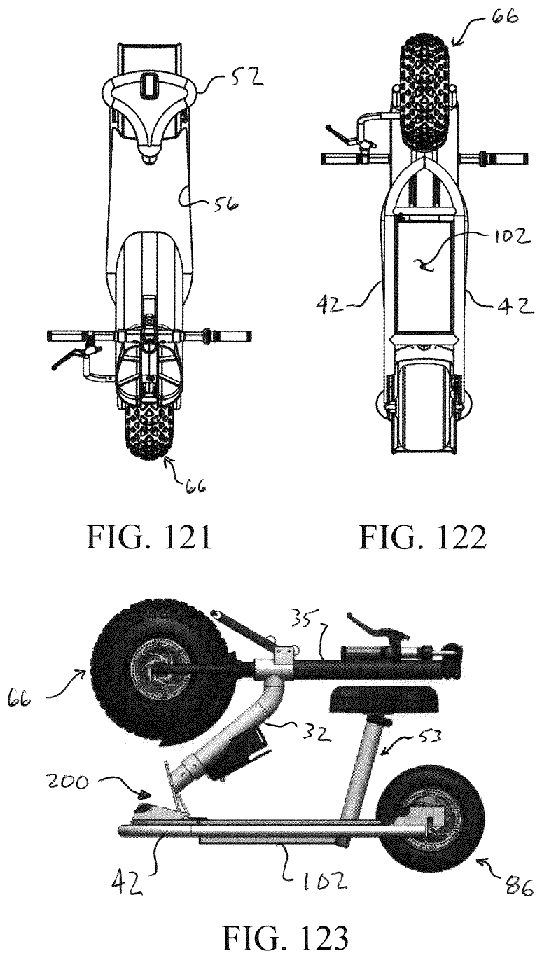

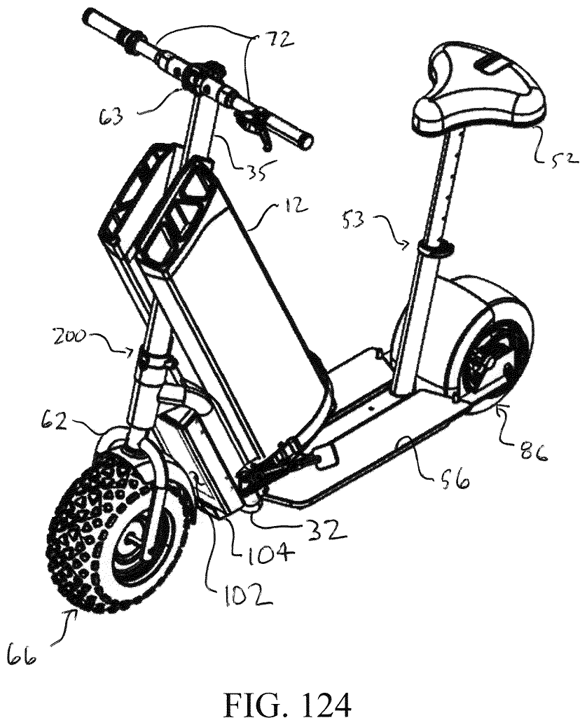

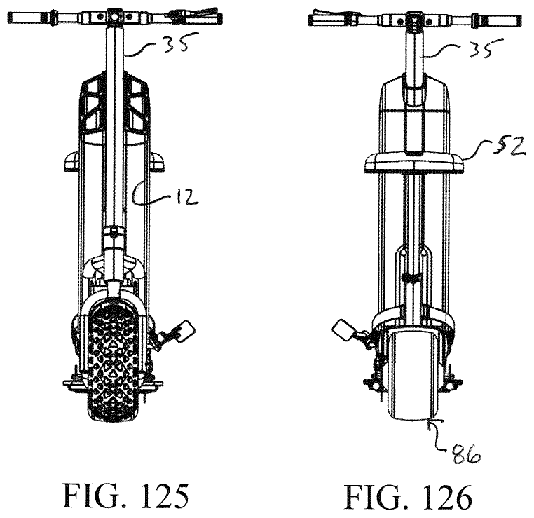

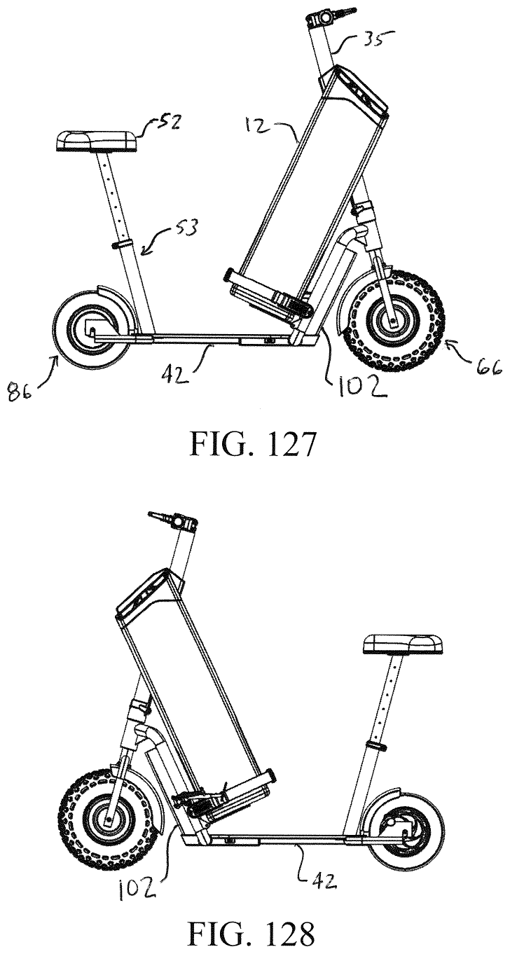

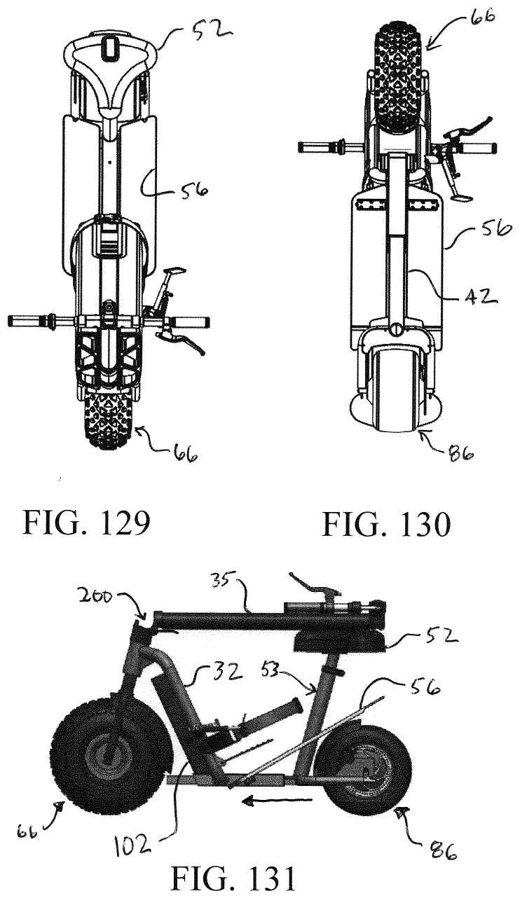

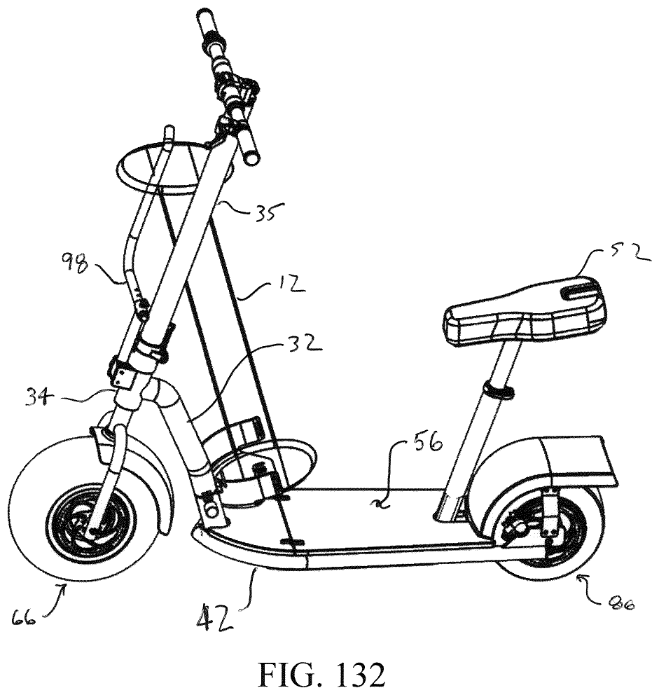

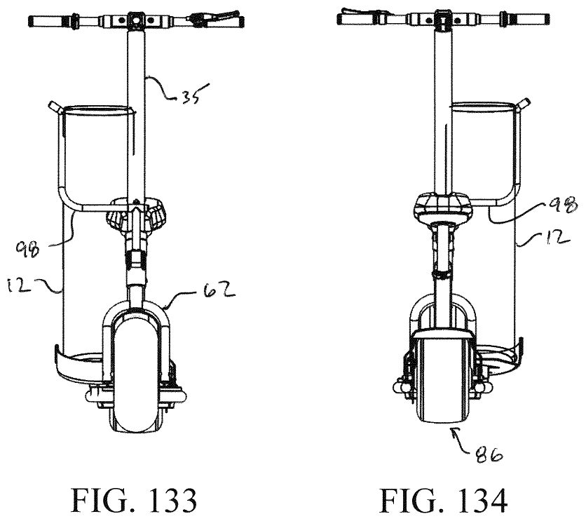

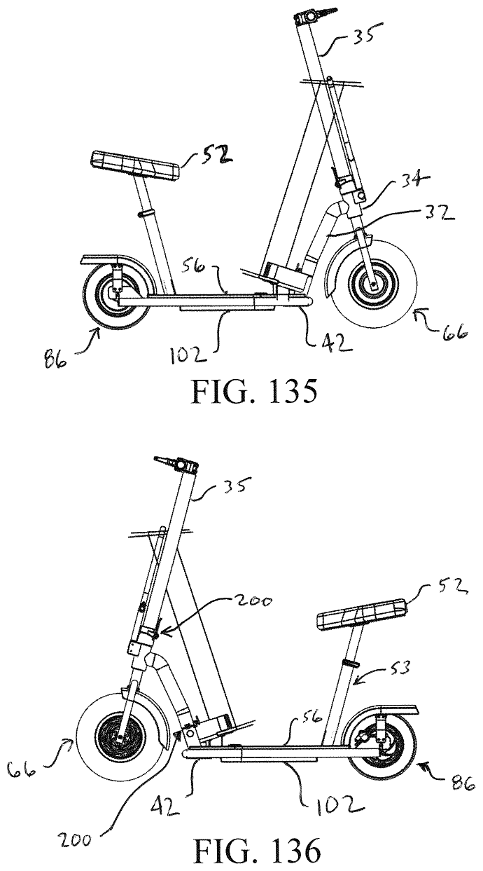

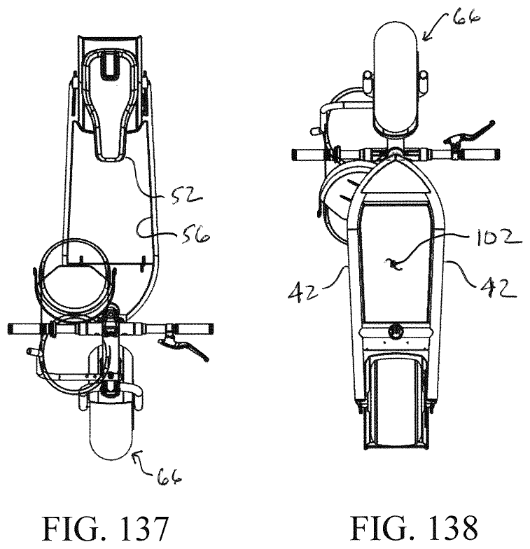

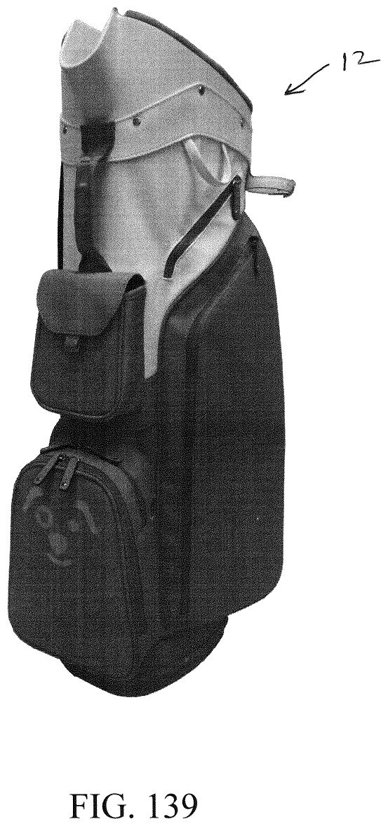

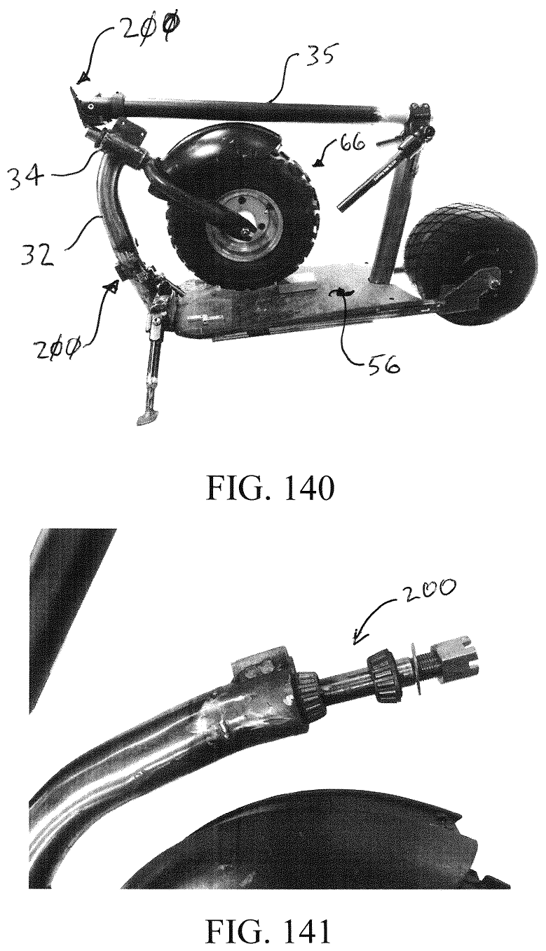

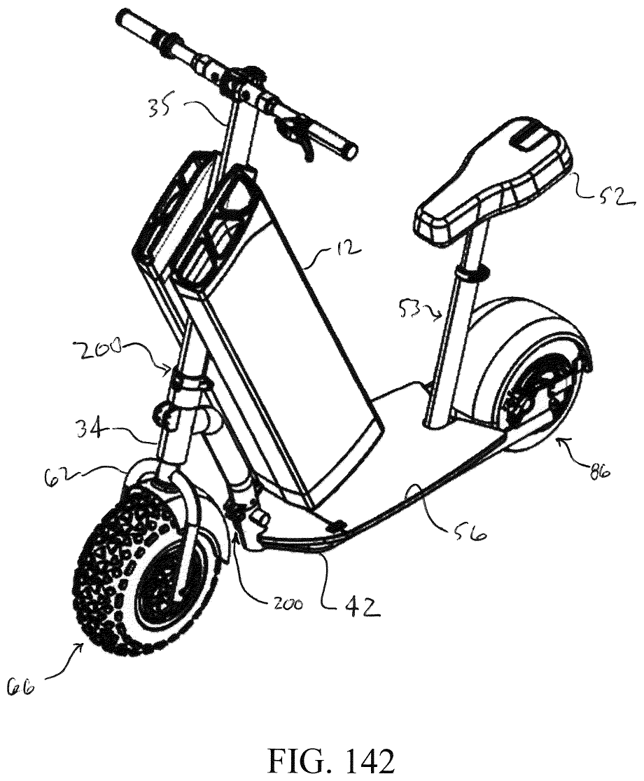

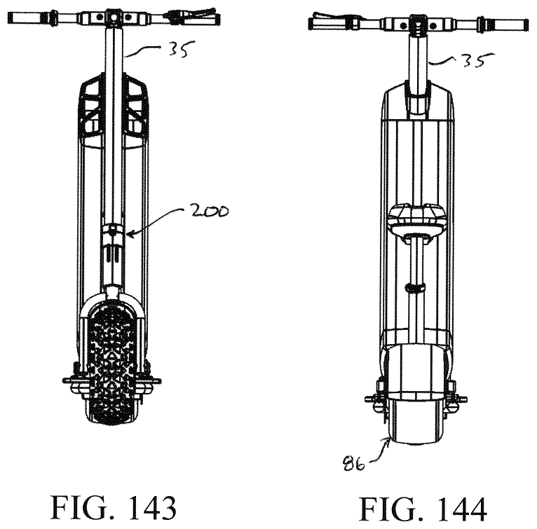

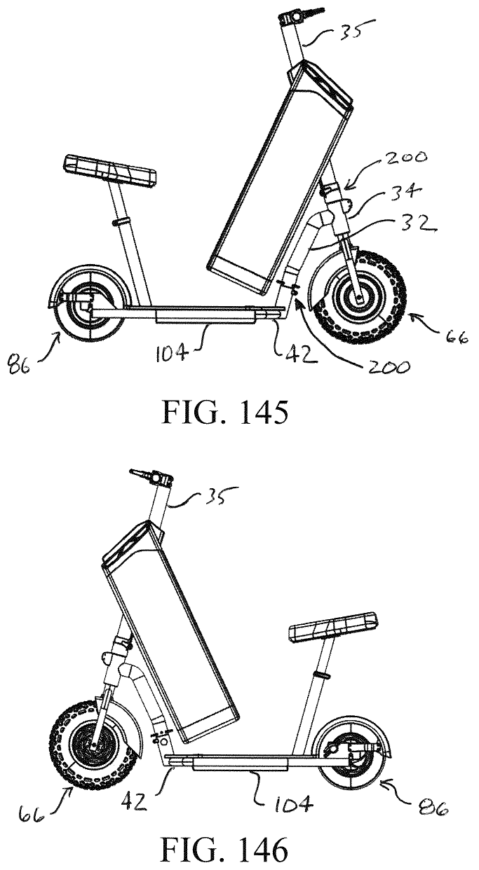

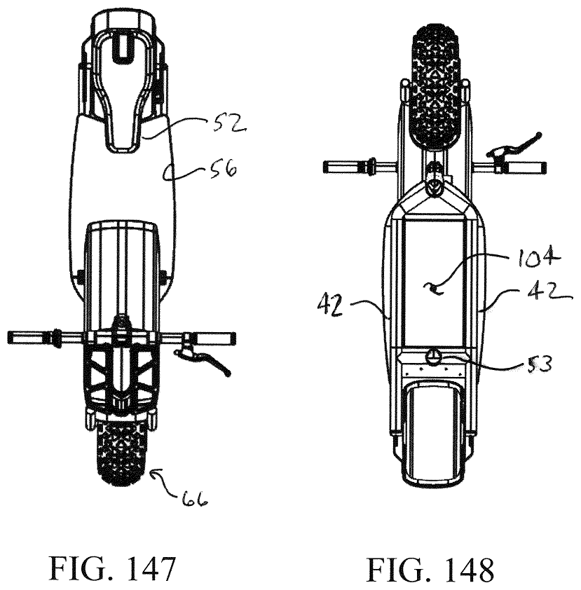

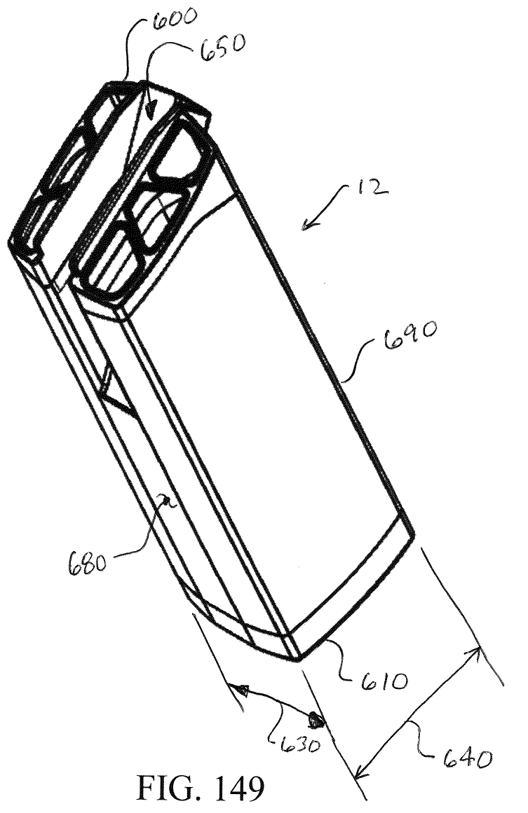

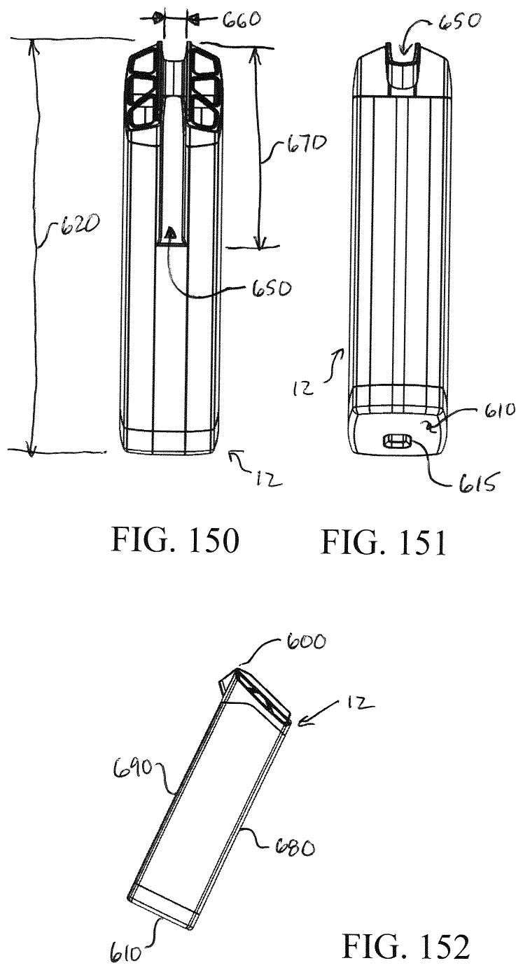

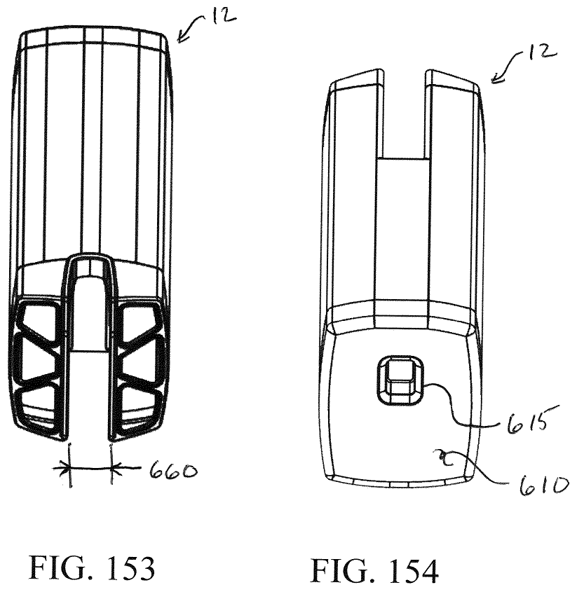

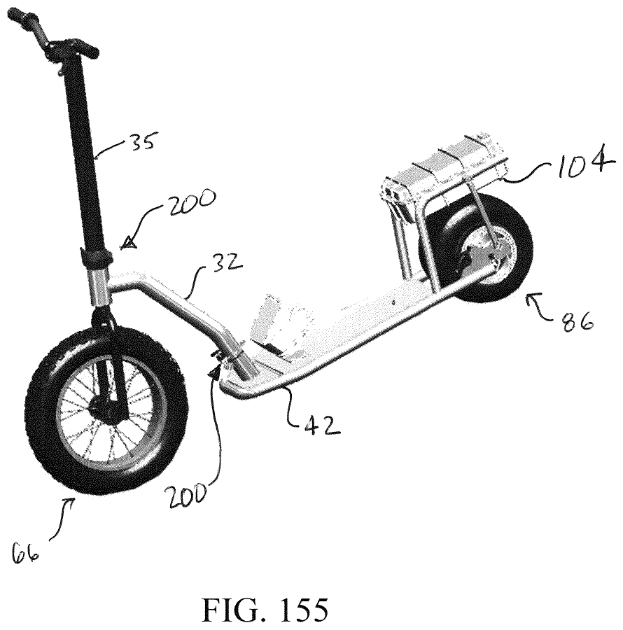

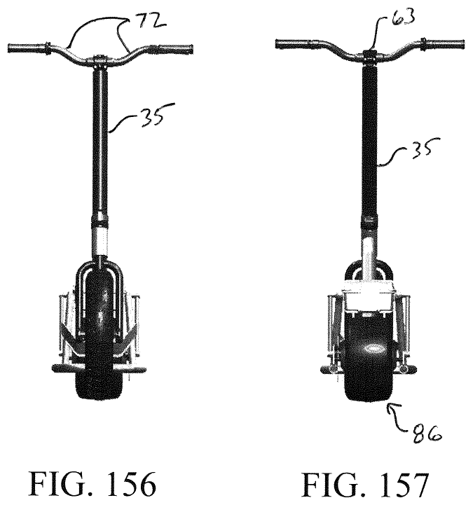

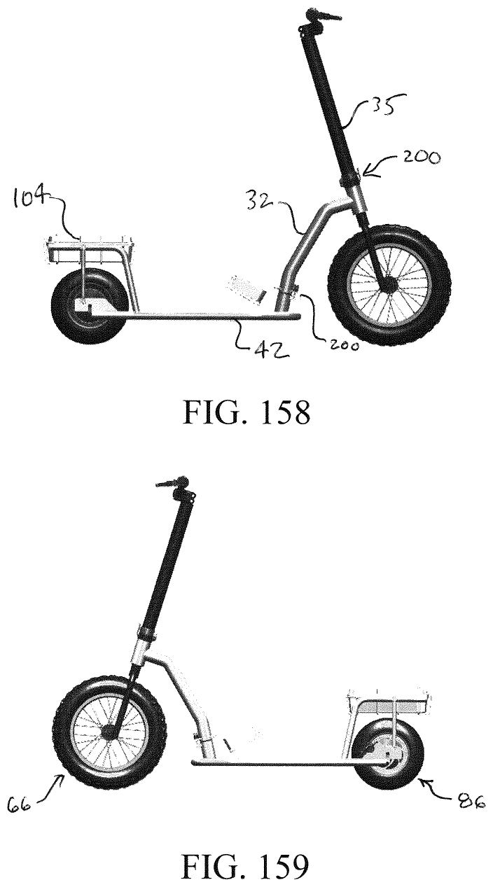

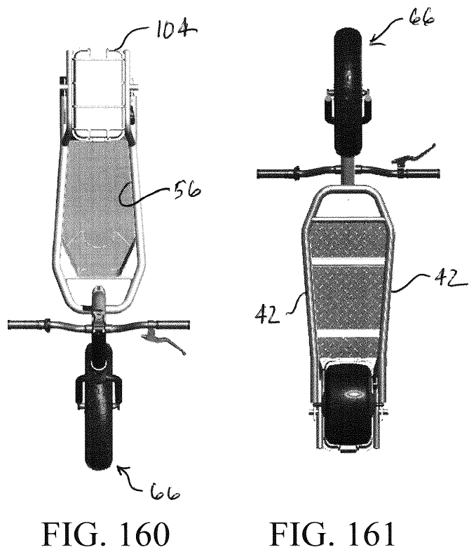

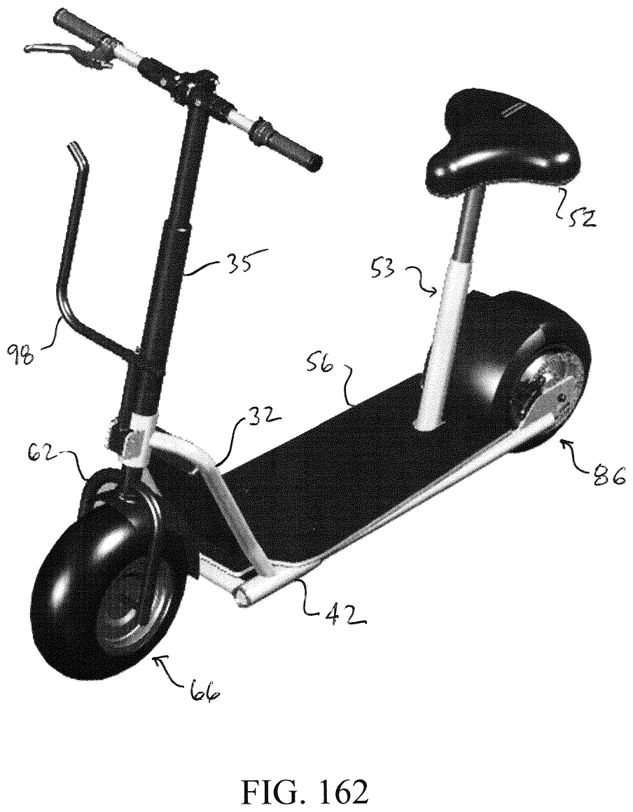

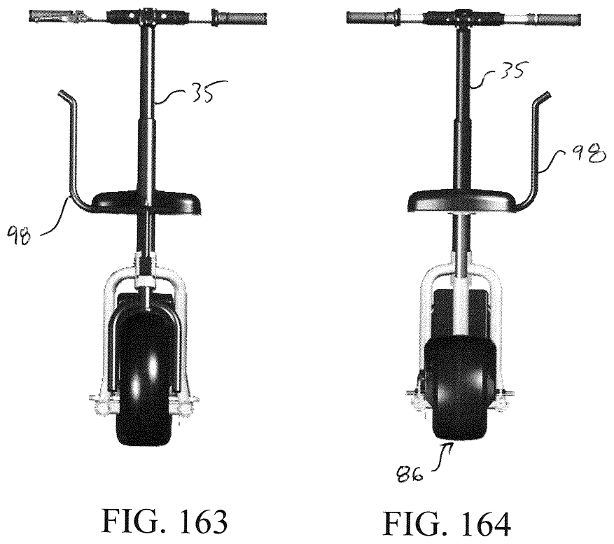

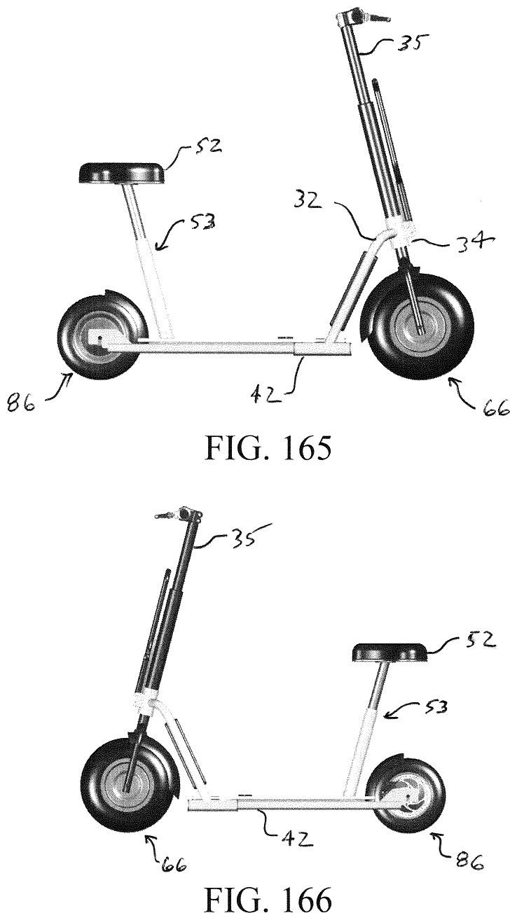

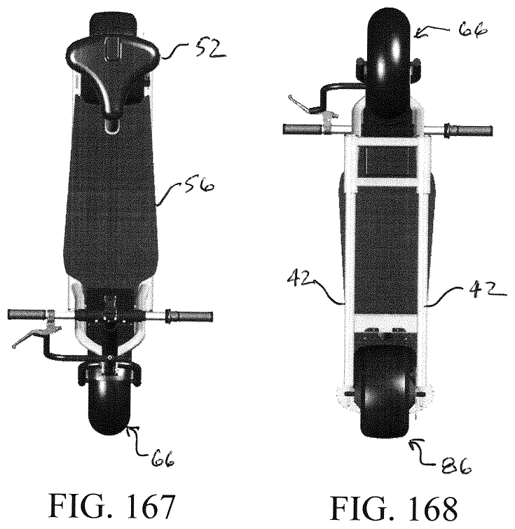

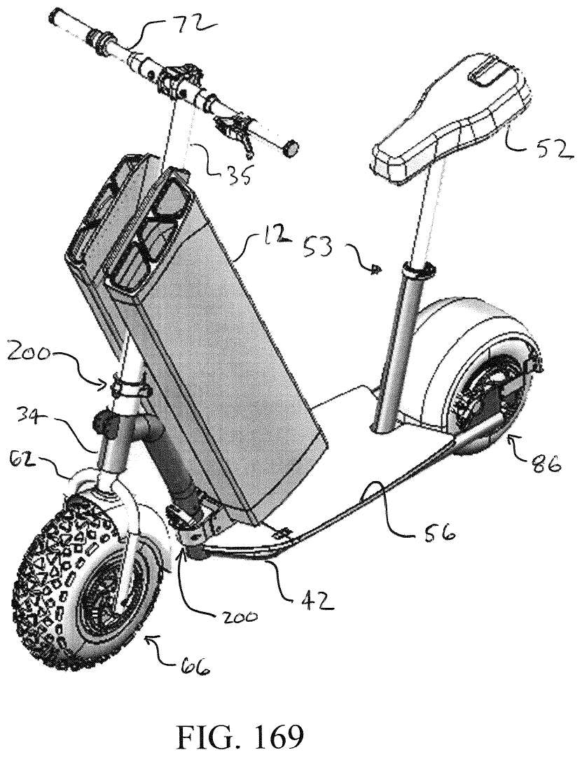

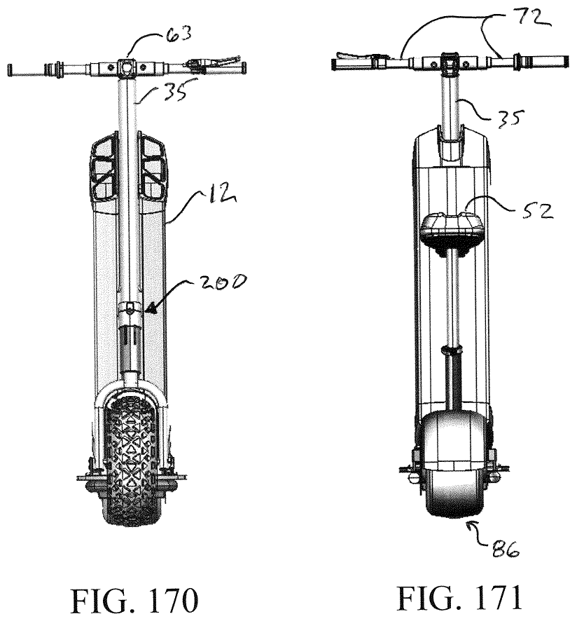

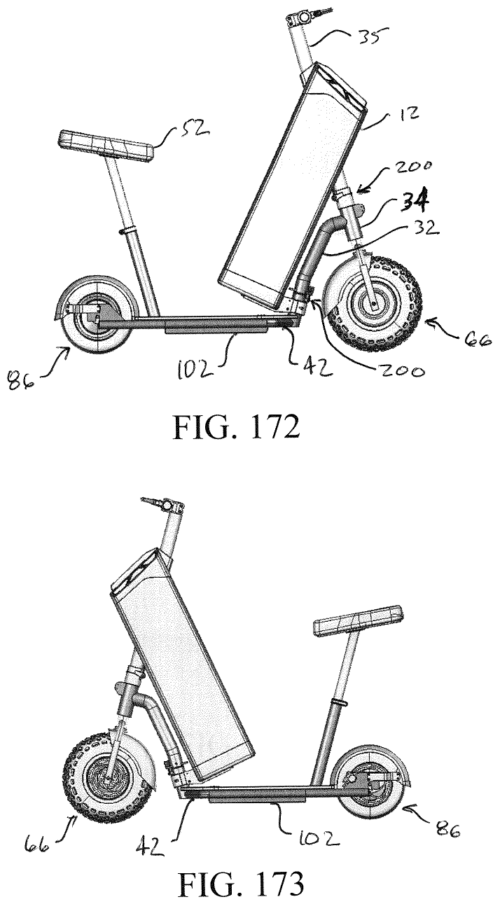

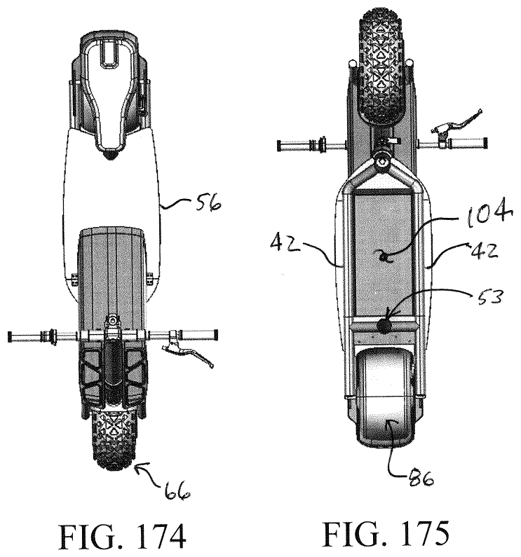

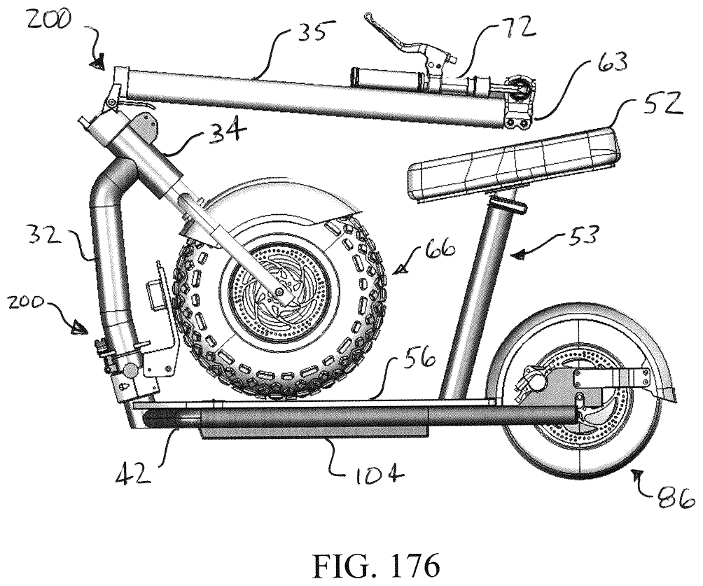

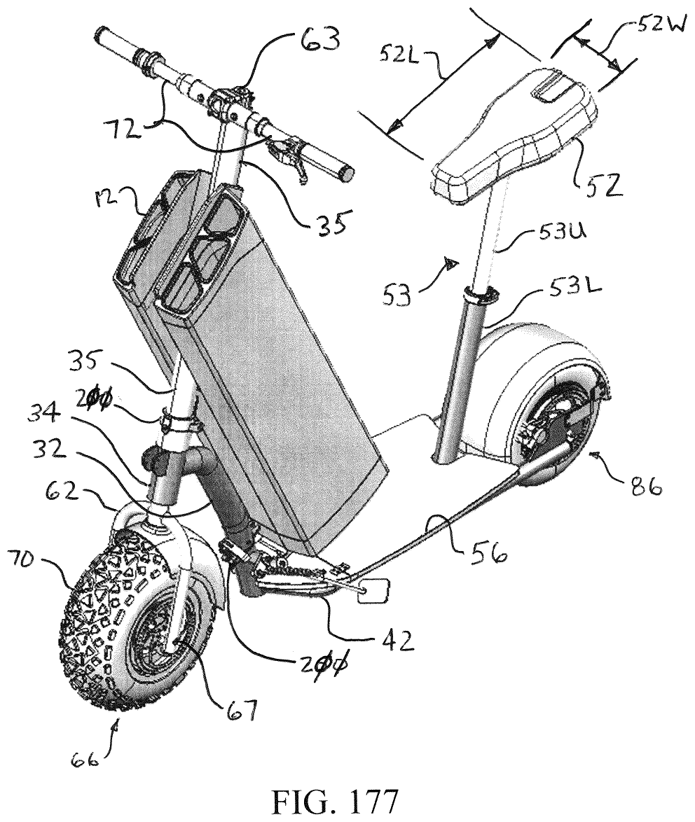

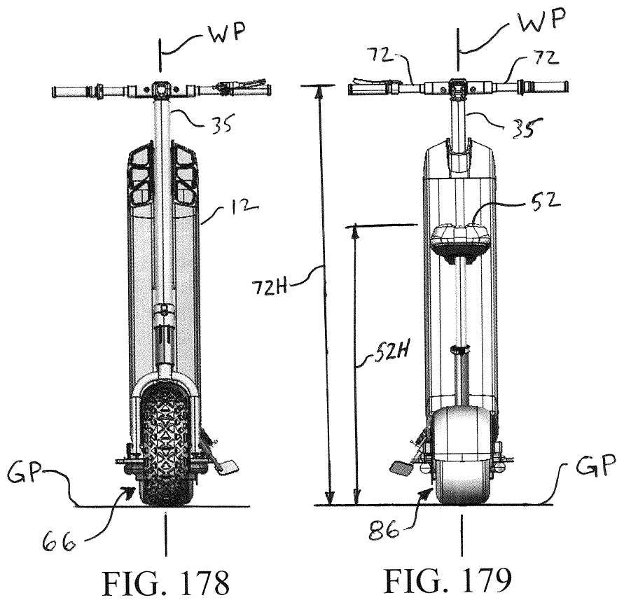

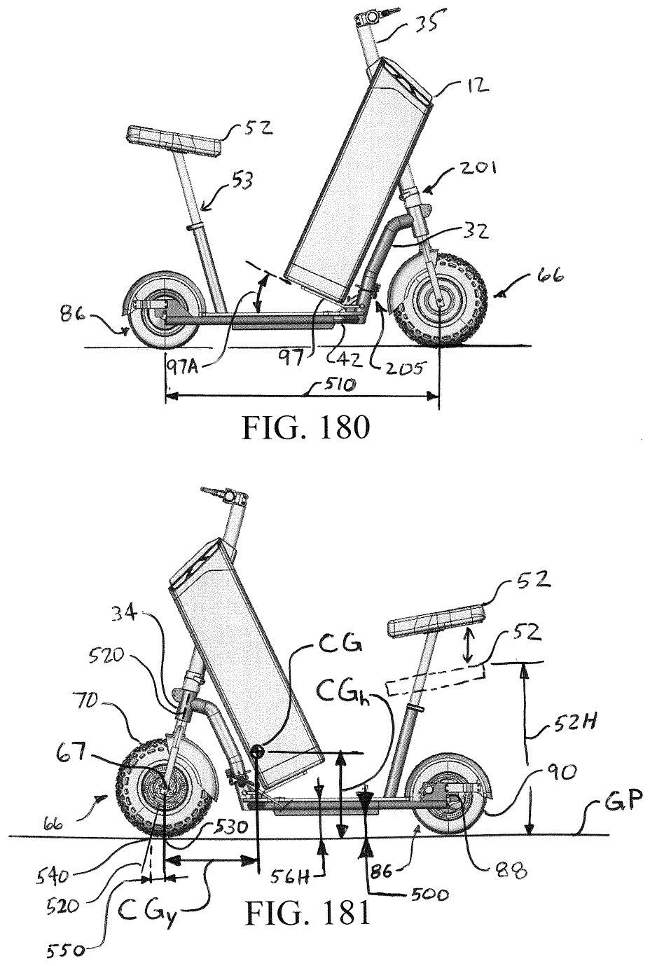

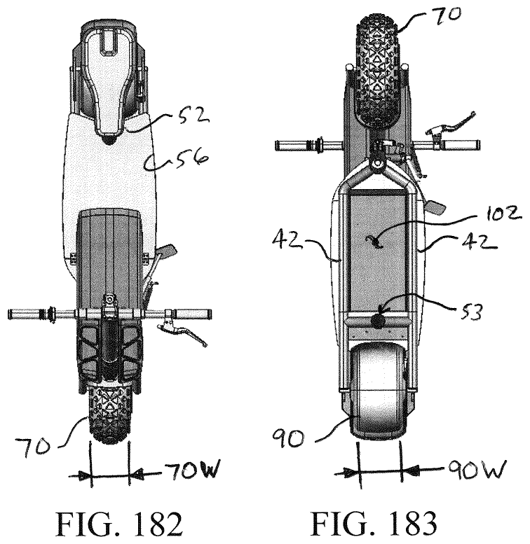

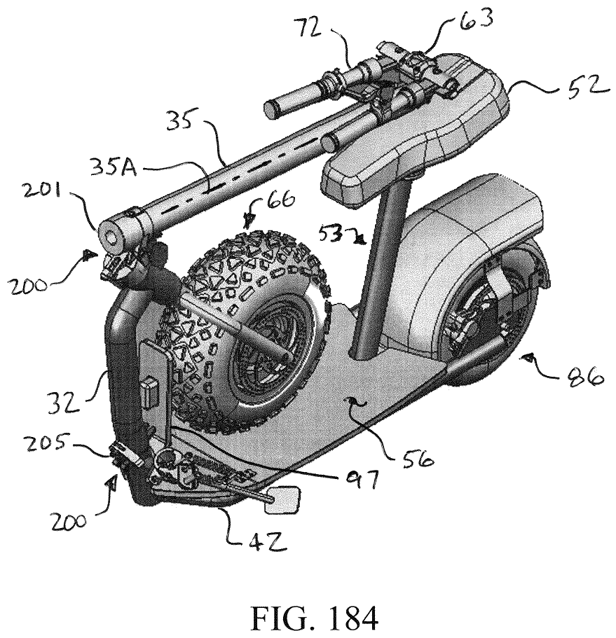

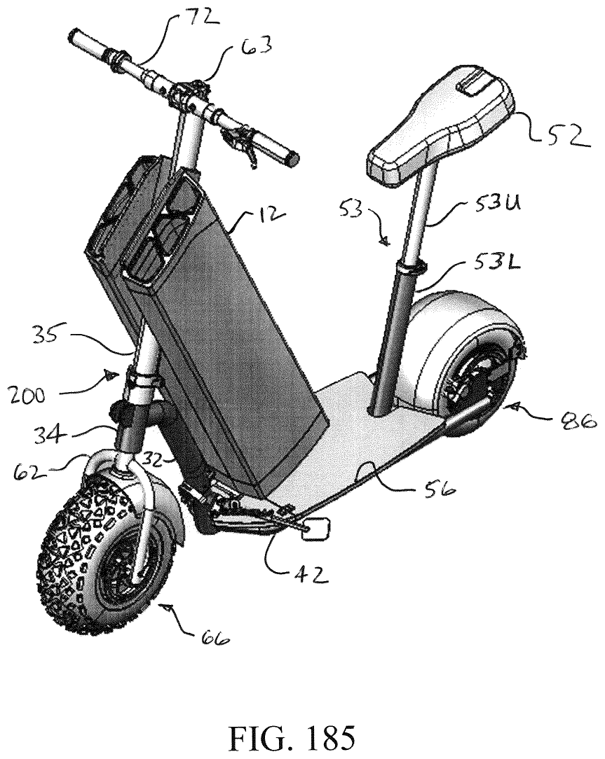

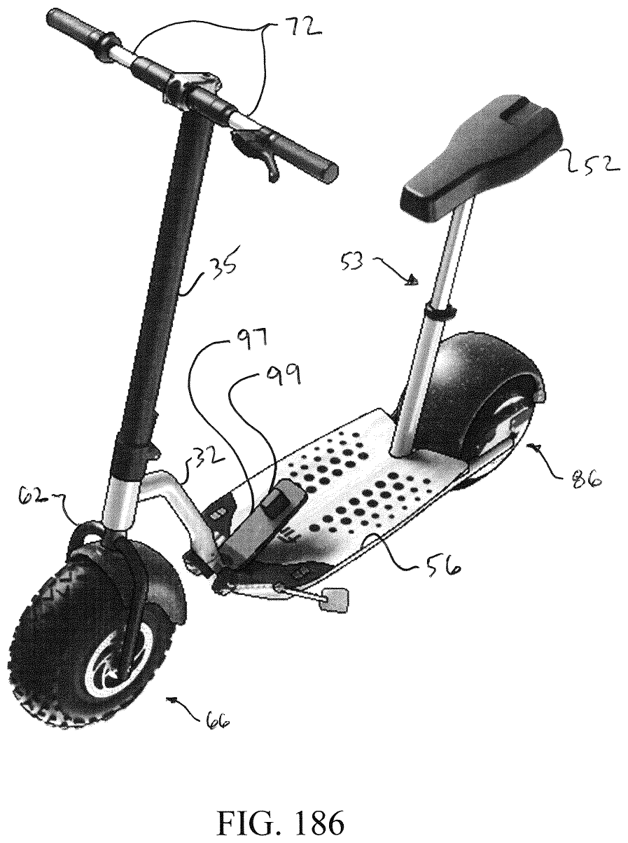

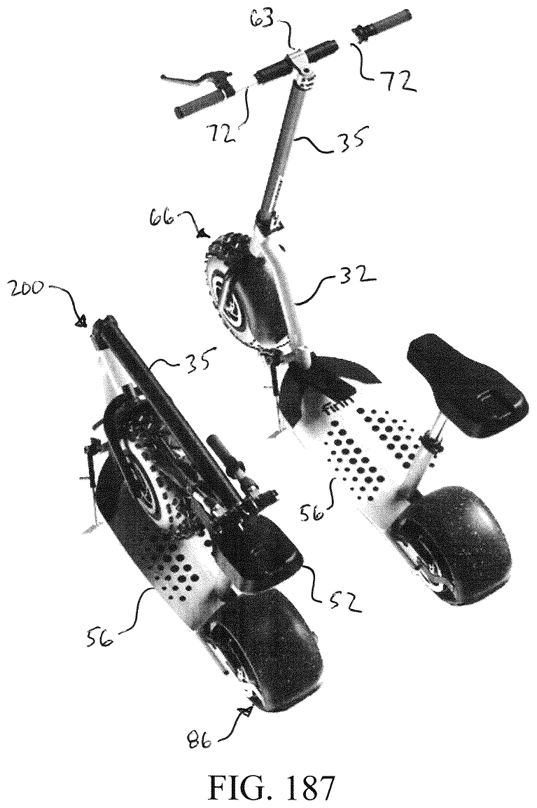

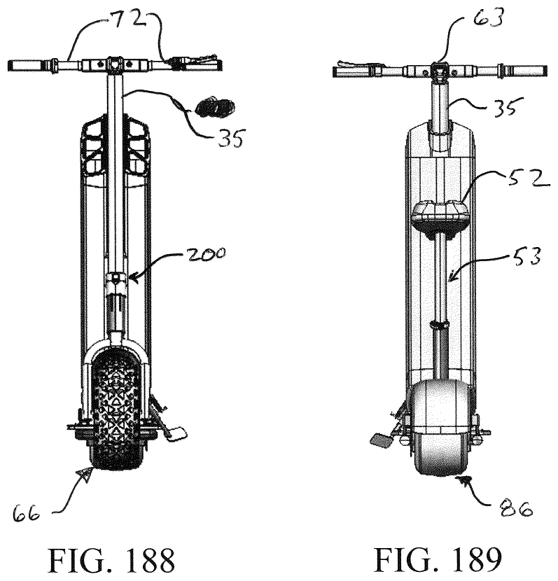

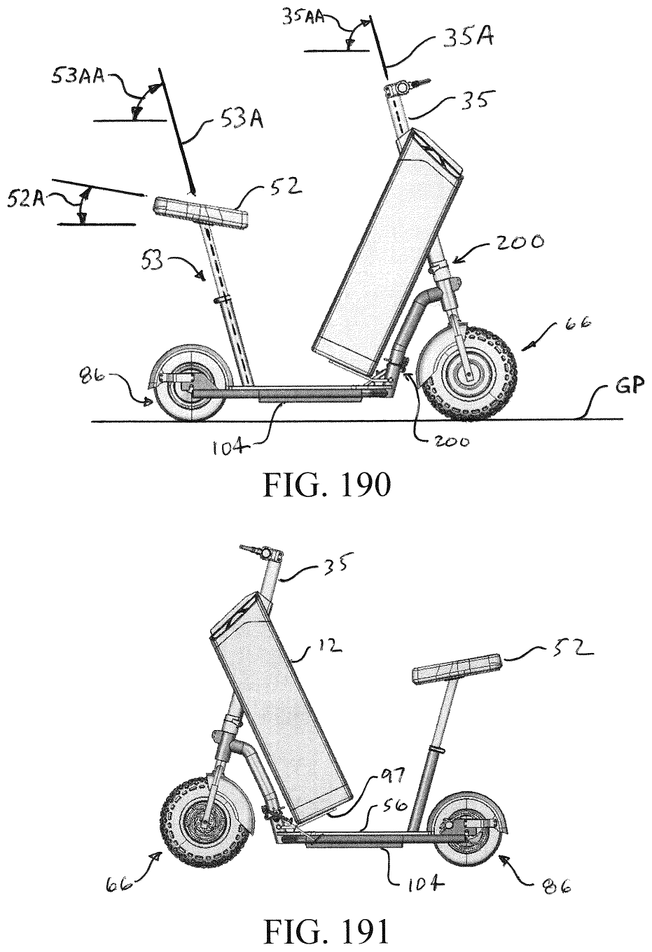

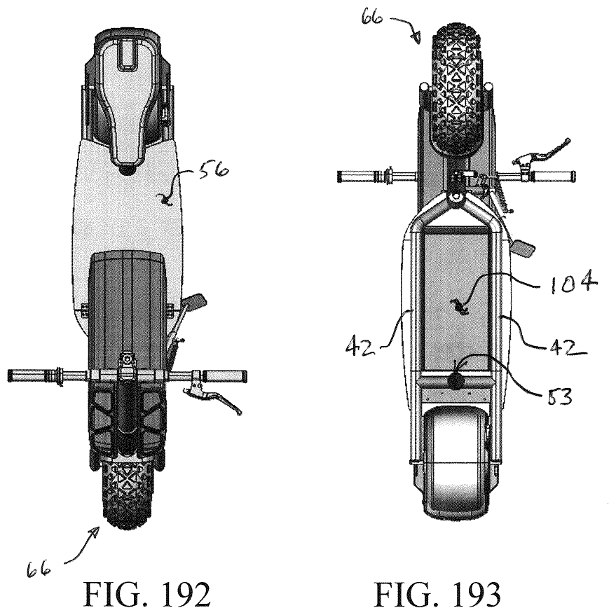

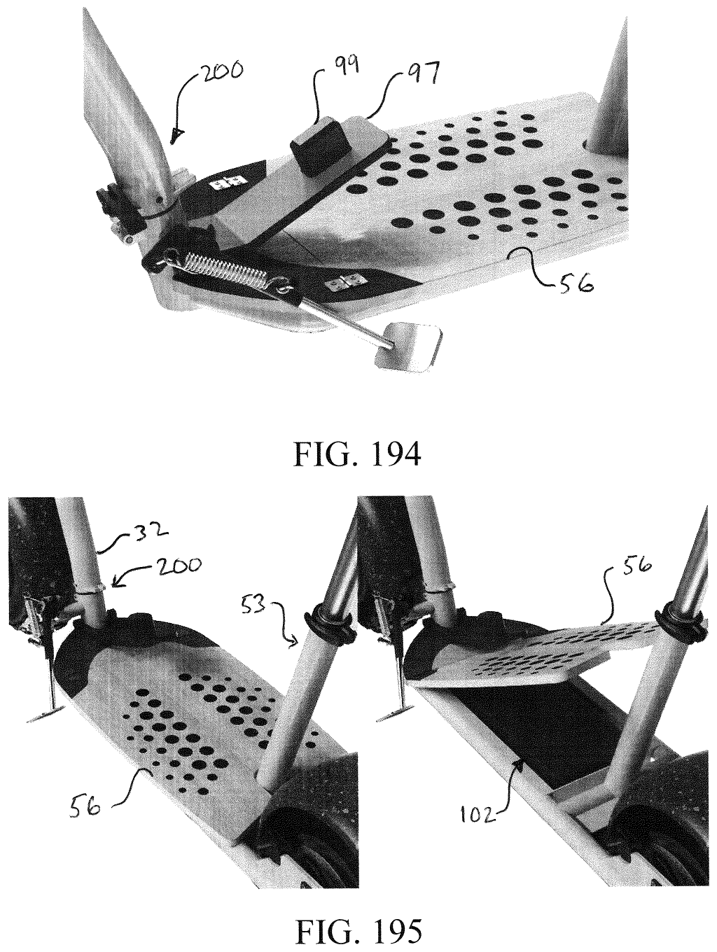

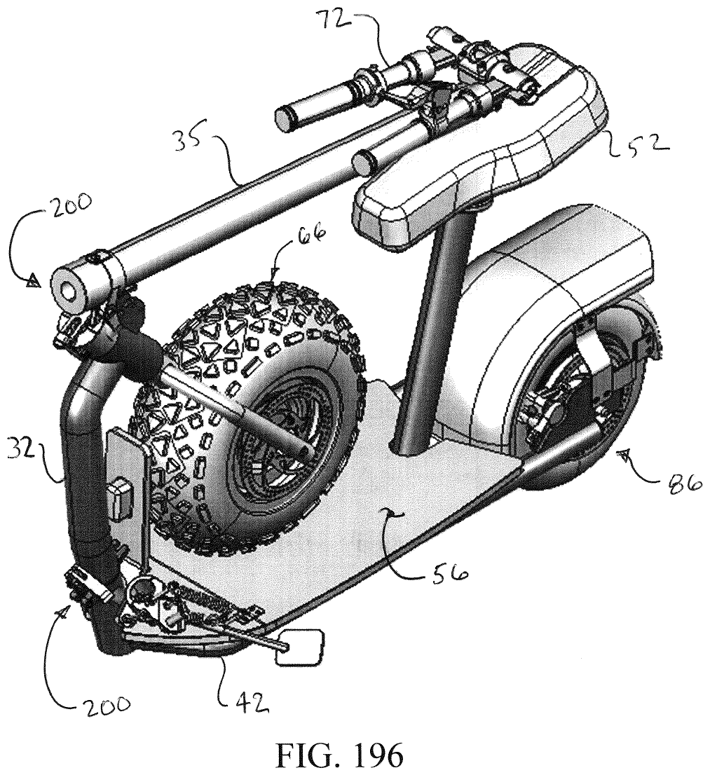

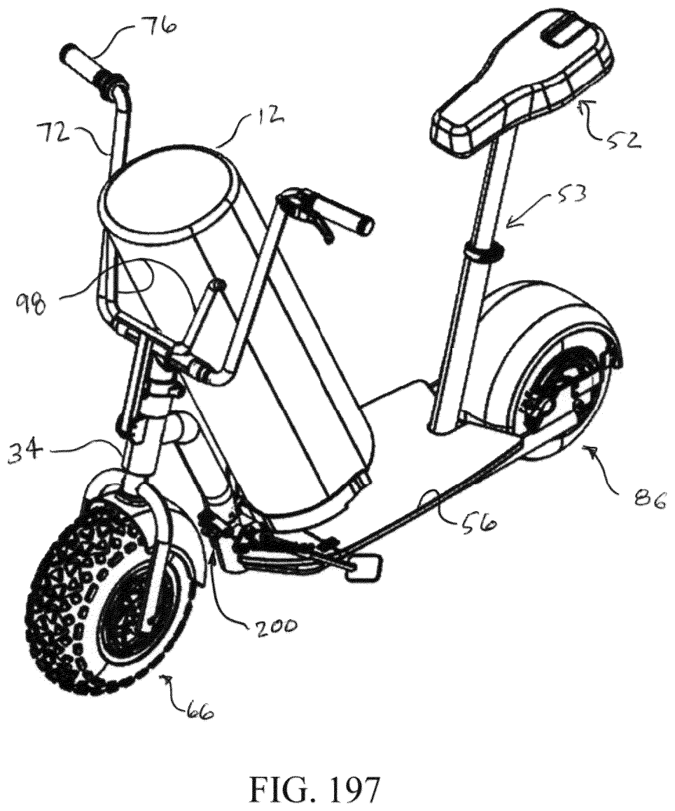

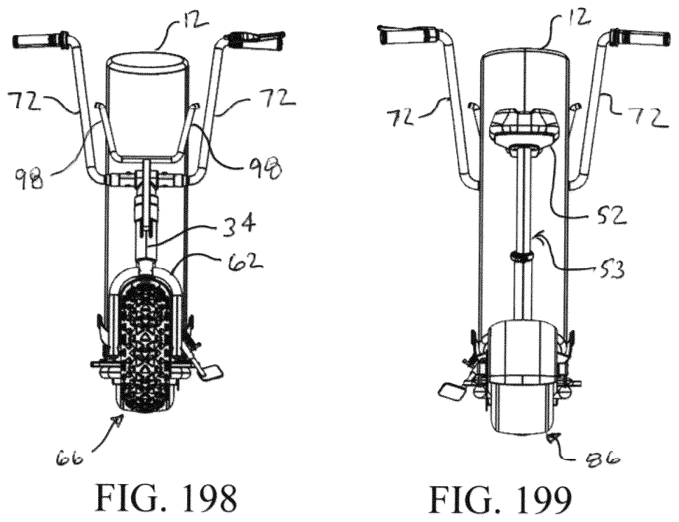

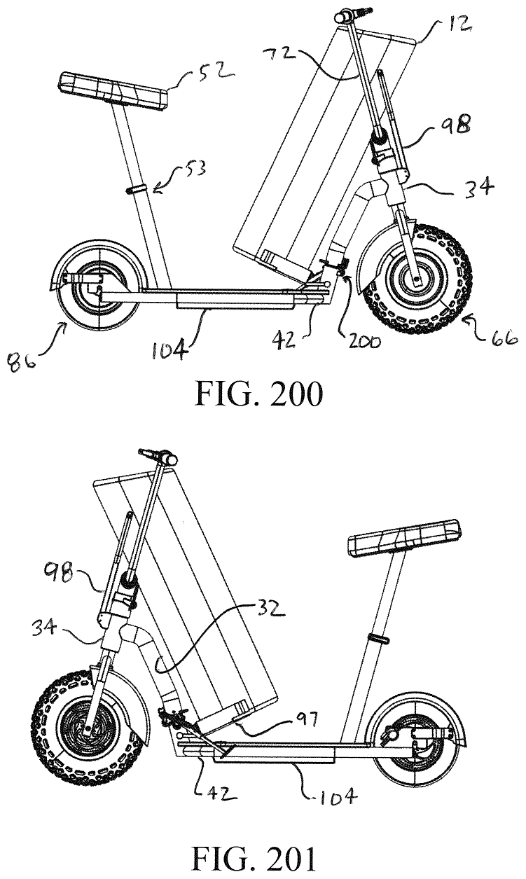

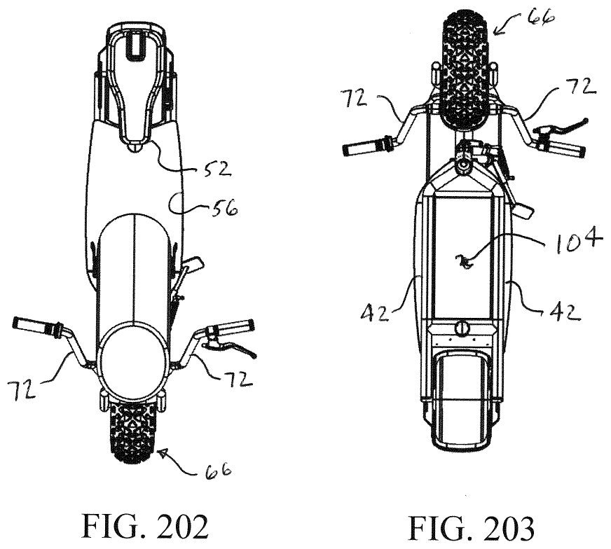

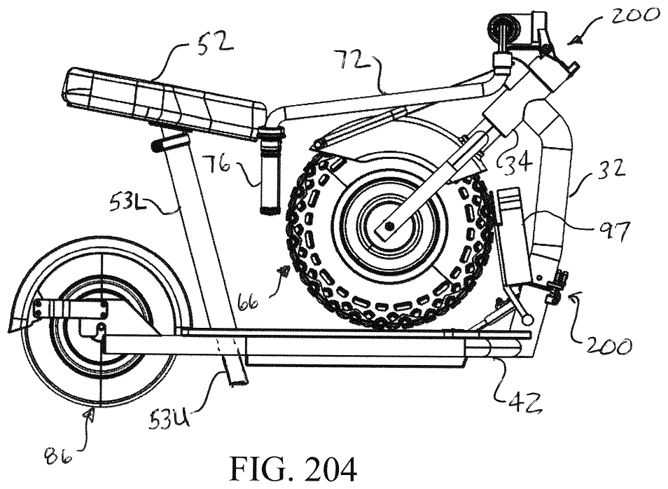

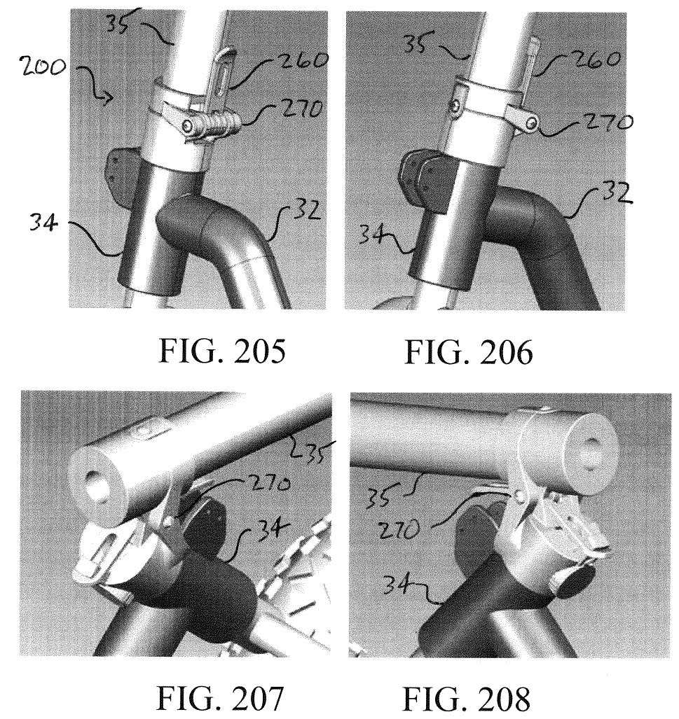

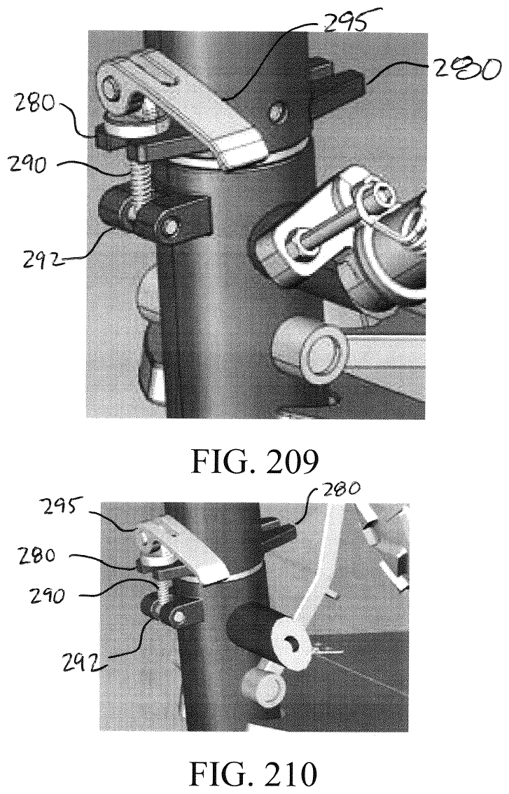

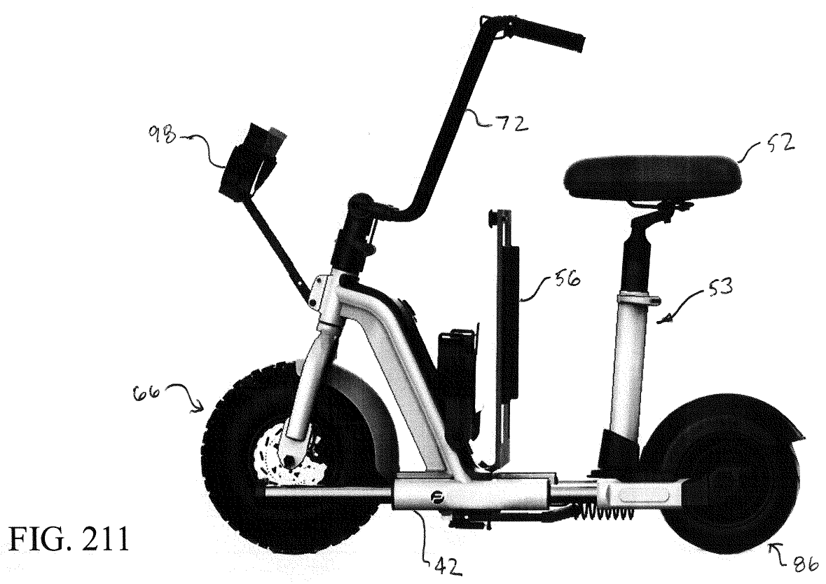

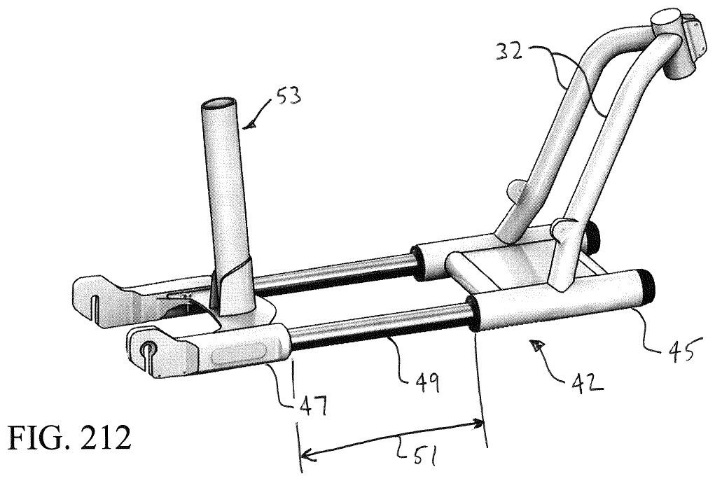

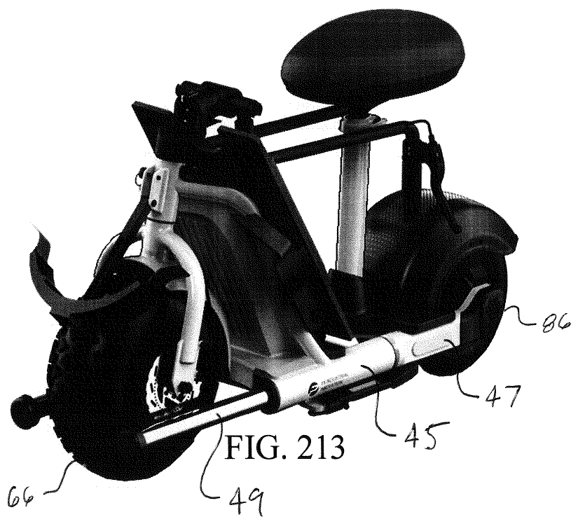

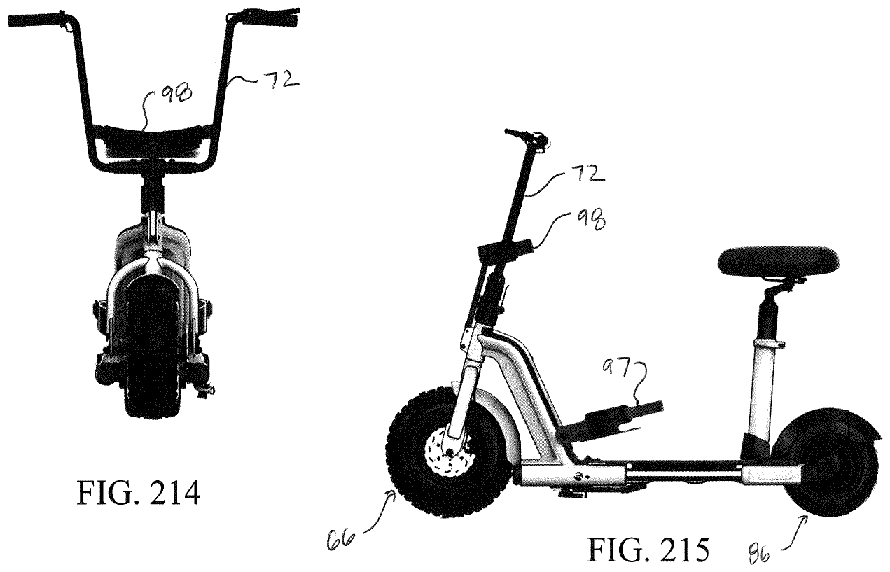

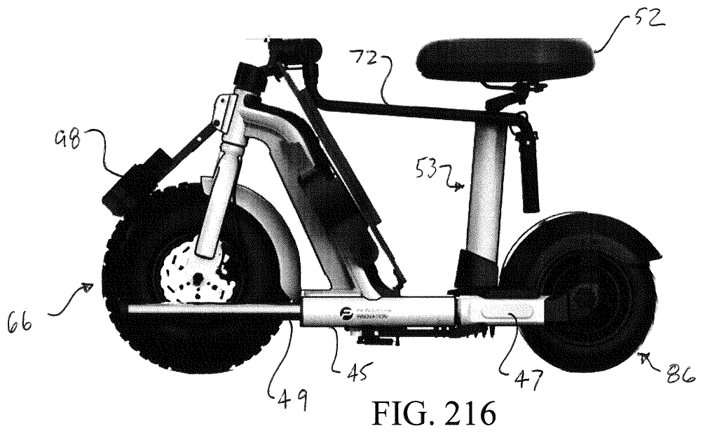

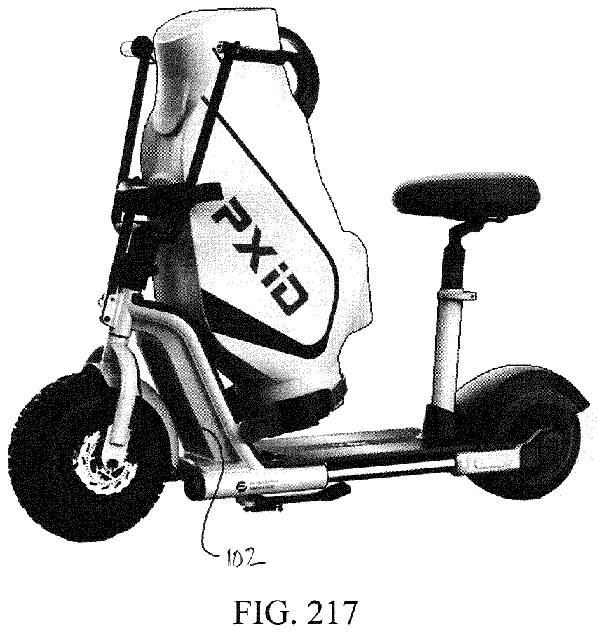

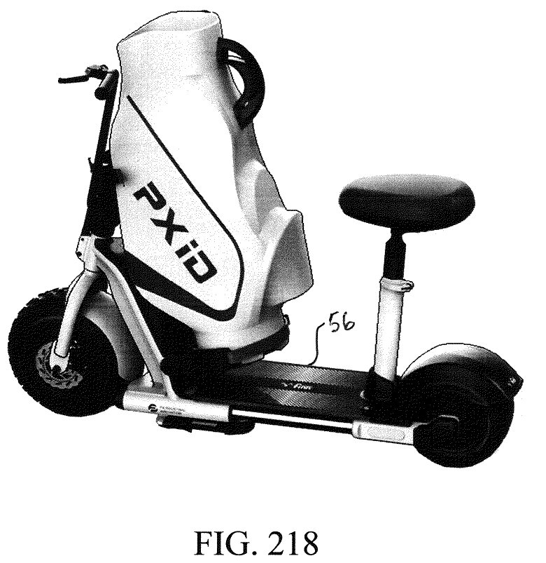

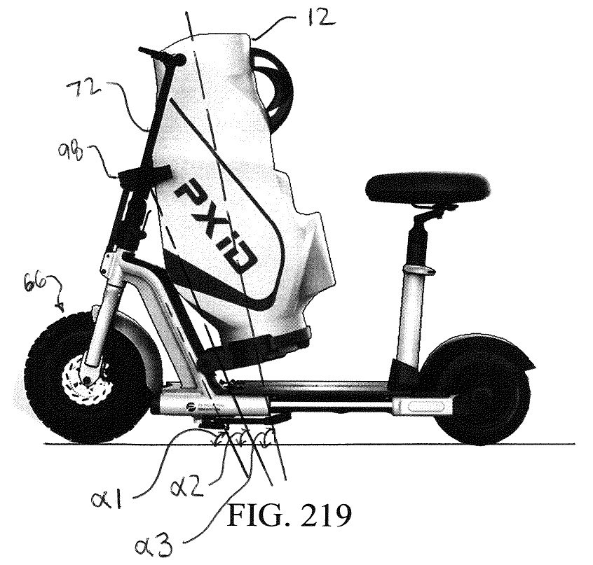

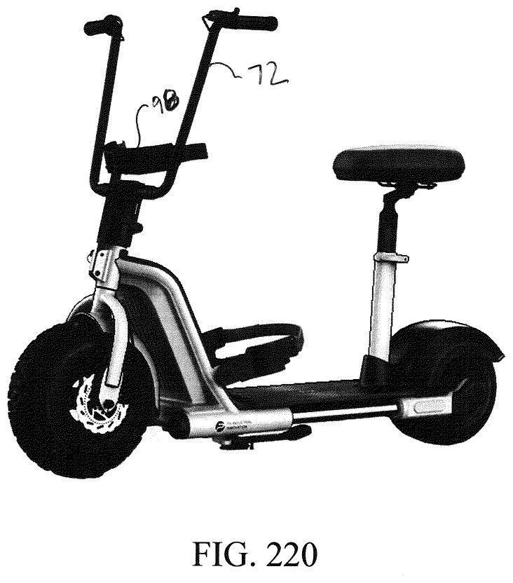

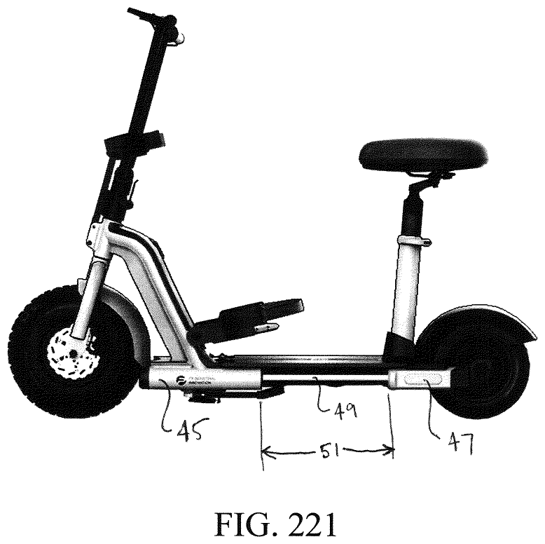

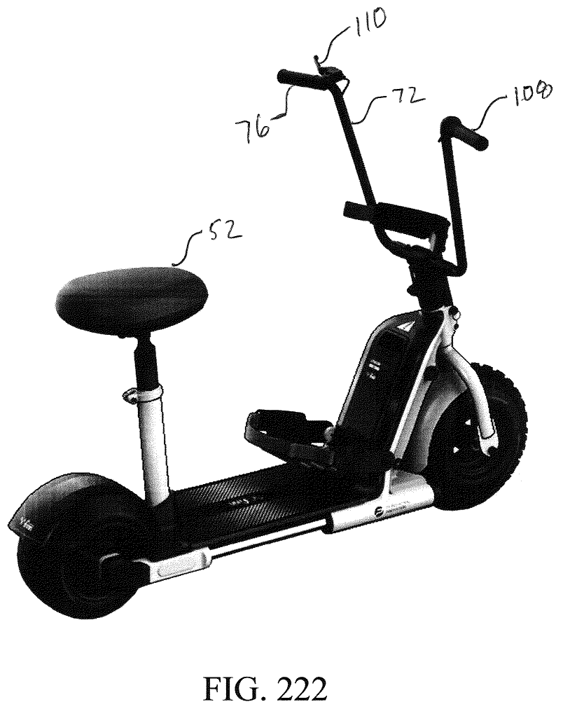

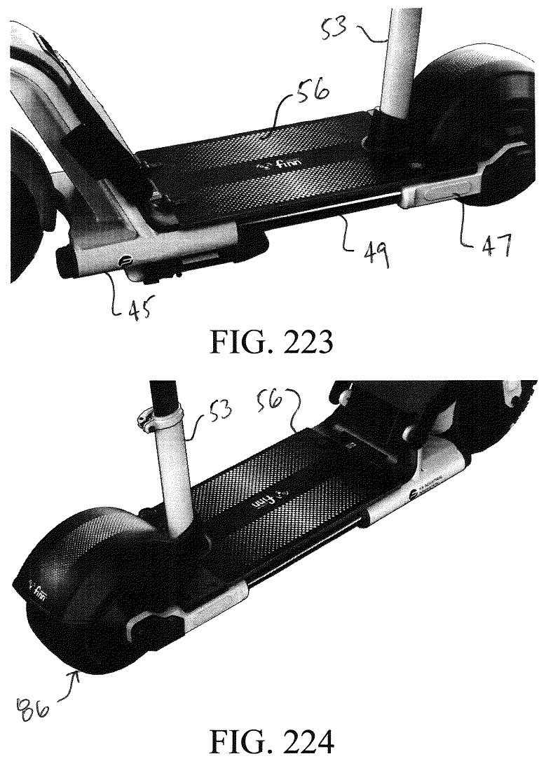

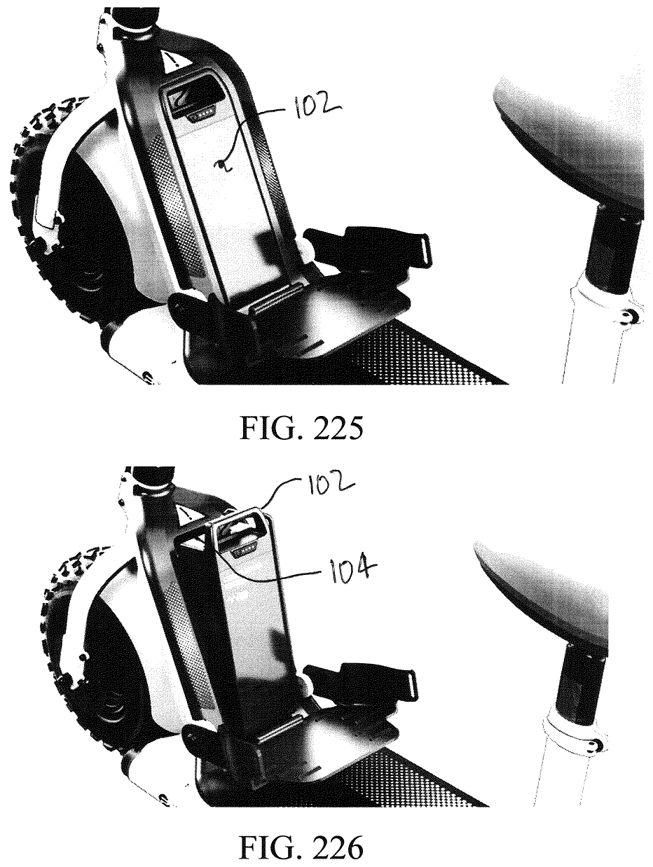

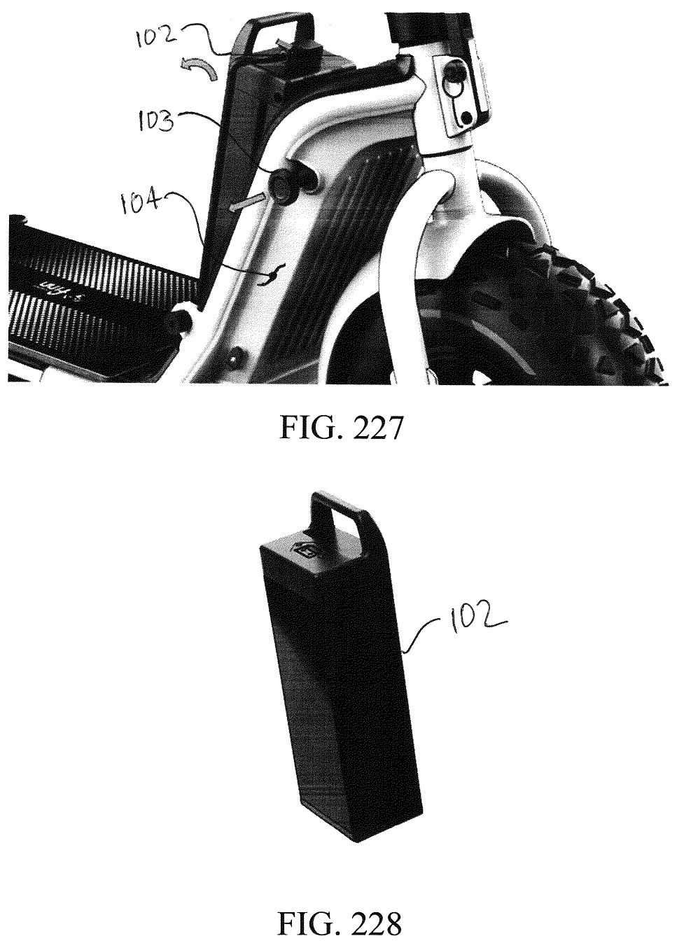

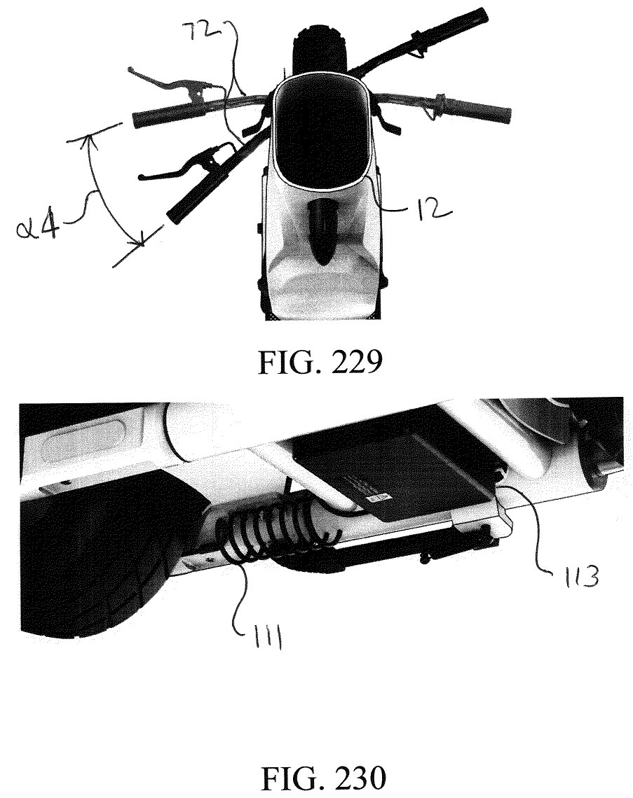

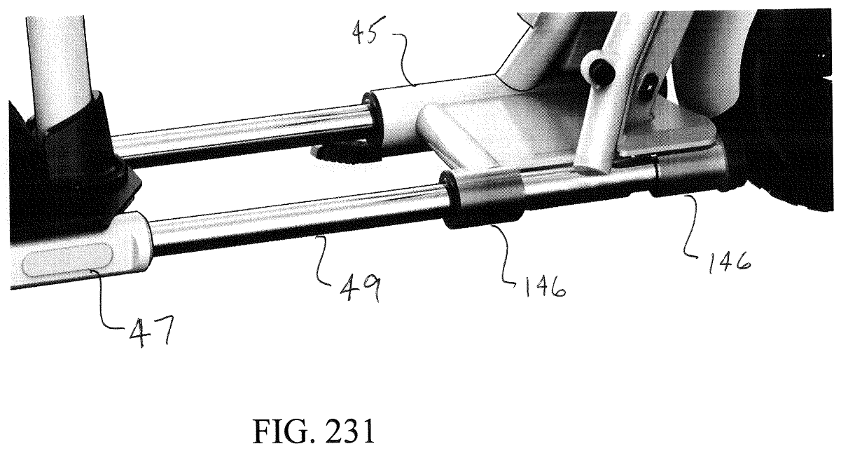

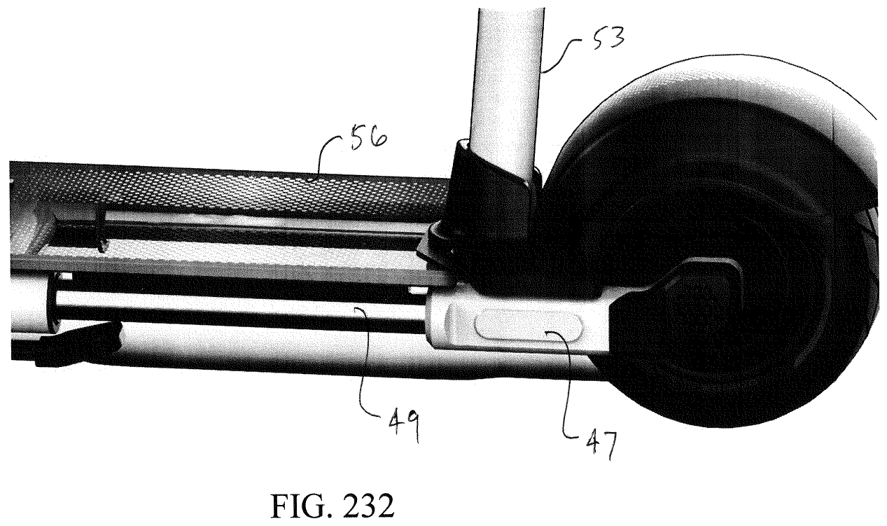

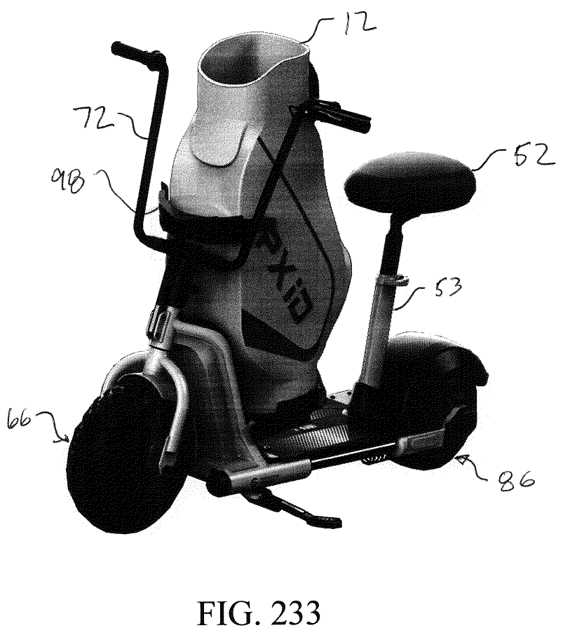

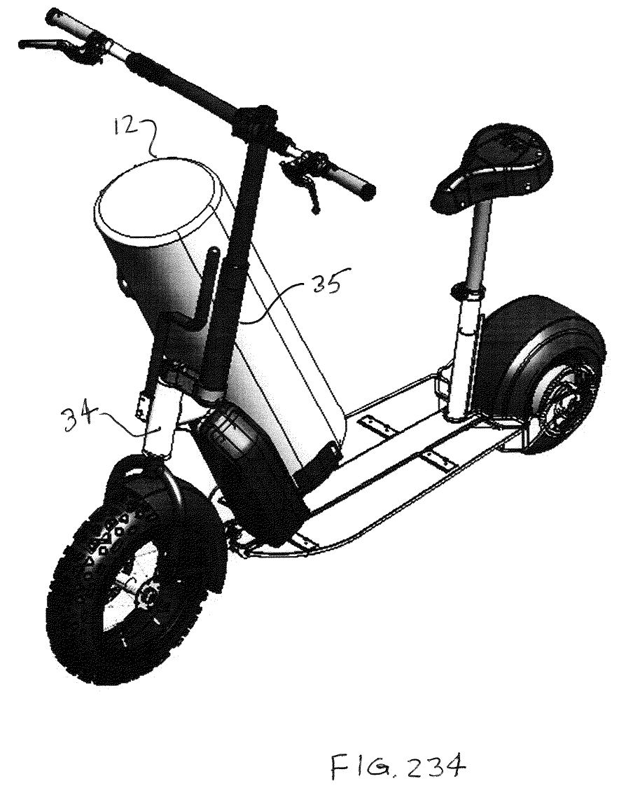

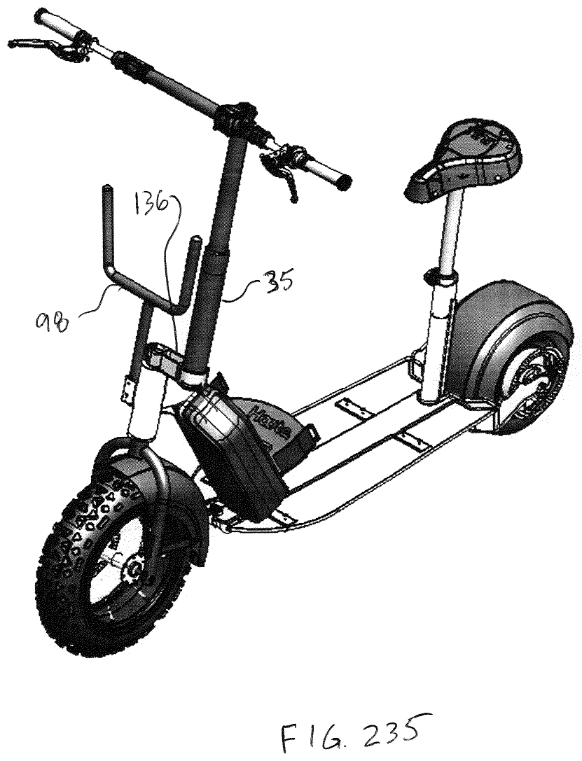

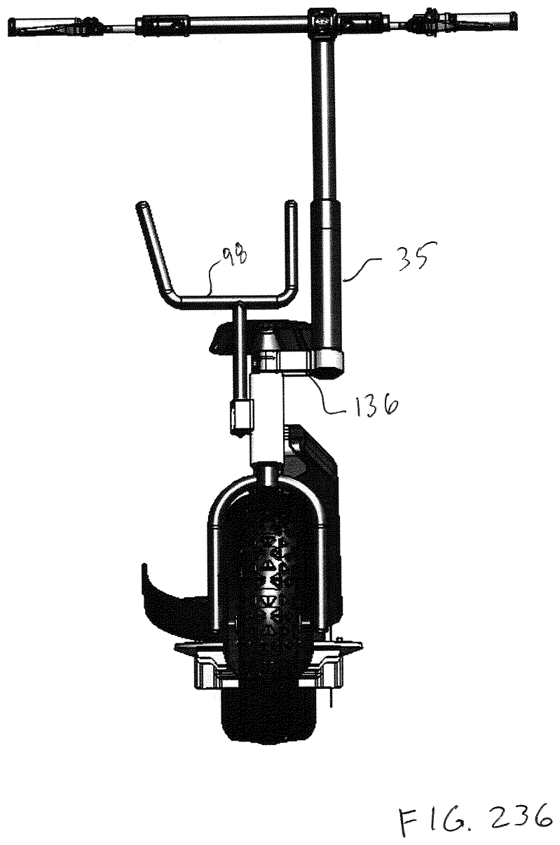

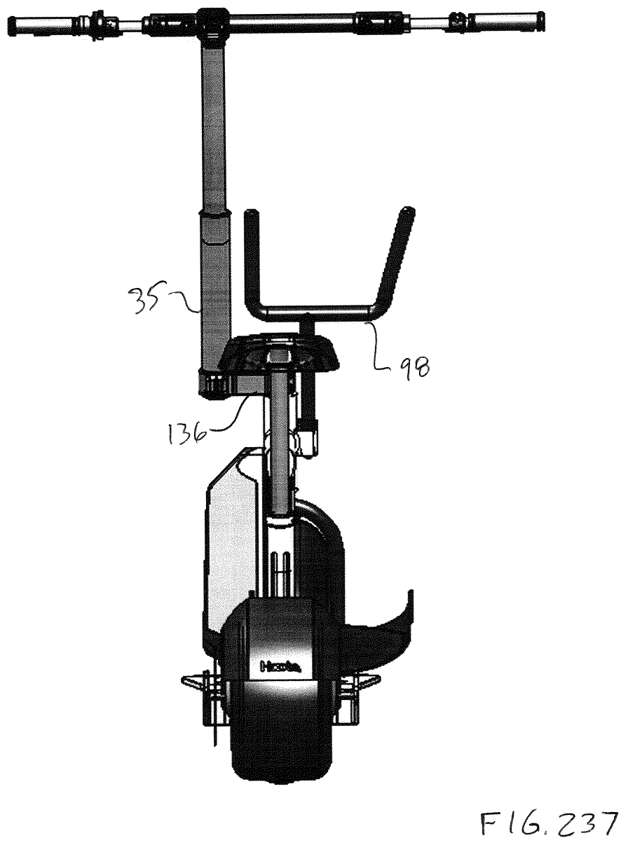

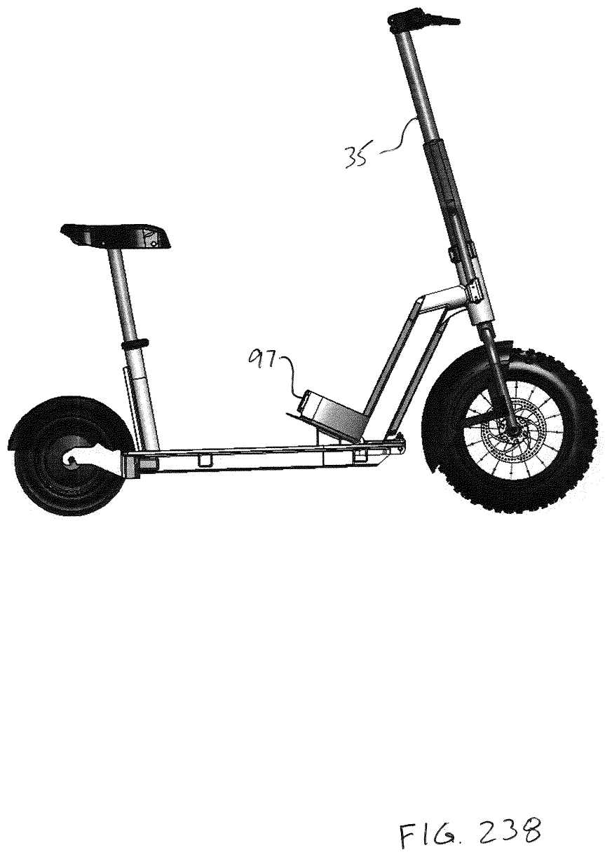

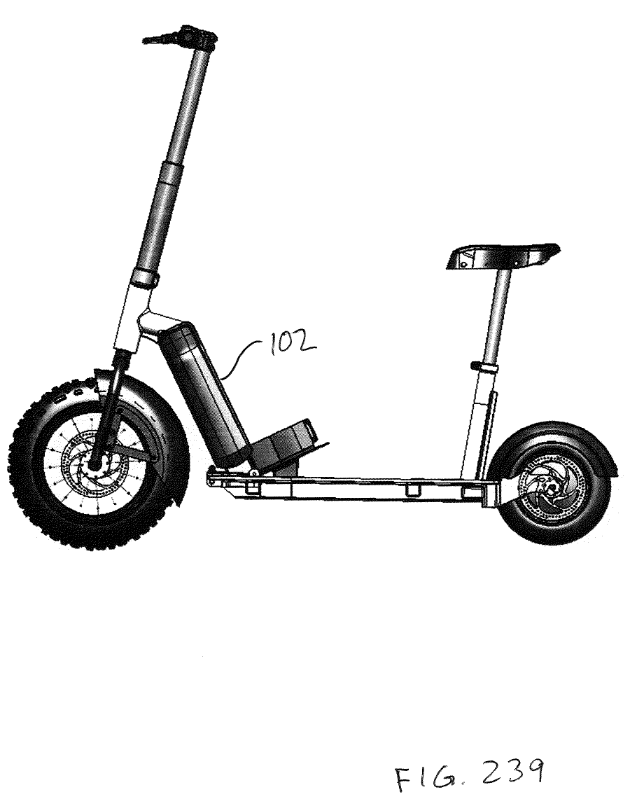

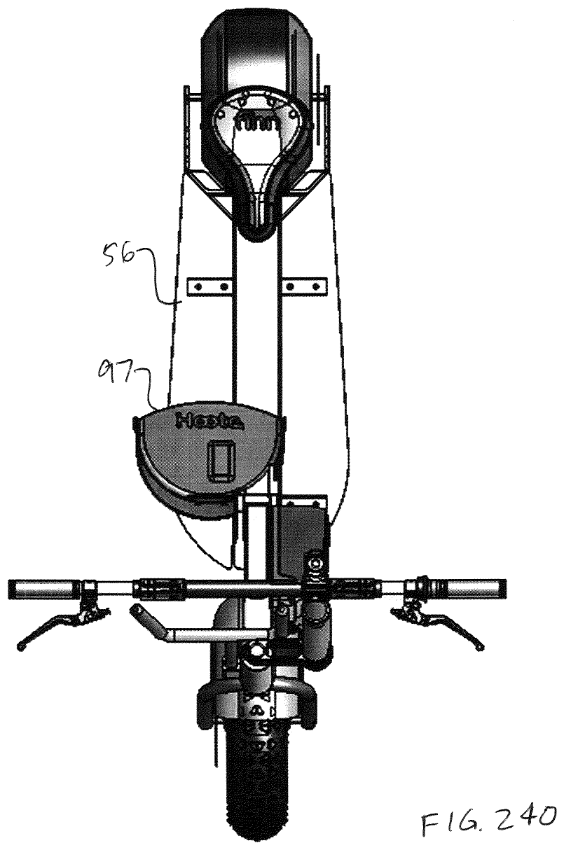

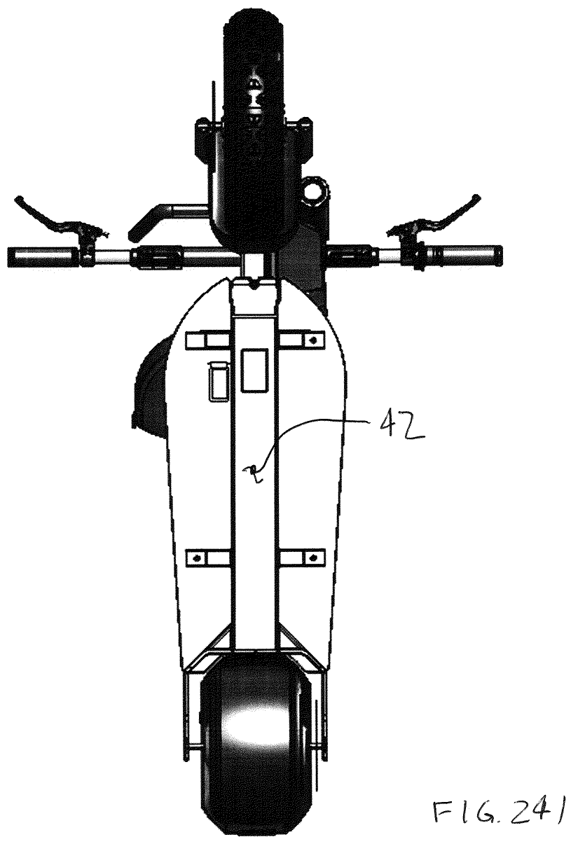

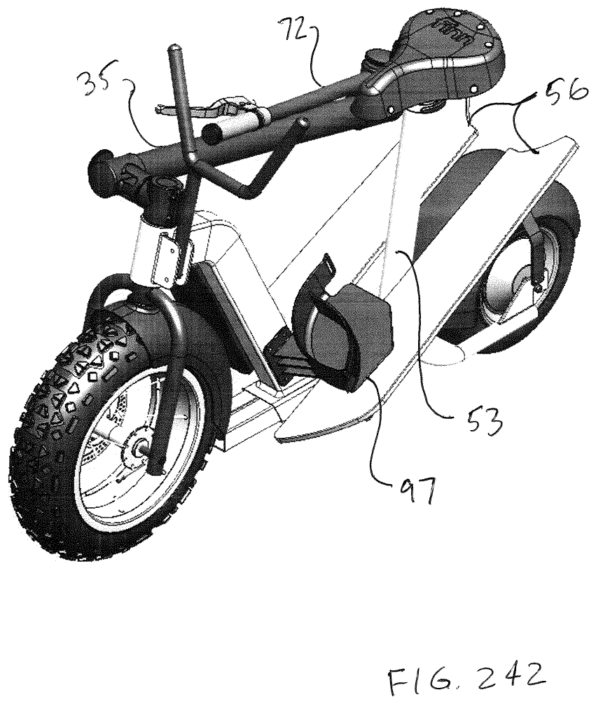

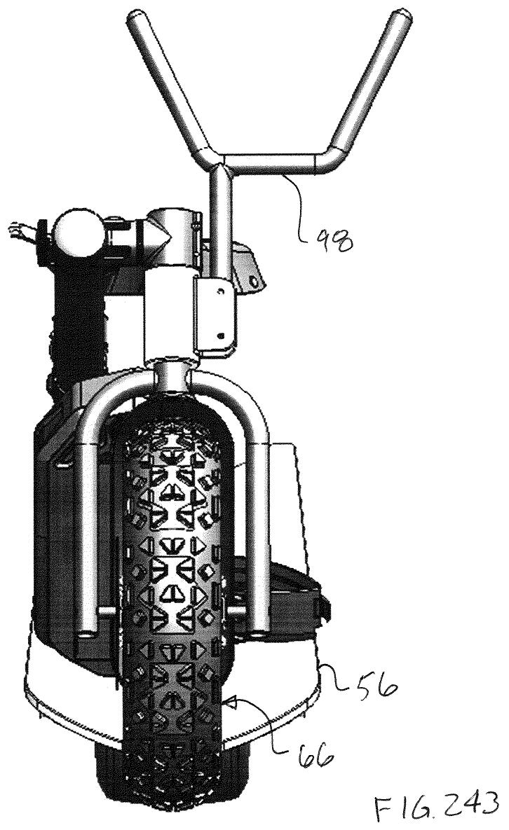

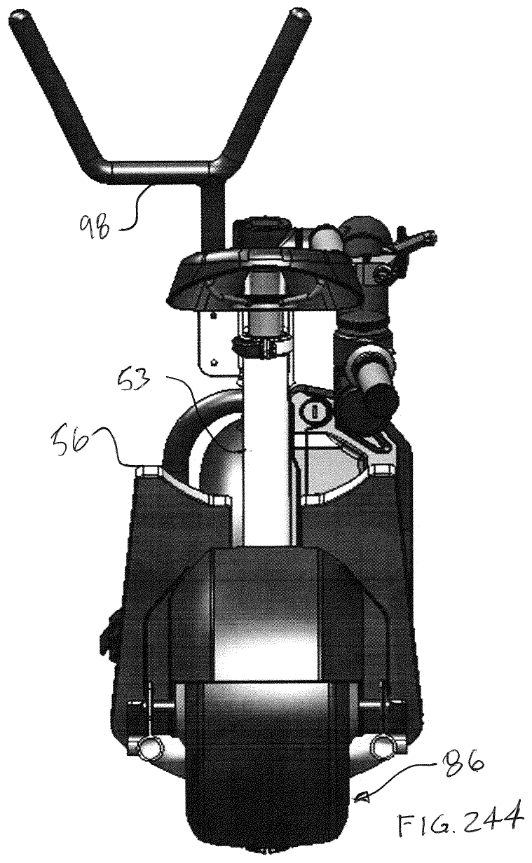

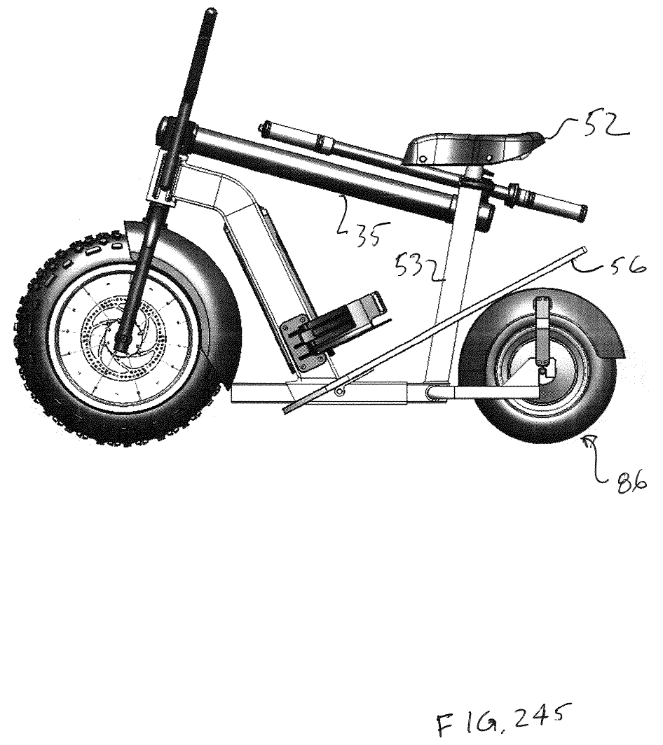

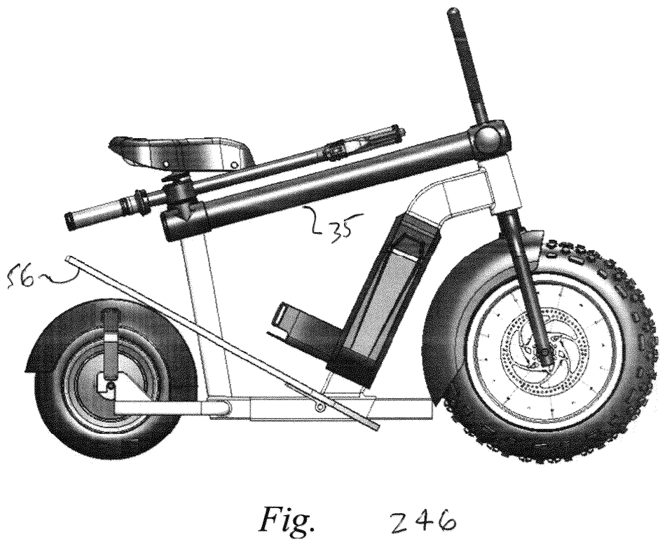

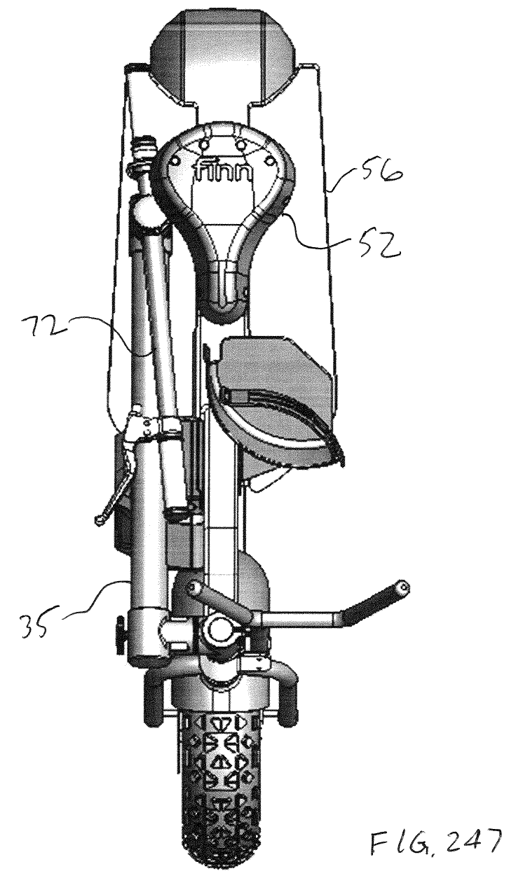

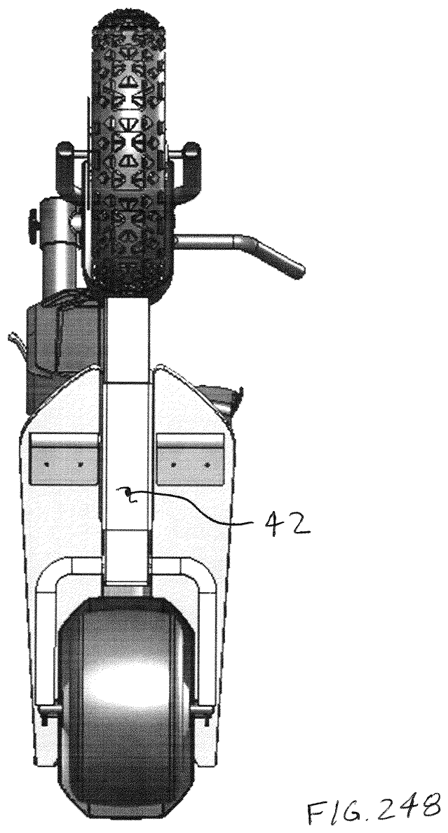

FIG. 98 is a bottom view of an alternate embodiment of the invention, shown with a golf bag;

FIG. 99 is a left elevation view of an alternate embodiment of the invention, shown in a folded state;

FIG. 100 is a front left perspective view of the invention alternate embodiment, showing a golf bag;

FIG. 101 is a front elevational view of an alternate embodiment of the invention, shown with a golf bag;

FIG. 102 is a rear elevational view of an alternate embodiment of the invention, shown with a golf bag;

FIG. 103 is a right elevation view of an alternate embodiment of the invention, shown with a golf bag;

FIG. 104 is a left elevation view of an alternate embodiment of the invention, shown with a golf bag;

FIG. 105 is a top view of an alternate embodiment of the invention, shown with a golf bag;

FIG. 106 is a bottom view of an alternate embodiment of the invention, shown with a golf bag;

FIG. 107 is a left elevation view of an alternate embodiment of the invention, shown in a folded state;

FIG. 108 is a front left perspective view of the invention alternate embodiment, showing a golf bag;

FIG. 109 is a front elevational view of an alternate embodiment of the invention, shown with a golf bag;

FIG. 110 is a rear elevational view of an alternate embodiment of the invention, shown with a golf bag;

FIG. 111 is a right elevation view of an alternate embodiment of the invention, shown with a golf bag;

FIG. 112 is a left elevation view of an alternate embodiment of the invention, shown with a golf bag;

FIG. 113 is a top view of an alternate embodiment of the invention, shown with a golf bag;

FIG. 114 is a bottom view of an alternate embodiment of the invention, shown with a golf bag;

FIG. 115 is a left elevation view of an alternate embodiment of the invention, shown in a folded state;

FIG. 116 is a front left perspective view of the invention alternate embodiment, showing a golf bag;

FIG. 117 is a front elevational view of an alternate embodiment of the invention, shown with a golf bag;

FIG. 118 is a rear elevational view of an alternate embodiment of the invention, shown with a golf bag;

FIG. 119 is a right elevation view of an alternate embodiment of the invention, shown with a golf bag;

FIG. 120 is a left elevation view of an alternate embodiment of the invention, shown with a golf bag;

FIG. 121 is a top view of an alternate embodiment of the invention, shown with a golf bag;

FIG. 122 is a bottom view of an alternate embodiment of the invention, shown with a golf bag;

FIG. 123 is a left elevation view of an alternate embodiment of the invention, shown in a folded state;

FIG. 124 is a front left perspective view of the invention alternate embodiment, showing a golf bag;

FIG. 125 is a front elevational view of an alternate embodiment of the invention, shown with a golf bag;

FIG. 126 is a rear elevational view of an alternate embodiment of the invention, shown with a golf bag;

FIG. 127 is a right elevation view of an alternate embodiment of the invention, shown with a golf bag;

FIG. 128 is a left elevation view of an alternate embodiment of the invention, shown with a golf bag;

FIG. 129 is a top view of an alternate embodiment of the invention, shown with a golf bag;

FIG. 130 is a bottom view of an alternate embodiment of the invention, shown with a golf bag;

FIG. 131 is a left elevation view of an alternate embodiment of the invention, shown in a folded state;

FIG. 132 is a left perspective view of the invention alternate embodiment, showing a golf bag;

FIG. 133 is a front elevational view of an alternate embodiment of the invention, shown with a golf bag;

FIG. 134 is a rear elevational view of an alternate embodiment of the invention, shown with a golf bag;

FIG. 135 is a right elevation view of an alternate embodiment of the invention, shown with a golf bag;

FIG. 136 is a left elevation view of an alternate embodiment of the invention, shown with a golf bag;

FIG. 137 is a top view of an alternate embodiment of the invention, shown with a golf bag;

FIG. 138 is a bottom view of an alternate embodiment of the invention, shown with a golf bag;

FIG. 139 is a perspective view of a golf bag;

FIG. 140 is a front left perspective view of an alternate embodiment of the invention, shown in a folded state;

FIG. 141 shows a frame tube bearing assembly;

FIG. 142 is a front left perspective view of the invention alternate embodiment, showing a golf bag;

FIG. 143 is a front elevational view of an alternate embodiment of the invention, shown with a golf bag;

FIG. 144 is a rear elevational view of an alternate embodiment of the invention, shown with a golf bag;

FIG. 145 is a right elevation view of an alternate embodiment of the invention, shown with a golf bag;

FIG. 146 is a left elevation view of an alternate embodiment of the invention, shown with a golf bag;

FIG. 147 is a top view of an alternate embodiment of the invention, shown with a golf bag;

FIG. 148 is a bottom view of an alternate embodiment of the invention, shown with a golf bag;

FIG. 149 is a front left perspective view of a golf bag embodiment;

FIG. 150 is a front elevation view of a golf bag embodiment;

FIG. 151 is a rear elevation view of a golf bag embodiment;

FIG. 152 is a right elevation view of a golf bag embodiment;

FIG. 153 is a top view of a golf bag embodiment;

FIG. 154 is a bottom view of a golf bag embodiment;

FIG. 155 is a front left perspective view of the invention alternate embodiment, showing a golf bag;

FIG. 156 is a front elevational view of an alternate embodiment of the invention, shown with a golf bag;

FIG. 157 is a rear elevational view of an alternate embodiment of the invention, shown with a golf bag;

FIG. 158 is a right elevation view of an alternate embodiment of the invention, shown with a golf bag;

FIG. 159 is a left elevation view of an alternate embodiment of the invention, shown with a golf bag;

FIG. 160 is a top view of an alternate embodiment of the invention, shown with a golf bag;

FIG. 161 is a bottom view of an alternate embodiment of the invention, shown with a golf bag;

FIG. 162 is a front left perspective view of the invention alternate embodiment, showing a golf bag;

FIG. 163 is a front elevational view of an alternate embodiment of the invention, shown with a golf bag;

FIG. 164 is a rear elevational view of an alternate embodiment of the invention, shown with a golf bag;

FIG. 165 is a right elevation view of an alternate embodiment of the invention, shown with a golf bag;

FIG. 166 is a left elevation view of an alternate embodiment of the invention, shown with a golf bag;

FIG. 167 is a top view of an alternate embodiment of the invention, shown with a golf bag;

FIG. 168 is a bottom view of an alternate embodiment of the invention, shown with a golf bag;

FIG. 169 is a front left perspective view of the invention alternate embodiment, showing a golf bag;

FIG. 170 is a front elevational view of an alternate embodiment of the invention, shown with a golf bag;

FIG. 171 is a rear elevational view of an alternate embodiment of the invention, shown with a golf bag;

FIG. 172 is a right elevation view of an alternate embodiment of the invention, shown with a golf bag;

FIG. 173 is a left elevation view of an alternate embodiment of the invention, shown with a golf bag;

FIG. 174 is a top view of an alternate embodiment of the invention, shown with a golf bag;

FIG. 175 is a bottom view of an alternate embodiment of the invention, shown with a golf bag;

FIG. 176 is a left elevation view of an alternate embodiment of the invention, shown in a folded state;

FIG. 177 is a front left perspective view of the invention alternate embodiment, showing a golf bag;

FIG. 178 is a front elevational view of an alternate embodiment of the invention, shown with a golf bag;

FIG. 179 is a rear elevational view of an alternate embodiment of the invention, shown with a golf bag;

FIG. 180 is a right elevation view of an alternate embodiment of the invention, shown with a golf bag;

FIG. 181 is a left elevation view of an alternate embodiment of the invention, shown with a golf bag;

FIG. 182 is a top view of an alternate embodiment of the invention, shown with a golf bag;

FIG. 183 is a bottom view of an alternate embodiment of the invention, shown with a golf bag;

FIG. 184 is a front left perspective view of an alternate embodiment of the invention, shown in a folded state;

FIG. 185 is a front left perspective view of the invention alternate embodiment, showing a golf bag;

FIG. 186 is a front left perspective view of the invention alternate embodiment, without a golf bag;

FIG. 187 is two separate rear left perspective views of the invention alternate embodiment, wherein one is non-folded state and the other in a folded state;

FIG. 188 is a front elevation view of an alternate embodiment of the invention, shown with a golf bag;

FIG. 189 is a rear elevation view of an alternate embodiment of the invention, shown with a golf bag;

FIG. 190 is a right elevation view of an alternate embodiment of the invention, shown with a golf bag;

FIG. 191 is a left elevation view of an alternate embodiment of the invention, shown with a golf bag;

FIG. 192 is a top view of an alternate embodiment of the invention, shown with a golf bag;

FIG. 193 is a bottom view of an alternate embodiment of the invention, shown with a golf bag;

FIG. 194 is a partial front left perspective view of an alternate embodiment of the invention, showing the running board and the bag support base;

FIG. 195 is two partial rear left perspective views of an alternate embodiment of the invention, showing the running board and a battery underneath the running board;

FIG. 196 is a front left perspective view of an alternate embodiment of the invention, shown in a folded state;

FIG. 197 is a front left perspective view of the invention alternate embodiment, showing a golf bag;

FIG. 198 is a front elevational view of an alternate embodiment of the invention, shown with a golf bag;

FIG. 199 is a rear elevational view of an alternate embodiment of the invention, shown with a golf bag;

FIG. 200 is a right elevation view of an alternate embodiment of the invention, shown with a golf bag;

FIG. 201 is a left elevation view of an alternate embodiment of the invention, shown with a golf bag;

FIG. 202 is a top view of an alternate embodiment of the invention, shown with a golf bag;

FIG. 203 is a bottom view of an alternate embodiment of the invention, shown with a golf bag;

FIG. 204 is a left elevation view of an alternate embodiment of the invention, shown in a folded state;

FIG. 205 is a rear left perspective view of steering bracket and steering column;

FIG. 206 is a front left perspective view of steering bracket and steering column;

FIG. 207 is a rear right perspective view of steering bracket and steering column in a folded state;

FIG. 208 is a rear left perspective view of steering bracket and steering column in a folded state;

FIG. 209 is view of an unfolded steering column and steering column locking mechanism;

FIG. 210 is another view of an unfolded steering column and steering column locking mechanism;

FIG. 211 is a left elevation view of an alternate embodiment of the invention, shown in a semi-compact state, also referred to as a semi-storage configuration;

FIG. 212 is a perspective view of a base segment of an embodiment of the invention;

FIG. 213 is a left perspective view of an embodiment of the invention, shown in a compact state, also referred to as a storage configuration;

FIG. 214 is a front elevation view of an embodiment of the invention;

FIG. 215 is a left elevation view of an embodiment of the invention, shown in an extended riding state, also referred to as a riding configuration;

FIG. 216 is a left elevation view of an embodiment of the invention, shown in a compact state;

FIG. 217 is a left perspective view of an embodiment of the invention, shown in an extended riding state;

FIG. 218 is a left perspective view of an embodiment of the invention, shown in an extended riding state;

FIG. 219 is a left elevation view of an embodiment of the invention, shown in an extended riding state;

FIG. 220 is a left perspective view of an embodiment of the invention, shown in an extended riding state;

FIG. 221 is a left elevation view of an embodiment of the invention, shown in an extended riding state;

FIG. 222 is a right perspective view of an embodiment of the invention, shown in an extended riding state;

FIG. 223 is a partial left perspective view of an embodiment of the invention, shown in an extended riding state;

FIG. 224 is a partial right perspective view of an embodiment of the invention, shown in an extended riding state;

FIG. 225 is a partial left perspective view of an embodiment of the invention;

FIG. 226 is a partial left perspective view of an embodiment of the invention;

FIG. 227 is a partial right perspective view of an embodiment of the invention;

FIG. 228 is a perspective view of an embodiment of the battery;

FIG. 229 is a partial top plan view of an embodiment of the invention;

FIG. 230 is a partial bottom perspective view of an embodiment of the invention;

FIG. 231 is a partial right perspective view of an embodiment of the invention;

FIG. 232 is a partial left perspective view of an embodiment of the invention;

FIG. 233 is a left perspective view of an embodiment of the invention;

FIG. 234 is a left perspective view of an embodiment of the invention;

FIG. 235 is a left perspective view of an embodiment of the invention;

FIG. 236 is a front elevation view of an embodiment of the invention;

FIG. 237 is a rear elevation view of an embodiment of the invention;

FIG. 238 is a right elevation view of an embodiment of the invention, shown in an extended riding state;

FIG. 239 is a left elevation view of an embodiment of the invention, shown in an extended riding state;

FIG. 240 is a top plan view of an embodiment of the invention, shown in an extended riding state;

FIG. 241 is a bottom plan view of an embodiment of the invention, shown in an extended riding state;

FIG. 242 is a left perspective view of an embodiment of the invention, shown in a compact state;

FIG. 243 is a front elevation view of an embodiment of the invention, shown in a compact state;

FIG. 244 is a rear elevation view of an embodiment of the invention, shown in a compact state;

FIG. 245 is a left side elevation view of an embodiment of the invention, shown in a compact state;

FIG. 246 is a right side elevation view of an embodiment of the invention, shown in a compact state;

FIG. 247 is a top plan view of an embodiment of the invention, shown in a compact state; and

FIG. 248 is a bottom plan view of an embodiment of the invention, shown in a compact state.

### DETAILED DESCRIPTION OF THE INVENTION

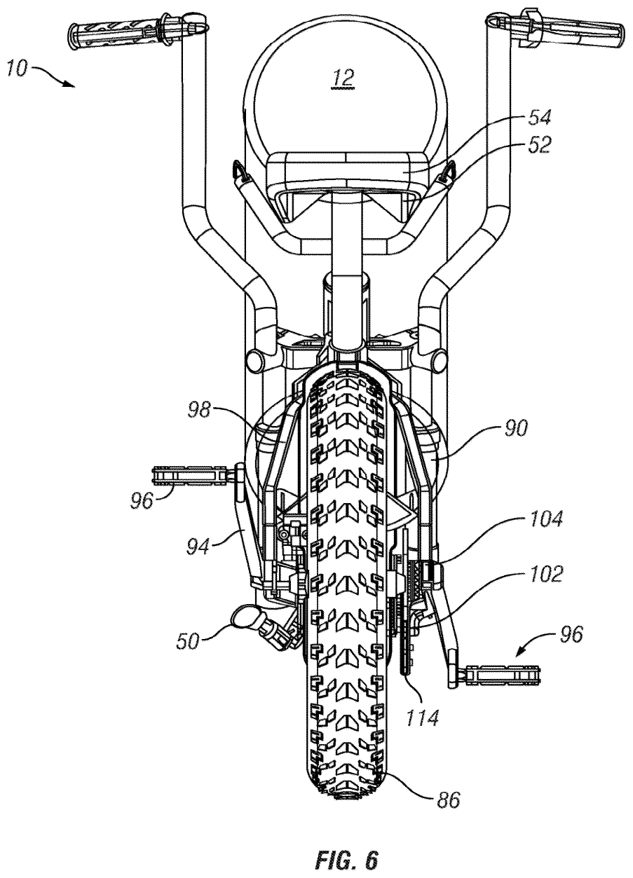

The present invention is personal riding golf bag cart in the form of a riding cycle used to transport the user along with golf bags loaded with golf clubs and accessories. The pedal-powered riding golf bag cart/cycle is referred to by the general reference character 10, generally referred to as “riding cart 10”, in the description. The riding cart 10 is generally symmetrical about a vertical (in normal operation) longitudinal plane 11. The riding cart 10 may be used with various golf bags 12 and may exist in multiple embodiments. The pedal-power is directly provided by the golfer/rider 13 (shown in phantom in FIG. 6) and is adapted to be assisted by a motor, as discussed below.

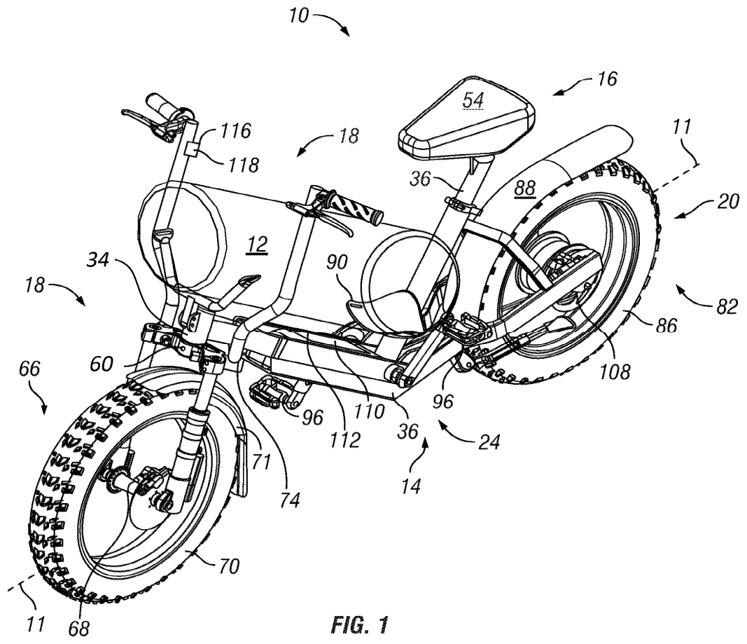

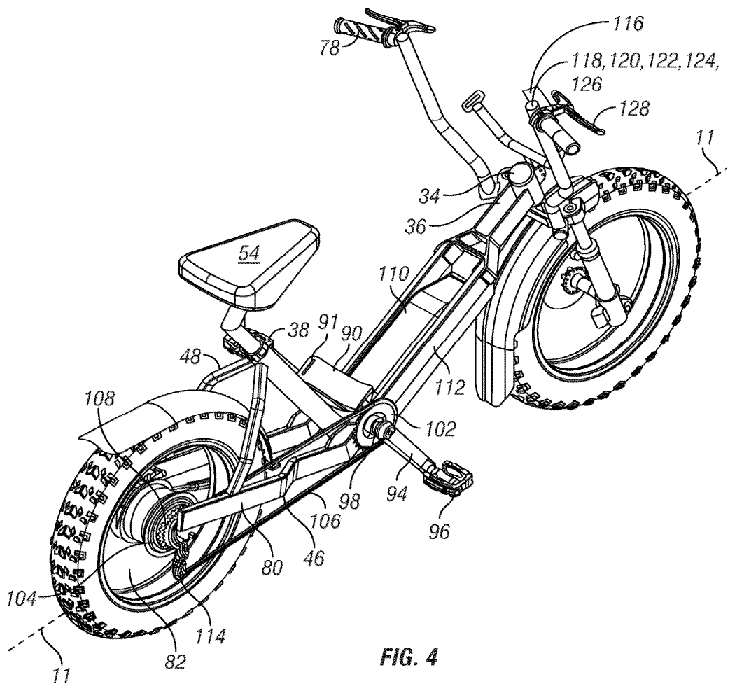

In one preferred embodiment of the invention illustrated in FIGS. 1 and 4, the riding cart 10 is shown in a perspective view as appropriate for transporting the typical golf bag 12 as well as a golfer/rider 13 (not shown). Although oversized “power-cart” golf bags are generally too large in diameter for comfortable riding between the rider's legs (and may interfere with pedaling and moving components) most conventional golf carry bags and slim-line cart bags are workable and comfortable.

The riding cart 10 may be thought of as having various principal assembles or subassemblies (each sometimes referred to in shorthand as a “sba” herein) which operate together in order to function as an easy to use method of transporting a golf bag on the rolling surfaces of a golf course and in other locations such as parking lots and storage facilities. The primary subassemblies include: a frame subassembly (sba) 14; a personal support sba 16; a front wheel and steering sba 18, a rear wheel sba 20, a bag support sba 22, a pedal sba 24, a motor-assist sba 26, and a motive control sba 28. It is understood that some components of the invention interface with others and may be considered to be a part of more than one of the subassemblies. As discussed further below, some of the sbas in alternate embodiments may have structures and features which allow them to be physically manipulated to create a collapsed/storage mode 30 having a lower and shorter aspect for transport and storage.

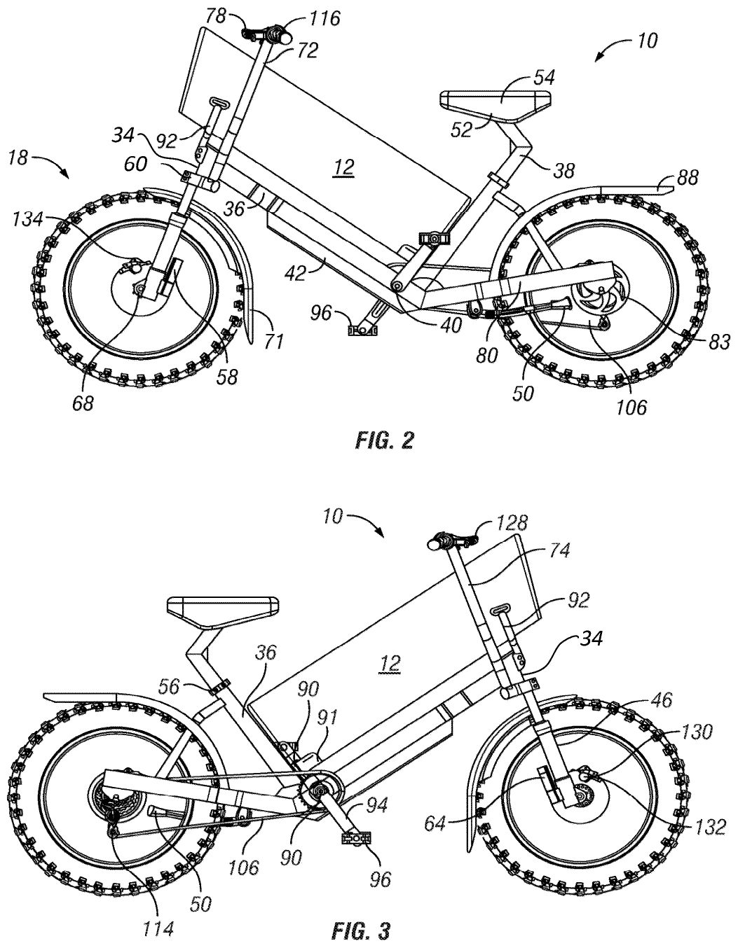

As best seen in FIGS. 1-4 and 8, the frame subassembly 14 includes a convoluted frame tube structure 32, aligned within the vertical longitudinal plane 11, which mates together with a steering bracket 34 (part of the front wheel/steering sba 18) at the front of the frame 14. The frame tube 32 extends rearward along the longitudinal plane 11 from the steering bracket 34. A front angle tube 36 is affixed to the stationary steering bracket 34 and is angled downward to intersect at an approximately right angle to bond with a lower extent of a seat tube 38. A pedal support tunnel 40 extends laterally through the front angle tube 36 forward of the seat tube 38. The seat tube 38 extends below the intersection with the front angle tube 36 to support a horizontally arrayed undercarriage 42. The frame sba 14 also includes a rocker arm fork 46 pivotally extending from the angle tube 36. A brace fork 48 extends rearward and downward from the upper portion of the seat tube 38 to mate with the rocker arm 46. A kickstand 50 pivotally depends from lower portion of the angle tube 36, and may be engaged to maintain the bag cart/cycle 10 in a generally vertical orientation when unoccupied by the rider 13 and then manually disengaged when motion is desired.

The personal support sba 16 is an adjunct to the cycle frame sba 14. The personal support sba 16 includes a seat 50 having a cushion 52. The seat 50 is mounted on and above the seat tube 38 with a height adjustable mounting bracket 54 so that the rider 13 is comfortable with operating the pedal sba 24. The seat 50 provides support for the golfer/rider 13 during use. Typically, the seat 50 may be mounted by the rider 13 either from the rear or, if feasible, from either side.

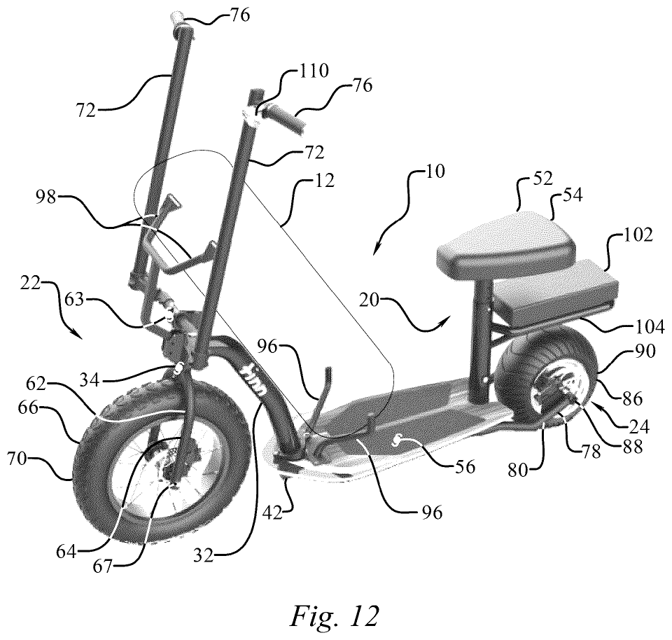

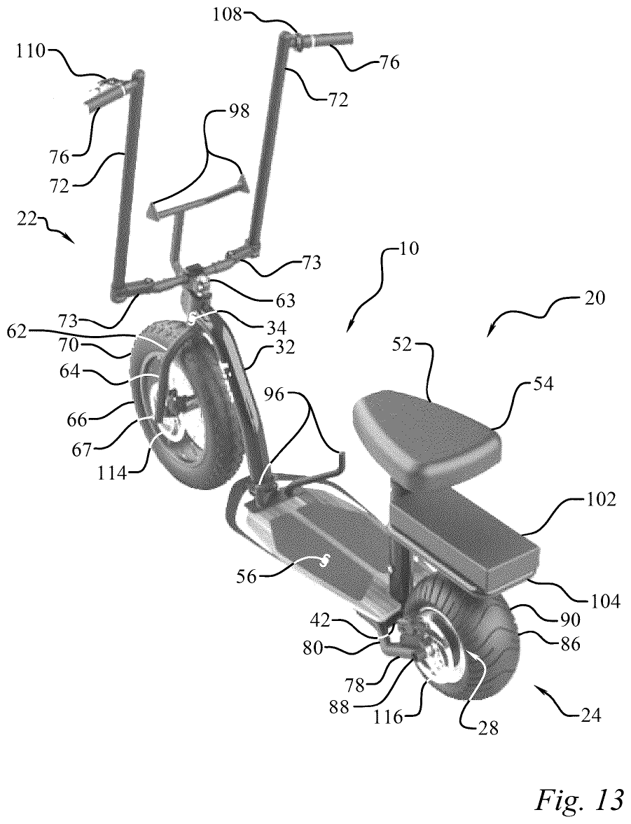

The front wheel/steering subassembly 18 includes a front fork 58 pivotally mounted to depend from the steering bracket 34. The front fork 58 includes a fork bracket 60 pivotally connected to the steering bracket 34 and supports a pair of opposed fork arms 62 depending therefrom, each optionally including a shock absorber 64. Alternatively, in some embodiments the fork bracket 63 is located above the steering bracket 34 and is the location for the handlebars 72 to connect to the rotational assembly that includes the front fork 62, as seen in FIGS. 12 and 13, and therefore the fork bracket 63 may be referred to as the handlebar connector 63 in embodiments where it is located above the steering backed 34, and in embodiments such as that of FIG. 177 is the location that the handlebars 72 are connected to the steering column 35. The fork arms 62 support a front wheel 66 on a front axle 68 extending between the lower extent of the opposing fork arms 64. The front wheel 66 has a substantial diameter and supports a front tire 70 having a moderately wide tread for traction while being pneumatic and relatively soft so as to avoid damaging the turf in use. A front fender 71 may be mounted between the arms of the front fork 58 above the front tire 70 to minimize splashing or debris from impacting the rider 13 or the golf bag 12.

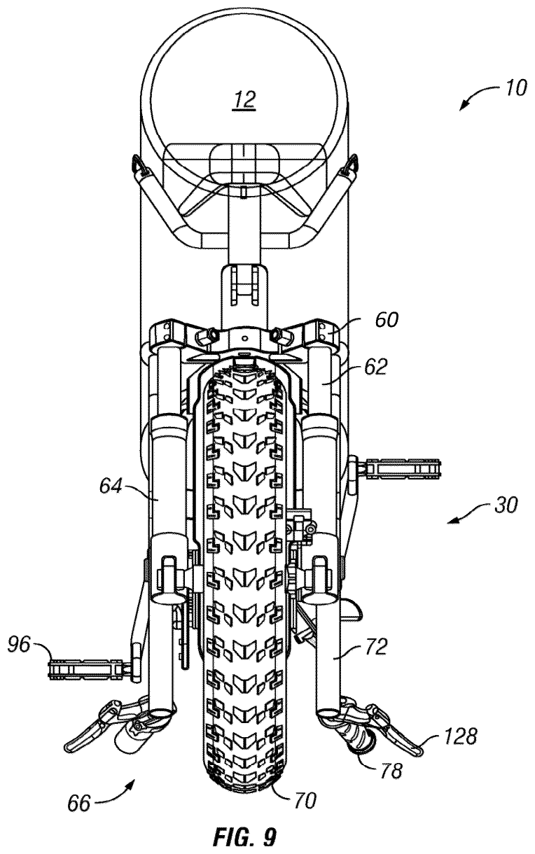

In the preferred embodiment 10 the upper portion of the front wheel/steering sba 22 includes a set of handlebars 72 pivotally attached to the fork bracket 60 by pivot tubes 74 on either side. Each handlebar 72 is bent outwards to form a curved tube 76 pivotally extending above the respective pivot tube 74 in order to facilitate steering and turning without impacting the golf bag 12 which extends therebetween. The curved tube 76 extends upward to handle grips 78 for comfortable hand positioning and steering. The pivotal attachment of the handlebars 72 to the fork bracket 60 allows the handlebars 72 to pivot downward around the front 70 tire in the compact storage more 30 (see FIG. 9). The curved tube 76 may also be rotated on the pivot tube 74 such that the handle grips 78 are aligned to be generally parallel with the front tire 70, thus minimizing net width in the collapsed storage mode 30.

The rear wheel subassembly 24 includes the previously described rocker arm fork 46 and brace fork 48 which together function as a rear fork 80. The rear fork 80 supports a rear wheel 82 having a hub 83 surrounding a rear axle 84. The rear wheel 82 is generally dimensionally the same as the front wheel 66 and supports a rear tire 86. The rear tire 88 is wide similarly to the front tire 66 to provide good driving traction while minimizing impact on the turf of the course. The rear tire 86 may be inflatable or solid. A fender 88 may be attached to the rear fork 80 or to the seat fork segment 44 to extend over the upper portion of the rear tire 86.

The bag support sba 22 is adapted to hold the golf bag 12 in place on the cart/cycle 10. The golf bag 12 is supported at about a forty-five to sixty five degree vertical angle, twenty five to forty five degrees to the horizontal, (with the club heads extending forward through the handlebars 72 and above the front wheel 66. The base of the golf bag 12 rests upon a bag bottom cradle 90 and may abut against the seat tube 38. The bag bottom cradle 90 is shaped to have wings 91 which extend upward and outward to hold the bag bottom up and laterally in place.

An upper bag cradle 92 is mounted on the steering bracket 34 to laterally cradle the upper part of the golf bag 12 and prevent the golf bag 12 and clubs from interfering with the handle bars 72. It is noted that the upper bag cradle 92 is stationary on the stationary steering bracket 34 and does not rotate with the handlebars 72. This arrangement maintains the golf bag 12 in position to be always centered on the longitudinal plane 11 even when the cart/cycle 10 is being steered around curves (the handlebars 72 being spread wide enough that the curved tubes 76 do not contact the golf bag 12 in any but the most extreme turns).

The pedal subassembly 24 facilitates operating the cart/cycle 10 either by itself or in combination with the motor assist sba 26. The components of pedal subassembly are all situated in the vicinity of the pedal support tunnel 42 discussed above. A pair of vertically opposed pedal arms 94, each including a rotatable pedal 96, are rigidly connected by a pedal axle 98 passing through the pedal support tunnel 40, cause a sprocket 100 to rotate when the rider 13 rotates the pedal sba 24 (in a similar manner to that of operating a conventional bicycle). When the cart/cycle 10 is operating in a pedal-only mode, it operates in the same manner as a conventional bicycle.

The sprocket 100 in the preferred embodiment is a toothed disk 102 which drives a similar (if smaller) rear disk 104, connected to the rear wheel axle 84, by virtue of a drive chain 106, Other drive concepts may also work, such as a belt drive, but the sprocket and chain mechanism is more reliable for pedal power. It is noted that the pedal power works only to propel the cart/cycle 10 forward and is not usable for reverse motion.

The motor assist sba 26 provides the power to move the cart/cycle 10 and the golfer 13 around the course, either providing sole power of operating to assist the pedal sba 24. The presently preferred embodiment 10 is a rear wheel drive system with an electrical motor 108 and a rechargeable battery 110. The electrical motor 108 in the present embodiment is a disc motor situated in the hub 83. Other motive systems may drive the rear wheel by any of a variety of mechanisms, including a chain drive, or a belt drive. The battery 110 may be mounted at various locations on the cycle frame 14, with the preferred version being a battery cradle 112 nested within the undercarriage 42.

The electrical motor 108 is intentionally limited in power in order to be “street legal” in most jurisdictions. This allows the cart/cycle 10 to be ridden to and from the course or on other errands unrelated to golf. Even in motor-assist or motor only modes.

In a motor assist mode, the motor 108 provides additional motive power to the rear wheel 82 to assist the force being provided by the rider 13 using the pedals 96. In this mode the electrical drive provides additional rotational energy which helps the rider 13 in situations where pedaling is difficult, such as when climbing hills of working in difficult terrain. In this mode the motor 108 does not supplant the pedal drive sba 24 but merely helps out.

The cart/cycle 10 can also be operated solely on motor power when the rider 13 wishes to rest. To facilitate this, a decoupler 114 is provided to decouple the pedal sba 24 from the rear axle 84 such that the pedals 96 are not forced to rotate during a motor-alone mode operation. This mode is ordinarily used on relatively flat terrain in the preferred embodiment since it is not intended, for overall weight and cost considerations, that the preferred motor 108 is powerful enough to handle steep inclines with a normal or heavy rider 13 aboard.

The operational mode and speed of the motor 108 will typically be regulated by the golfer 13 by a control unit 116 usually mounted on one of the handlebars 72, normally adjacent to or part of the handle grips 76. The control unit 116 has settings which allow the motor 108 to be set to off 118, motor-assist 120, and motor only 122 (which also engages the decoupler 114). A throttle control 124 allows the rider 13 to select the speed/rotational force in motor-assist and motor only modes. An optional speedometer 126 may also be provided to allow the rider to know the velocity of travel.

A brake actuator 128, also typically situated near a handle grip 74, will control a brake 130 applied to one or both of the front wheel 66 and/or the rear wheel 82. The front brake 132 will typically be a conventional friction brake while a rear brake 134 may be a motor brake, a disc brake, or a friction brake.

The preferred embodiment 10 is primarily constructed of cast or extruded anodized aluminum for light weight and durability. The wheels 66 and 82 are pneumatic tires with cushioned traction surfaces and may either be provided with solid hubs or spoke hubs (although the rear wheel will have a hub for containing the electric motor 108).

In one embodiment (see FIG. 9) the cart/cycle 10 may be converted to the collapsed mode 30 for storage or transport. In this instance, each handlebar 72 is rotated downward upon the fork bracket 60 to extend to either side of the front wheel 66, thus reducing the overall height of the assembly. It is envisioned that other modification intended to reduce the “footprint” of the cart/cycle 10 may also be feasible, but generally the entire unit is compact enough for most storage situations and is adapted to fit on a conventional bicycle vehicle rack for transport.

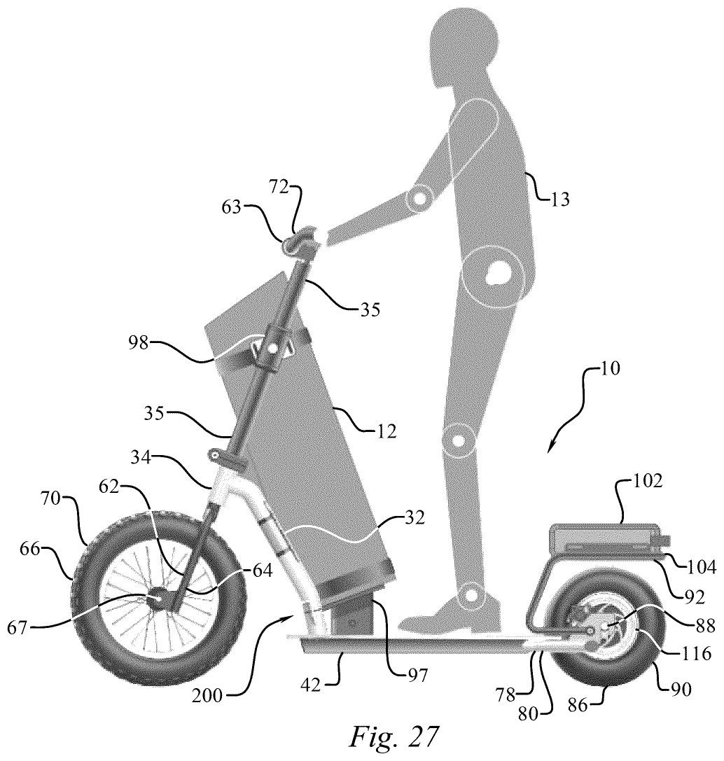

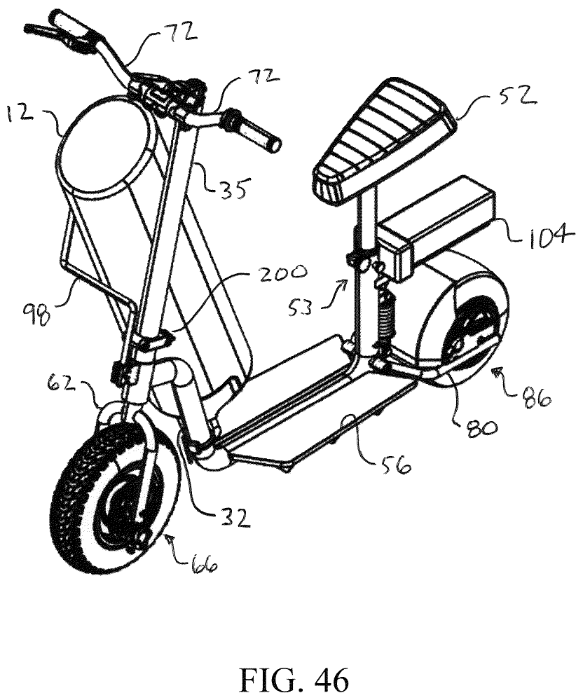

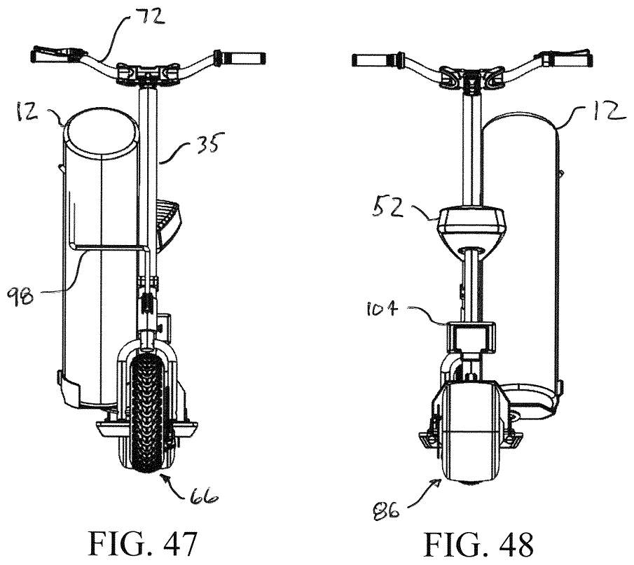

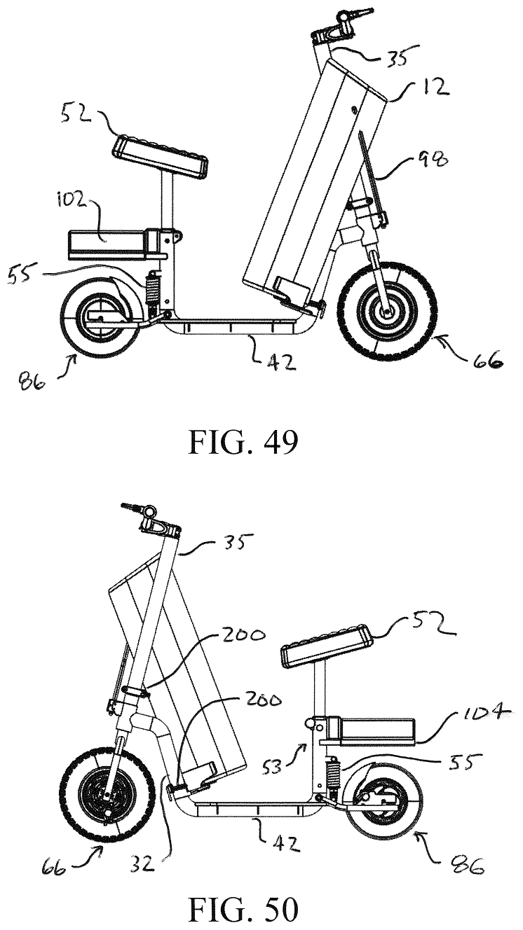

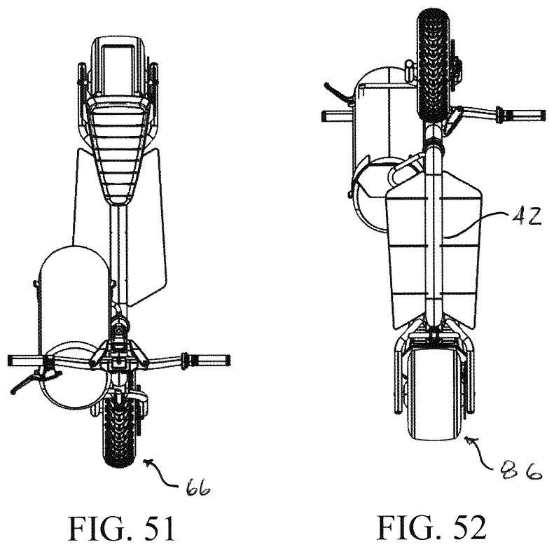

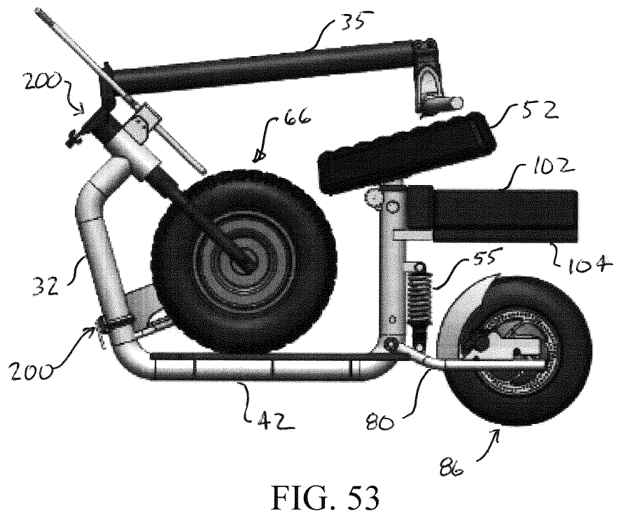

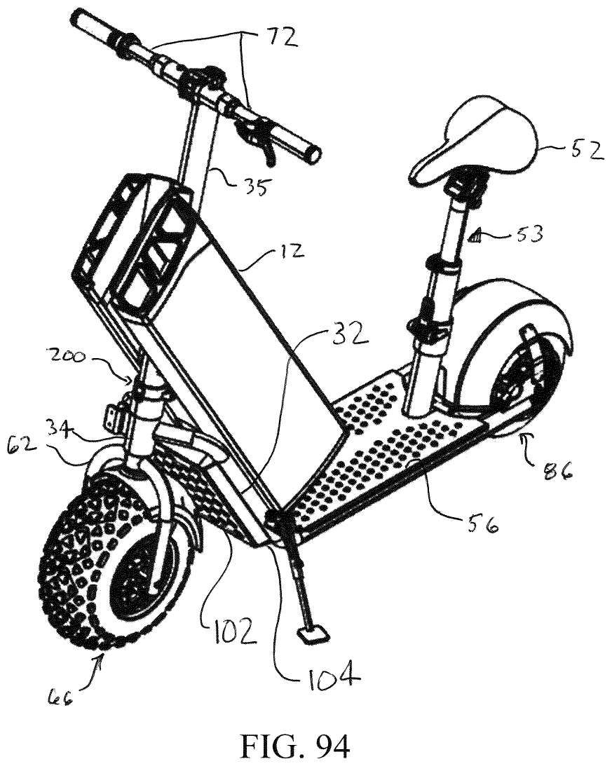

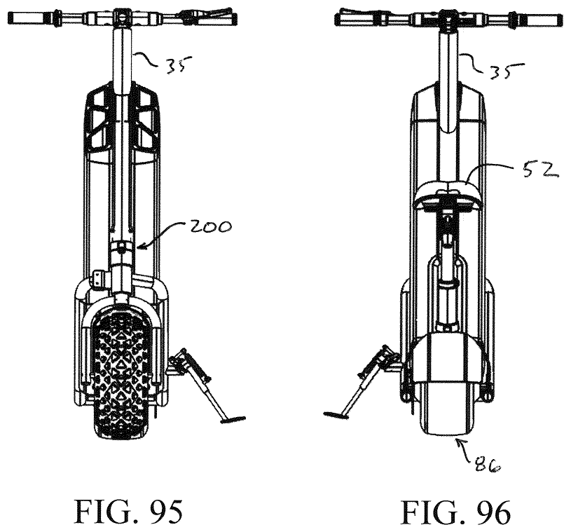

FIGS. 12-248 illustrate embodiments of a rideable cart (10) whereby the user can stand and/or sit while operating the cart (10). Further, embodiments such as that of FIGS. 12 & 217, as well as many others, allow operation with a golf bag (12) extending between the handlebars (12), while embodiments such as FIGS. 27, 46, and 234, as well as many others, allow operation with the golf bag (12) offset from a wheel plane (WP), while embodiments such as that of FIG. 94 incorporate a unique golf bag (12), seen in FIGS. 139 and 149-154, designed to permit passage of a steering column (35) through the golf bag (12). The referenced wheel plane (WP), seen in FIGS. 178-179, is a vertical plane passing through the center of the front wheel (66) and the center of the rear wheel (86).

The embodiment of FIGS. 177-196 will first be disclosed in detail because aspects of the embodiment are applicable to all other embodiments, which is true of all disclosure associated with any embodiment being transferable to any other embodiment; for instance, but not limited to, any of the frame tube (32) configurations and folding or pivoting joints may be incorporated into any of the disclosed embodiments, and likewise any of the base segments (42), which may be single piece, or multiple components designed for translation between positions, as seen in FIG. 212, may be incorporated into any of the disclosed embodiments, and likewise with respect to the steering column (35), handlebar(s) (72), fork, fork bracket (63), handlebar connector, battery, battery location, battery cradle, running board(s) (56), frame tube connector assembly (205), and/or steering connector assembly (201).

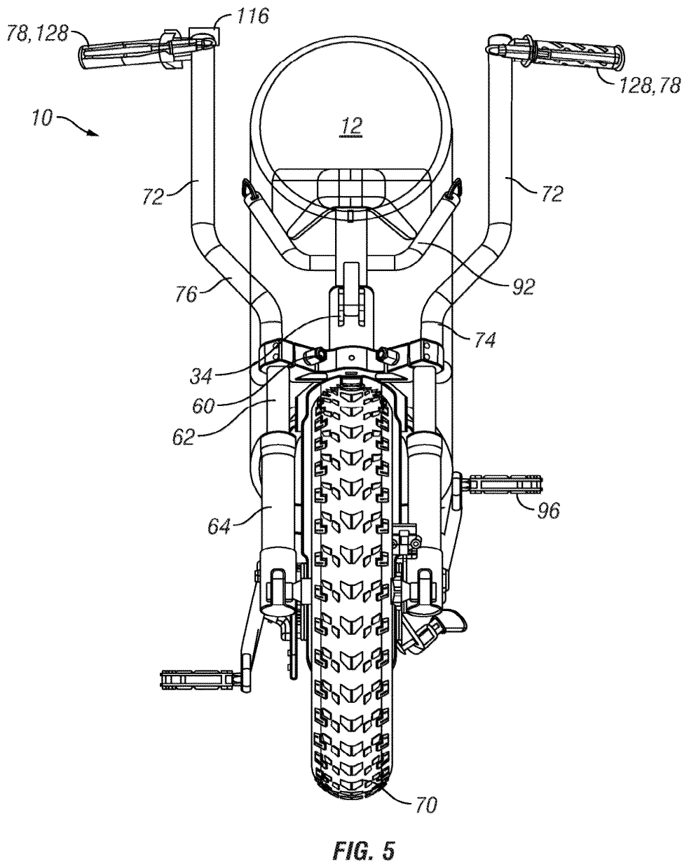

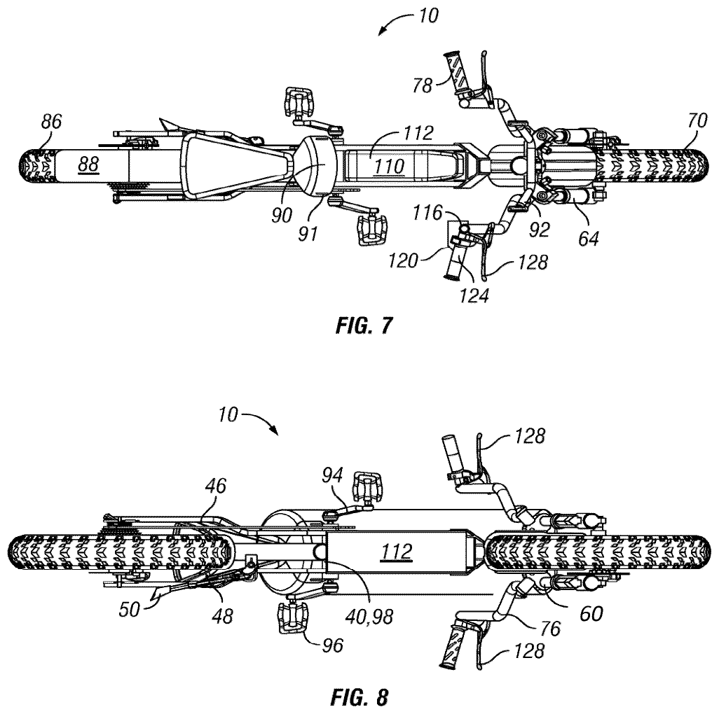

The primary components include a frame tube (32) extending upwardly and forward from a base segment (42), which extends rearwardly to the rear wheel (86) and serves as support for a running board (56). Some embodiments include a seat support (53) extending upward from the base segment (42) to support a seat (52). The seat support (53) may be adjustable in height and include a upper seat support (53U) and a lower seat support (53L). The frame tube (32) extends upward and over a portion of a front wheel (66) to a steering bracket (34), which in bicycle nomenclature is often referred to as a head tube while the frame tube (32) is analogous to a bicycle down tube. In this embodiment a steering column (35) and a front fork (62) are rotationally attached to the steering bracket (34). A handlebar (72), or individual left and right handlebars (72), are attached to the steering column (35), which in some embodiments is made possible via a handlebar connector (63). As previously explained, when the handlebar (72) is connected to the system below the steering bracket the connection is referred to as a front fork bracket (63), as seen in FIGS. 1-11, however when the handlebar (72) is connected to the system above the steering bracket, and in the embodiment of FIG. 177 to the steering column (35), the connection is referred to as a handlebar connector (63). The seat (52) is not required in any of the embodiments, as illustrated by FIGS. 74 and 155.

A portion of the steering column (35), or the interface of the steering column (35) and the steering bracket (34), may incorporate a connector assembly (200), as seen in FIGS. 177, and 205-208, referred to as a steering connector assembly (201) seen in FIG. 180. Further, a portion of the frame tube (32) may also incorporate a connector assembly (200), as seen in FIGS. 177 and 209-210, referred to as a frame tube connector assembly (205) seen in FIG. 180. The steering connector assembly (201) and the frame tube connector assembly (205) work to reorient the components from a riding configuration, seen in FIG. 177, to a storage configuration illustrated in FIG. 184.

The frame tube connector assembly (205) allows all of the components connected to the frame tube (32) above the frame tube connector assembly (205) to rotate 180 degrees so that the front wheel (66) is over the running board (56). The steering connector assembly (201) allows the steering column (35) to pivot and fold about the steering connector assembly (201). In one embodiment in the storage configuration a steering column axis (35A), seen in FIG. 190, is within ±25 degrees of being parallel to the surface of the running board (56), and in further embodiments ±20 degrees, ±15 degrees, ±10 degrees, ±5 degrees, or 0 degrees (i.e. parallel). In another embodiment in the storage configuration a portion of the steering column (35) contacts the seat (52), seen in FIG. 184. In a further embodiment the steering connector assembly (201) is also securely lockable in the storage configuration so that the steering column (35) cannot pivot. In one embodiment the seat support (53) is adjustable in height via an upper seat support (53U) sliding within a lower seat support (53L). As seen in FIG. 190, the seat support (53) has a support axis (53A) and a support axis angle (53AA), which is measured from horizontal, or a ground plane (GP). Similarly, the steering column (35) has a column axis (35A) and a column axis angle (35AA), also measured from horizontal, or the ground plane (GP). Likewise, the support surface of the seat (52) is oriented at a seat angle (52A). In one embodiment the support axis angle (53AA) is less than 90 degrees, and in further embodiments is less than 88 degrees, 86 degrees, 84 degrees, or 82 degrees. In another embodiment the support axis angle (53AA) is at least 65 degrees, and in further embodiments at least 70 degrees, 72 degrees, 74 degrees, or 76 degrees. In another embodiment at least a portion of the seat support (53) extends over a portion of the rear wheel (86), while in a further embodiment at least a portion of the upper seat support (53U) extends over a portion of the rear wheel (86), and in a further embodiment at least a portion of the lower seat support (53L) extends over a portion of the rear wheel (86). In one embodiment the support axis angle (53AA) is ±15 degrees of the column axis angle (35AA), and in further embodiments is ±10 degrees, ±5 degrees, or 0 degrees (i.e. parallel). In another embodiment the seat angle (52A) is at least 2.5 degrees, and in further embodiments at least 5 degrees, 7.5 degrees, 10 degrees, or 12.5 degrees. In another series of embodiments the seat angle (52A) is no more than 35 degrees, and no more than 30 degrees, 25 degrees, or 20 degrees in additional embodiments. As seen in FIG. 180, the bag support base (97) is oriented at a bag support base angle (97A) that is at least 10 degrees in one embodiment, and no more than 45 degrees in another embodiment.

The upper seat support (53U) has an upper seat support length and the lower seat support (53L) has a lower seat support length, which in one embodiment is less than the upper seat support length. In one embodiment the upper seat support length is at least 10% greater than the lower seat support length, and in further embodiments at least 15%, 20%, 25%, or 30%. In a further embodiment the upper seat support length is no more than 180% of the lower seat support length, and in further embodiments no more than 170%, 160%, 150%, or 140%. These relationships are not merely for adequate structural engagement of support sections, but rather to facilitate compactness in the storage configuration. In a further embodiment the end of the lower seat support (53L) is open and unobstructed by any other components so that the upper seat support (53U) may extend out of the lower end of the lower seat support (53L), as seen in FIG. 204. In an additional embodiment safety is provided by ensuring the upper seat support (53U) cannot be secured to the lower seat support (53L) when the upper seat support (53U) is extending out of the lower end of the lower seat support (53L). Thus, in the riding configuration the upper seat support (53U) will not be the component defining the minimum ground clearance.

A maximum elevation of the seat (52H), seen in FIG. 179, is selected to facilitate riding while leaning against the seat (52) rather than just sitting on the seat (52), and thus in one embodiment the seat support (53) must be adjustable to heights greater than that required for a solely seated riding configuration, and the components must be configured to safely facilitate the increased height. Improved safety and maneuverability has been found in a riding position characterized by a slight user lean against a high seat (52) with a narrow forward neck so that it is easily positioned between a rider's legs without requiring an unnatural riding position with the legs spread apart. As seen in FIG. 177, the seat (52) has a seat width (52W) that may vary from a minimum width to a maximum width, and a seat length (52L). In one embodiment the seat length (52L) is at least 150% of the maximum seat width (52W), and at least 160%, 170%, or 180% in further embodiments. In one embodiment the maximum seat width (52W) is equal to, or greater than, a front tire width (70W), seen in FIG. 182; while in a further embodiment the maximum seat width (52W) is equal to, or less than, a rear tire width (90W). In one embodiment the maximum elevation of the seat (52H), seen in FIG. 179, is at least 22″, and in further embodiments at least 24″, 26″, or 28″. The handlebar height (72W), seen in FIG. 179, is at least 32″ inches in one embodiment, and at least 34″, 36″, 38″, or 40″ in further embodiments. In an even further embodiment the seat (52) is not a seat but a lower back support, or buttocks support.

A center of gravity (CG) of the rideable cart (10) is illustrated in FIG. 181. The location of the center of gravity (CG), and all of the disclosed relationships, are essential in providing a rideable cart (10) that is stable off-road, particularly when transporting a user and a golf bag full containing a full set of golf clubs and all the ancillary components typically found in a golf bag. The center of gravity (CG) is located a CGy dimension behind the front axle (67), measured horizontally parallel to the ground plane (GP), and is located a CGh dimension above the ground plane (GP), measured vertically perpendicular to the ground plane (GP), as seen in FIG. 181. Additionally, the rideable cart (10) has a minimum clearance (500), seen in FIG. 181, and a wheelbase (510), which is the horizontal distance measured between a center of the front wheel (66) and a center of the rear wheel (86), as seen in FIG. 180. Further, a top surface of the running board (56) is located a running board height (56H), measured vertically above the ground plane (GP), as shown in FIG. 181. The point that the front tire (70) contacts the ground plane (GP) directly below the front axle (67) is the contact point (530). The steering bracket (34) defines the headset axis (520), seen in FIG. 181, which intersects the ground plane (GP) at an axis contact point (540). A horizontal distance from the contact point (530) and the axis contact point (540) is referred to as the trail (550), which is positive if the axis contact point (540) is further from the rear wheel (86) than the contact point (530). The front tire (70) has a front tire outer diameter, and the rear tire (90) has a rear tire outer diameter, wherein the front tire outer diameter is greater than the rear tire outer diameter. Further, the front tire (70) has a front tire width (70W) and the rear tire (90) has a rear tire width (90W), wherein the rear tire width (90W) is greater than the front tire width (70W). Additionally, the front tire (70) has a front tire crown radius, and the rear tire has a rear tire crown radius that is greater than the front tire crown radius. Characteristics of the tires disclosed herein are measured when no external forces are acting upon the tires.

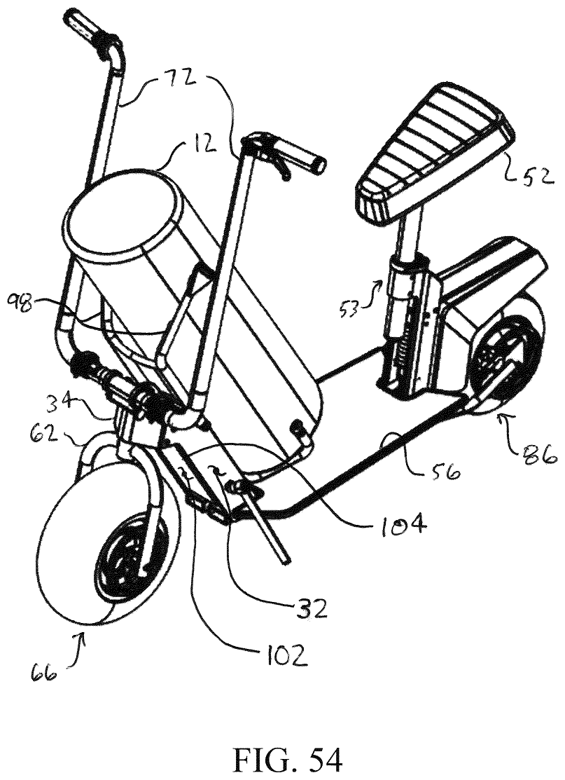

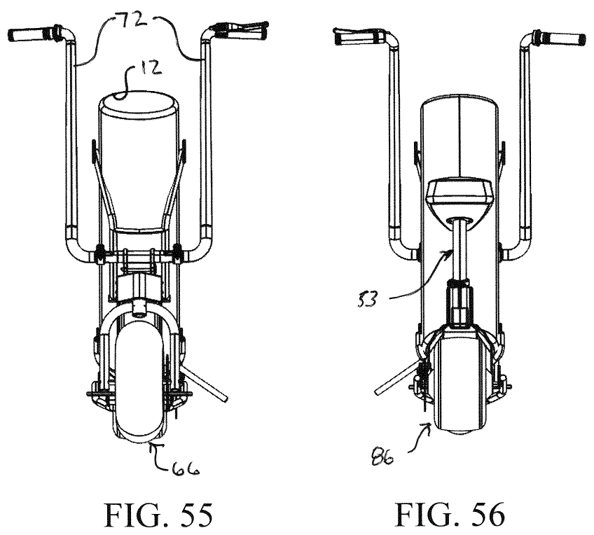

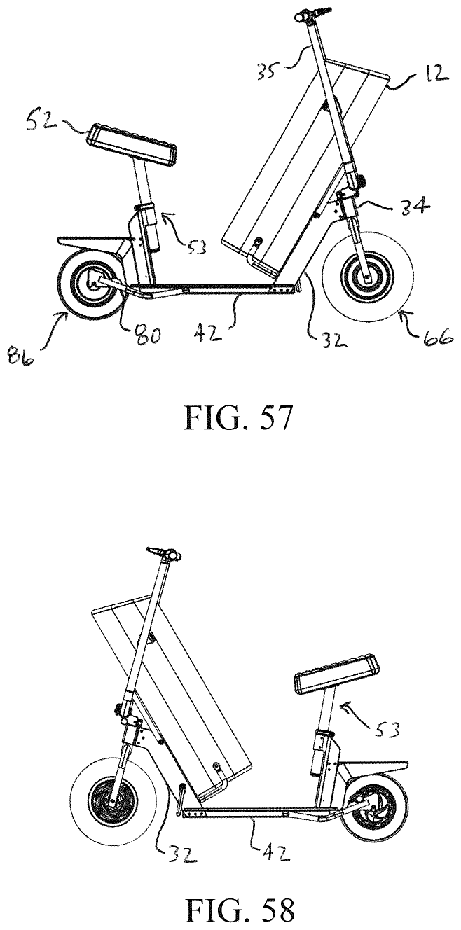

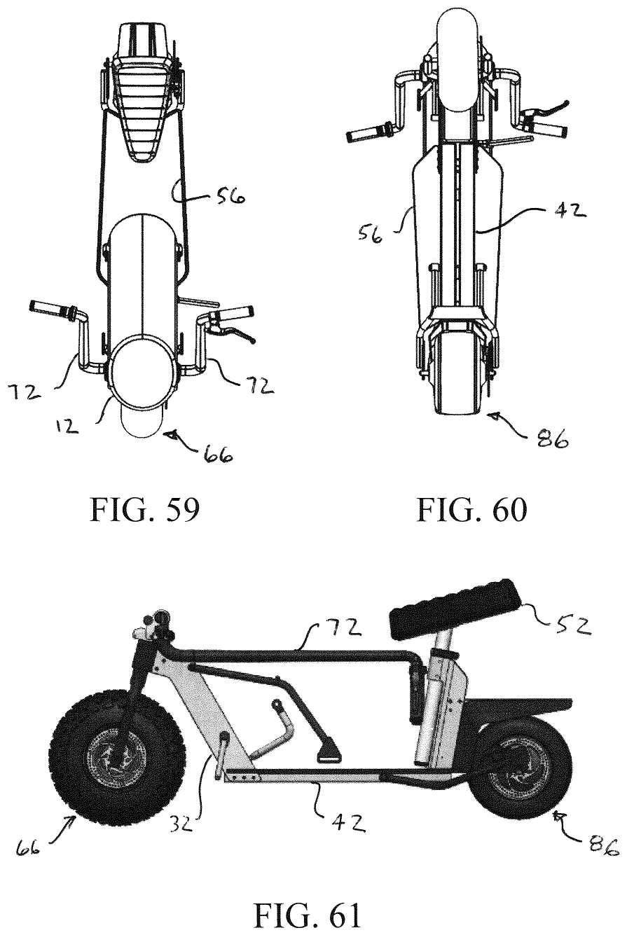

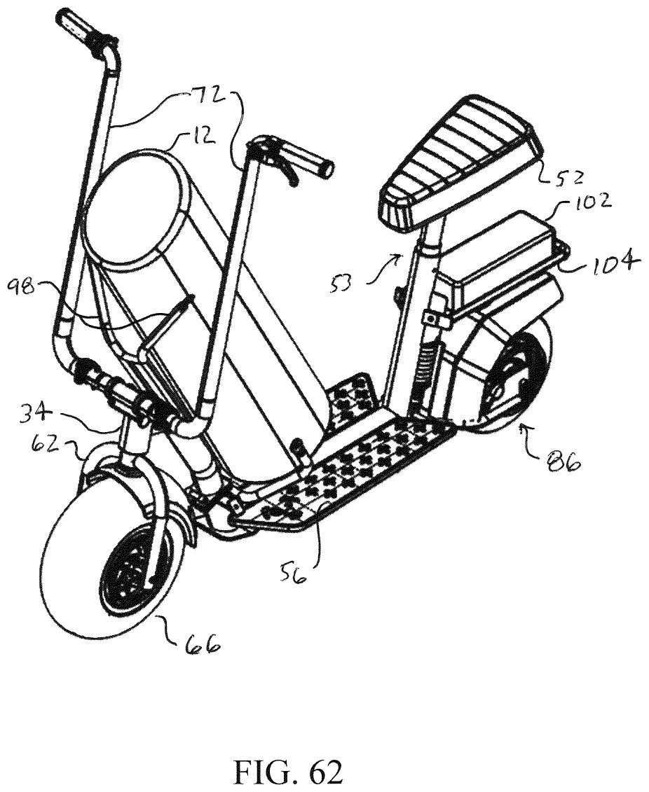

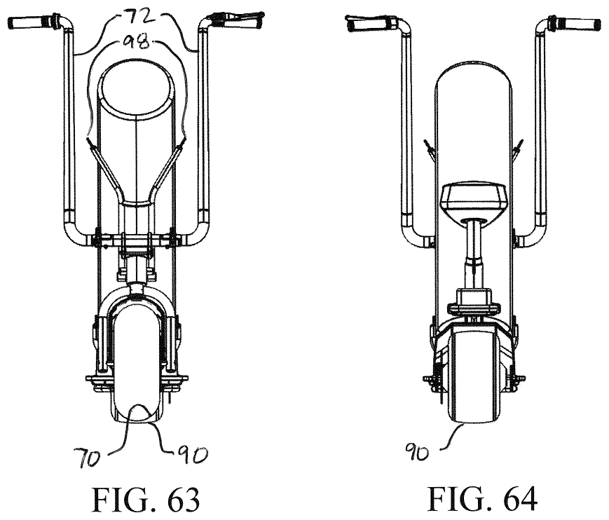

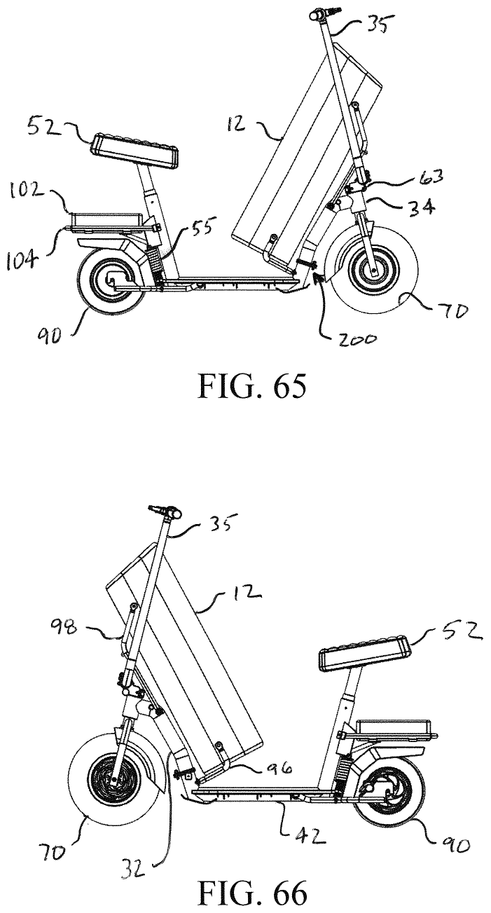

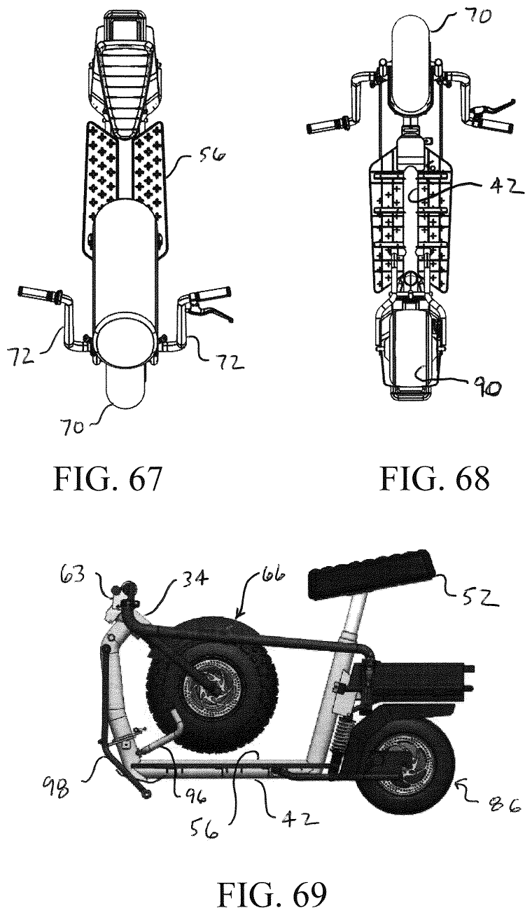

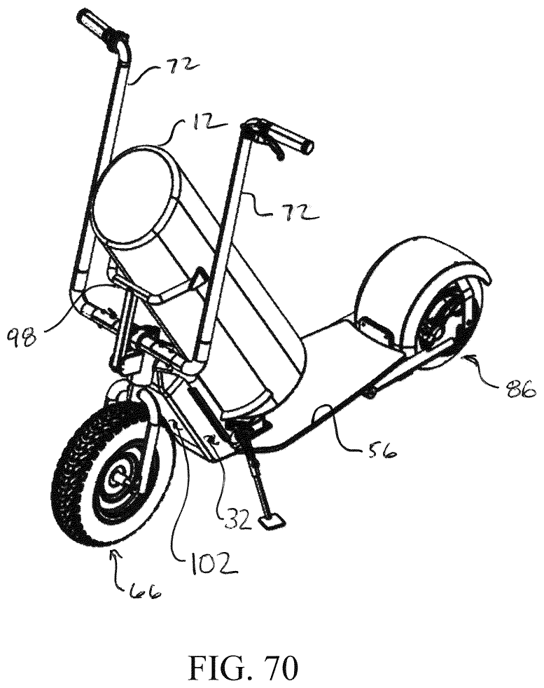

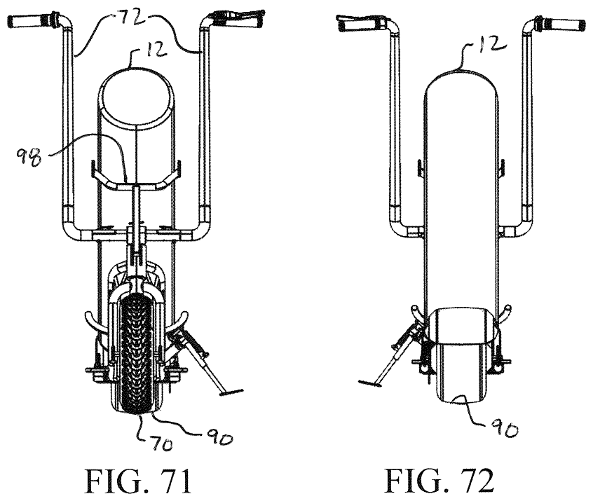

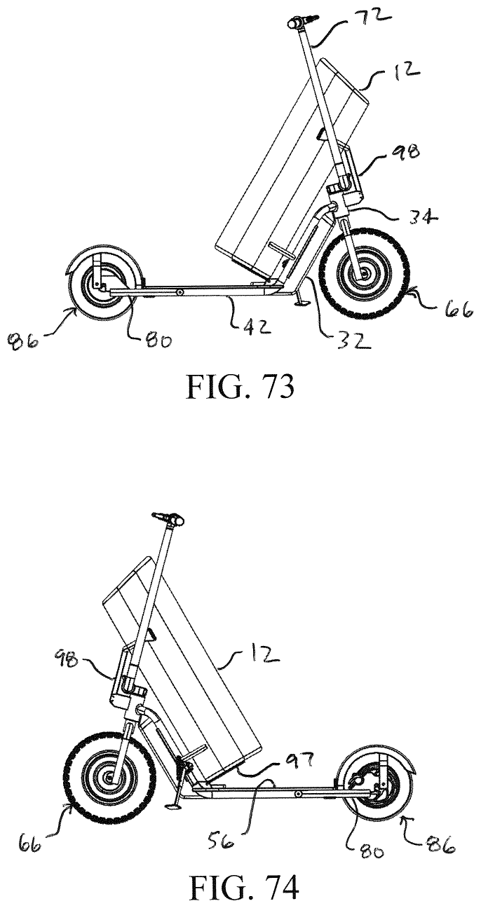

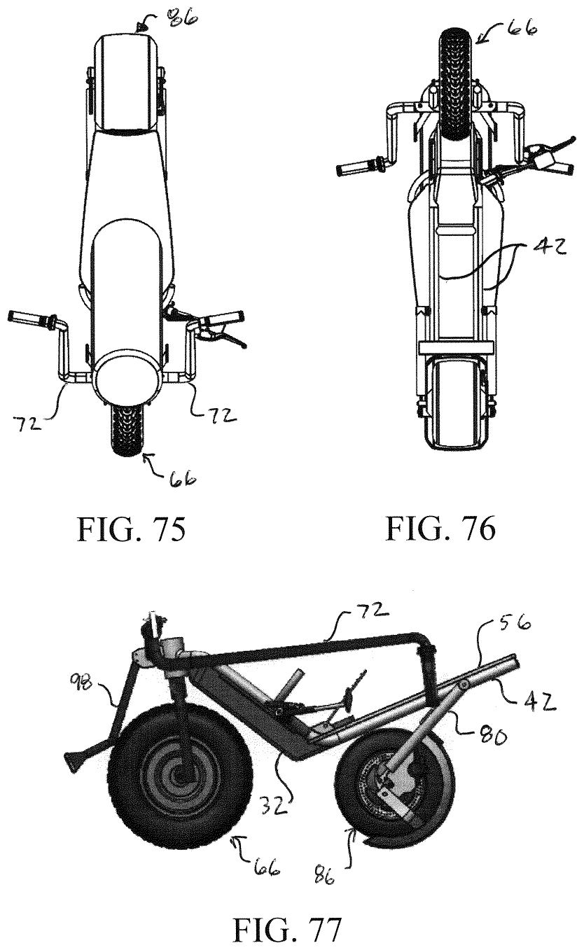

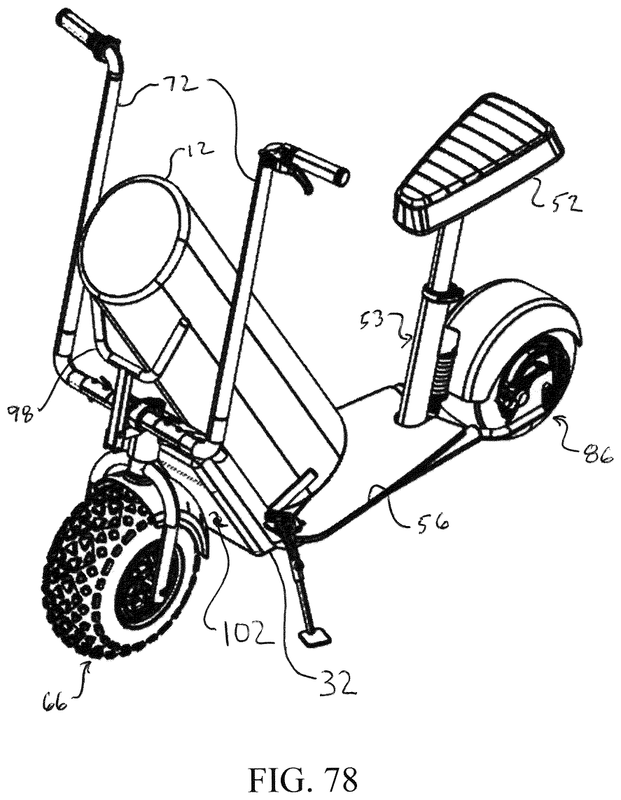

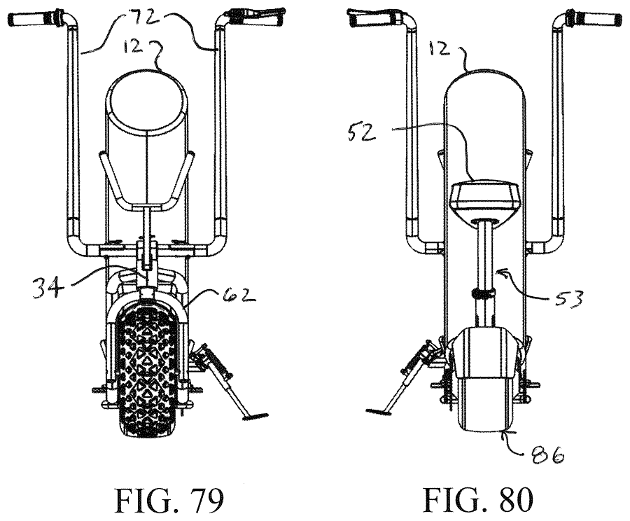

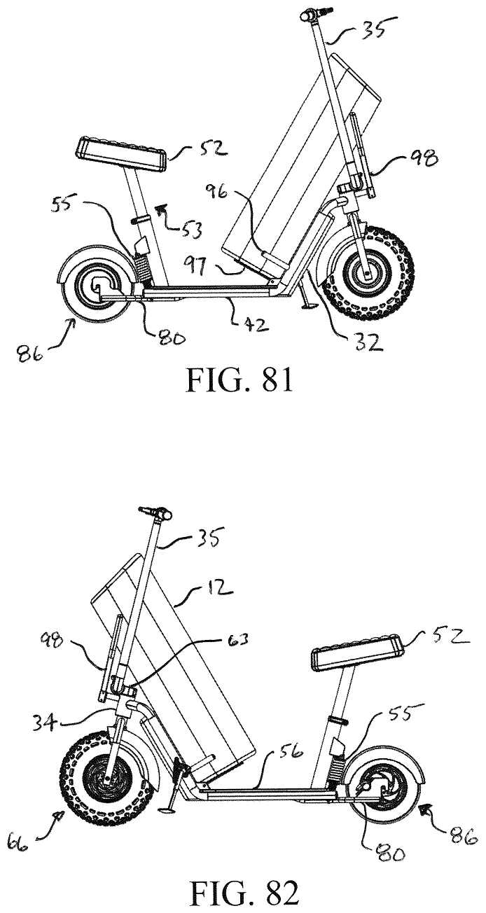

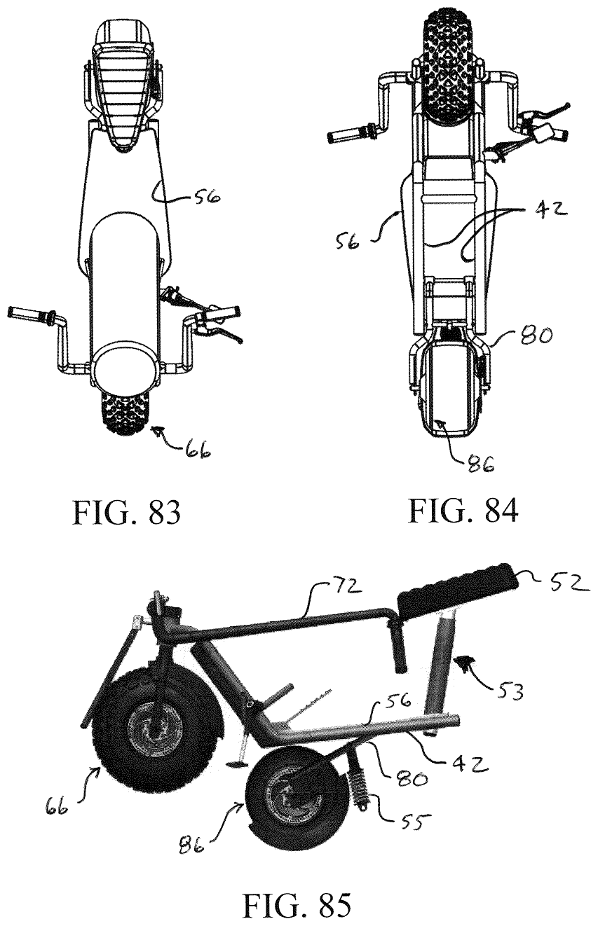

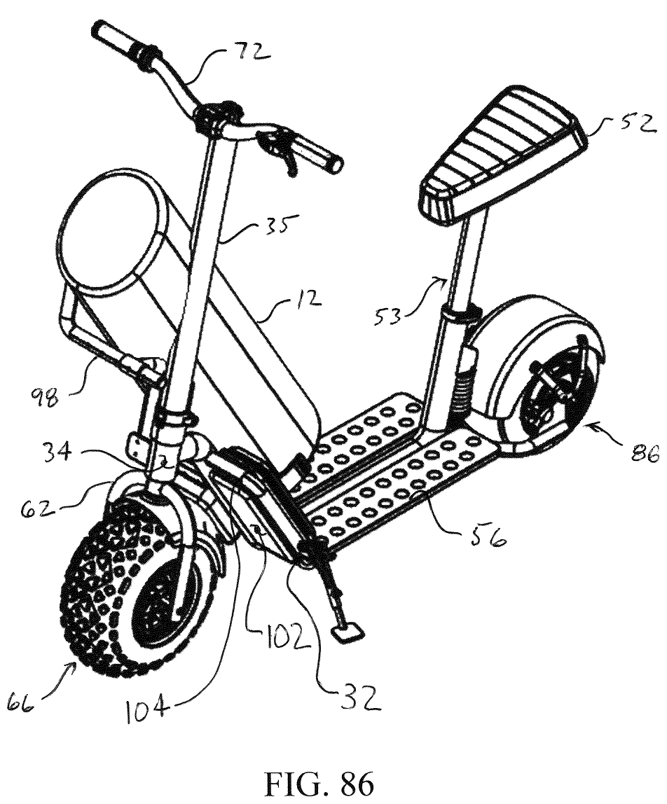

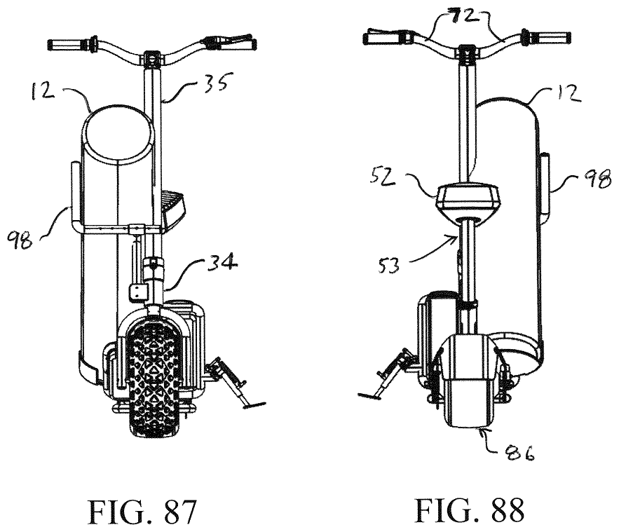

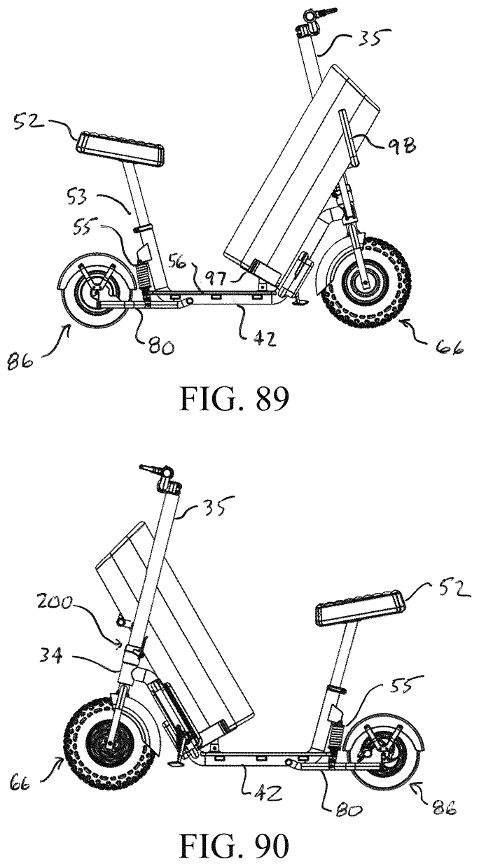

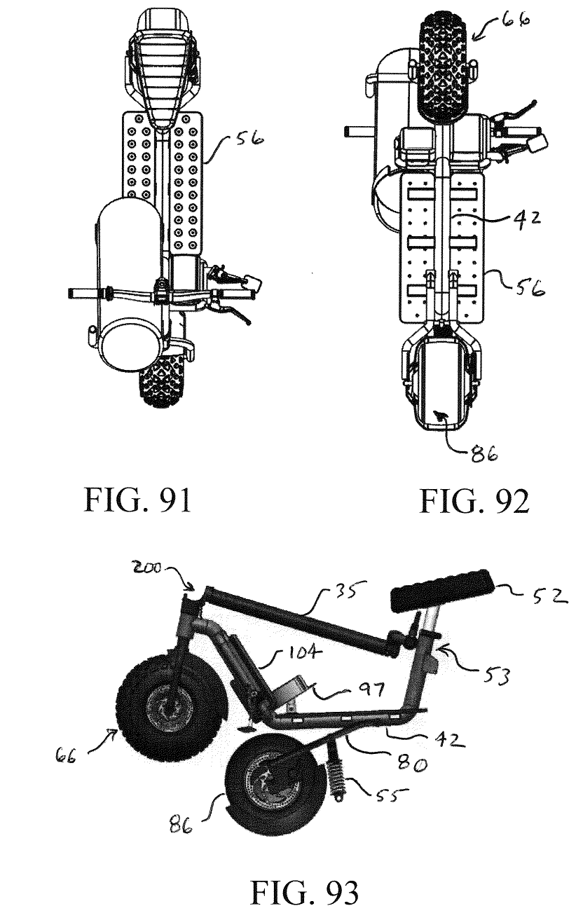

In one embodiment CGy is within ±25% of CGh, and in further embodiments within ±20%, ±15%, ±10%, or ±5%. In one embodiment CGy is greater than CGh. In a further embodiment CGy is less than 45% of the wheelbase (510), and less than 40%, 38%, or 36% in further embodiments. In another series of embodiments CGy is at least 24%, 26%, 28%, or 30% of the wheelbase (510). Such forward center of gravity embodiments are influenced by many factors, including, but not limited to, the location of the battery (102) and/or battery cradle (104), such as when attached to, within, or created by the frame tube (32), as seen in FIGS. 54, 70, 78, 86, and 94, or attached to, within, or created by the base segment (42), as seen in FIG. 108, 116, 132, 169, 177, as well as the configuration of the steering column (35), frame tube (32), and base segment (42), and how the unit is configured to transform from a safe riding configuration to a storage configuration, whether that be via pivoting components, folding components, and/or translating components. These forward center of gravity embodiments create unique challenges and have some undesirable performance characteristics that are reduced by other relationships disclosed herein, including, but not limited to, attributes of the tires.

For instance, in one embodiment the front tire outer diameter is at least 10% greater than the rear tire outer diameter, and in further embodiments at least 15%, 17.5%, or 20% greater. Another series of embodiments limits this relationship such that the front tire outer diameter is no more than 160% of the rear tire outer diameter, and in further embodiments is no more than 150%, 140%, or 130%. The rear tire width (90W) is at least 10% greater than the front tire width (70W) in one embodiment, and the rear tire width (90W) is at least 12.5%, 15%, or 17.5% greater than the front tire width (70W) in further embodiments. Another series of embodiments limits this relationship such that the rear tire width (90W) is no more than 160% of the front tire width (70W) in one embodiment, and in further embodiments is no more than 150%, 140%, 130%, or 125%.

The front tire crown radius is at least 30% of the front tire outer diameter in one embodiment, and is at least 32.5%, 35%, or 37.5% in further embodiments. Another series of embodiments limits this relationship such that the front tire crown radius is no more than 85% of the front tire outer diameter in one embodiment, and is no more than 80%, 75%, 70%, 65%, 60%, 55%, 50%, or 45% in further embodiments. In another embodiment the rear tire crown radius is at least 200% of the front tire crown radius, and is at least 225%, 250%, 275%, or 300% in further embodiments. In another embodiment the front tire outer diameter is at least 30% of the wheelbase (510), and at least 32.5% or 35% in additional embodiments. The front tire outer diameter is no more than 50% of the wheelbase (510) in one embodiment, and no more than 47.5%, 45%, 42.5%, or 40% in additional embodiments. Further, the front tire outer diameter is at least 85% of CGh in one embodiment, and at least 90%, 95%, and 100% in further embodiments. Conversely, the rear tire outer diameter is no more than CGh in one embodiment, and no more than 95%, 90%, or 85% in further embodiments. In another stable embodiment CGh is less than the front tire outer diameter, but greater than the rear tire outer diameter; and in a further embodiment CGy is likewise less than the front tire outer diameter, but greater than the rear tire outer diameter. In another embodiment rear tire has a lower design pressure than the front tire. The disclosed relationships ensure the cart (10) can easily traverse curbs, holes, cracks, and steep obstacles, while being stable under severe braking and reducing the likelihood of pitching a rider forward. The disclosed rear wheel is beneficial high torque, relative to motor power, is desired.

A flatter crowned rear tire embodiment is implemented with the standard crown front tire. The effect of this combination is improved stability when stepping onto the cart and at low speed. The front wheel provides plenty of steering control. The flatter crown rear tire takes away slightly from maneuverability in that it slightly reduces the turning or leaning rate, but not noticeably so; while the improved low speed handling is noticeable. This wider flat crowned tire is 5.5″-8.5″ wide and 9″-14″ in diameter, and has been found to complement a riding style that has the feet parallel and pointing ahead, which is how most people naturally try to ride a traditional scooter with a narrow deck, which can be dangerous. One embodiment reduces such risk by incorporating a width of the running board (56), measured perpendicular to the wheel plane (WP), that is narrower toward the rear wheel (86) and wider toward the front wheel (66), thereby promoting a more stable and reliable toe-out riding position.

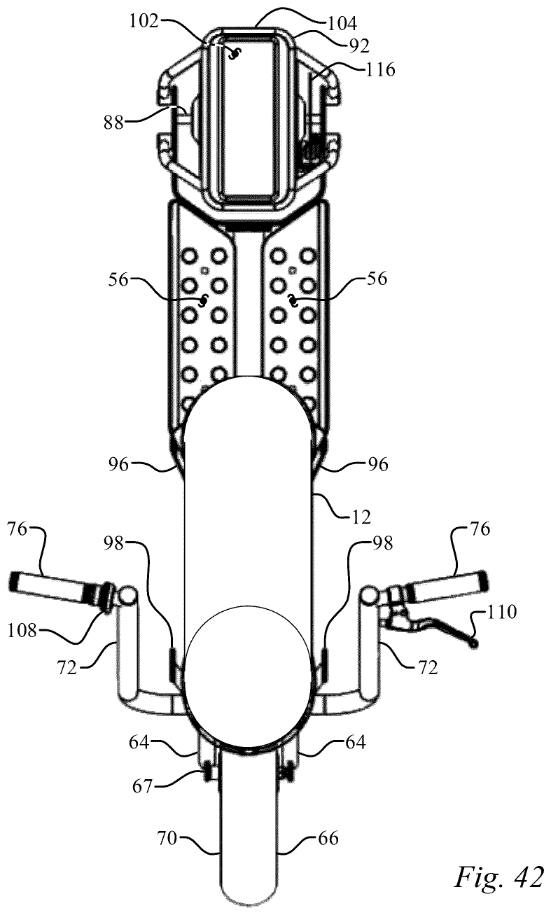

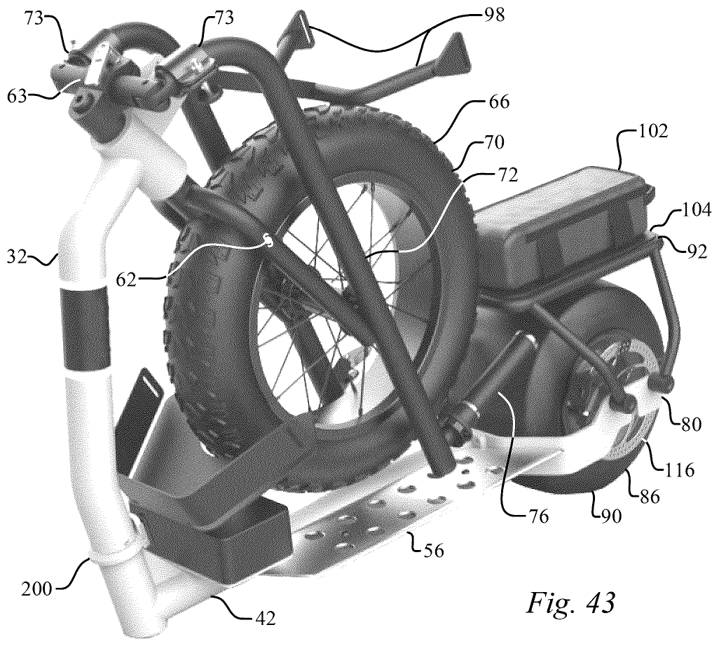

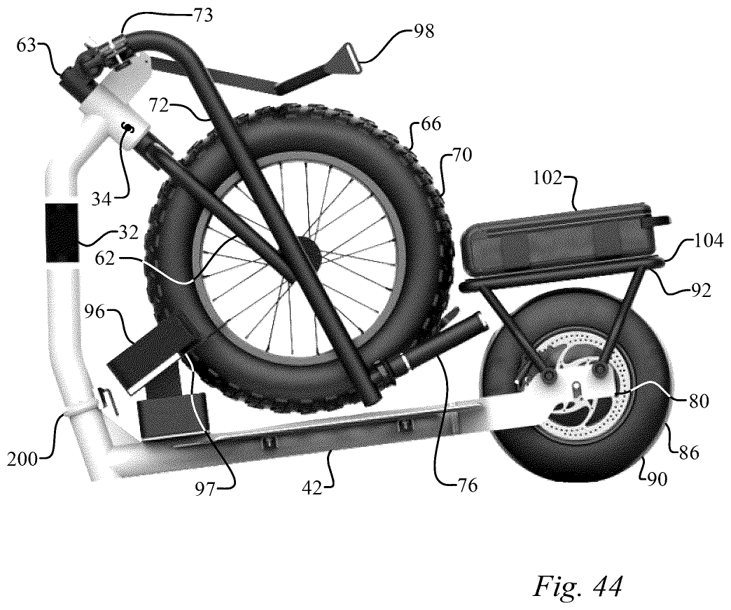

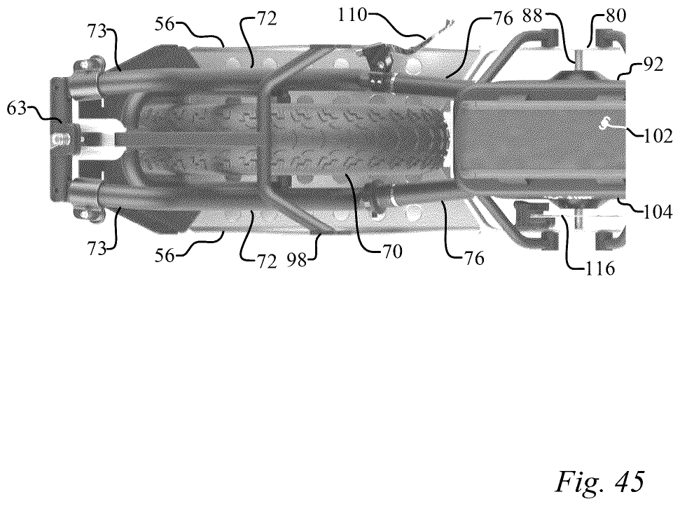

The trail (550) is at least 1.0″ in one embodiment, and at least 1.5″, 1.75″, and 2.0″ in further embodiments. Another series of embodiments limits the trail (550) to no more than 4.0″ in one embodiment, and no more than 3.5″, 3.0″, or 2.5″ in additional embodiments. The CGh is preferably less than 5 times the minimum clearance (500) in one embodiment, and less than 4.75 times, 4.5 times, 4.25 times, or 4.0 times in further embodiments. Another series of embodiments has a CGh of at least 2.75 times the minimum clearance (500) in one embodiment, and at least 3.0 times, and 3.25 times in further embodiments. The running board height (56H), seen in FIG. 181, is no more than 65% of the rear tire outer diameter in one embodiment, and no more than 60%, 55%, or 50% in further embodiments. The running board height (56H) is at least 35% of the rear tire outer diameter in one embodiment, and at least 37.5% or 40% in additional embodiments. The running board height (56H), seen in FIG. 181, is no more than 50% of the front tire outer diameter in one embodiment, and no more than 47.5%, 45%, or 42.5% in additional embodiments. Embodiments having the battery (102) located below the running board (56) require a battery having a height, measured vertically as with all heights shown in FIG. 181, of no more than 2.5 inches, and in further embodiments no more than 2.25 inches or 2.0 inches. Embodiments having base segments (42) consisting of a dual tube configuration, such as those of FIGS. 42, 76, 84, 98, 106, 122, 138, 148, 168, 175, 183, 203, and 212, are ideal designs for locating the battery (102) below the running board (56).

As with all the relationships disclosed herein, these relationships are more than mere optimization, maximization, or minimization of a single characteristic or variable, and are often contrary to conventional design thinking yet have been found to achieve a unique balance of the trade-offs associated with competing criteria such as size, portability, durability, weight distribution, CG placement, vehicle dynamics, and low speed stability over rough terrain while carrying a load. The aforementioned balance requires trade-offs among the competing characteristics recognizing key points of diminishing returns. Therefore, this disclosure contains a unique combination of relationships that produce enhanced stability, performance, and durability, while controlling the overall size and arrangement of components to facilitate a very compact storage configuration. Further, the relative dimensions, including, but not limited to component length, width, depth, thickness, and height, as well as their placement within the cart, and their relationships to one another and the other design variables disclosed herein, influence the aforementioned criteria. Additionally, many embodiments have identified upper and/or lower limits ranges. For embodiments outside these ranges or relationships, the performance may suffer and adversely impact the goals of the design.

The figures show numerous riding configurations and storage configuration. The movement of various components about the illustrated connector assembly(s) (200) would be evident to one skilled in the art, and therefore will not be described in detail. The location and configuration of the illustrated connector assembly(s) (200) is essential to achieving the desired storage configuration, both for portability of the cart (10) to and from the golf course, but also for shipping of the cart (10). For instance, in the illustrated storage configurations the cart (10) can be confined in a box having a width measured in the same direction as the tire widths of FIGS. 182-183, a height measured in the same direction as the heights of FIG. 181, and a length measured in the same direction as wheelbase (510); wherein (a) the girth is 130 inches or less, where the girth is defined as two times the sum of the width and height, and (b) the sum of the girth and the length is 165 inches or less. Most of the disclosed embodiments achieve this compact storage configuration via the rotation of the front wheel (66) 180 degrees such that it is positioned above the running board (56), however some embodiments achieve a compact storage configuration via a sliding base segment (42) that reduces the wheelbase (510) in the storage configuration. One such wheelbase reducing embodiment is illustrated in FIGS. 124-131 and 211-248 whereby the base segment (42) is composed of multiple sections that may translate with respect to one another to reduce the wheelbase (510) in the storage configuration. While the illustrated base segment (42) of FIGS. 124-131 and 234-248 is a single tube configuration, another sliding tube embodiment, seen in FIGS. 211-233, incorporates a sliding tube on each side of the cart (100), similar to the perimeter tubes shown in FIG. 203.

As seen in FIGS. 211 and 242, the running board(s) (56) may pivot, such that a rear end of the running board (56) rotates upward toward the seat (52) to accommodate the translational movement of the base segment (42). In the embodiment of FIG. 245 the running board(s) (56) are pivotably mounted to the base segment at a location offset and offset distance from the forwardmost point of the running board(s) (56). In this embodiment the rearwardmost point of the running board(s) (56) is capable of rotating about the pivot mount such that an elevation of the rearwardmost point of the running board(s) (56) is greater than the diameter of the rear wheel. As seen in the embodiment of FIGS. 240-241, the running board (56) comprises two individual sections, with one on each side of the base segment. In one embodiment the offset distance is at least 20% of a maximum width of the running board (56), and at least 22.5%, 25%, or 27.5% in additional embodiments. In another series of embodiment the offset distance is no more than 45% of the maximum width of the running board (56), and in additional embodiments no more than 42.5%, 40%, 37.5%, or 35%.

The running board (56) of the embodiments of FIGS. 211-233 is pivotably mounted to the base segment (42) such that it can rotate at least 90 degrees from the riding configuration to the storage configuration; which in further embodiments is at least 95, 100, 105, or 110 degrees. A further series of embodiments caps the rotation to no more than 150 degrees, with additional embodiments reducing the range to no more than 145, 140, or 135 degrees.

As seen in FIG. 212, the base segment (42) may incorporate a rear base-segment portion (47) that includes a cooperating mid base-segment portion (49), which is designed to cooperate with and pass through at least a portion of a forward base-segment portion (45). While the illustrated embodiment incorporates these portions on both a left and right side, one skilled in the art will appreciate that this is also true for the embodiments having one central base segment (42), as seen in FIGS. 240-248. Additionally, the configuration may be exactly the opposite in further embodiments whereby the forward base-segment portion (45) includes the cooperating mid base-segment portion (49), which is designed to cooperate with and pass through at least a portion of the rear base-segment portion (47).

Referring now to FIG. 216, in the storage configuration illustrated a portion of the cooperating mid base-segment portion (49) has passed through the forward base-segment portion (45). In fact the cooperating mid base-segment portion (49) has a forwardmost end and a rearwardmost end. As seen in FIG. 216 in the storage configuration, in one embodiment the forwardmost end is capable to translating to a position forward of the forward base-segment portion (45), while in another embodiment the forwardmost end is forward of a rear edge of the front tire, while in still another embodiment the forwardmost end is forward of the front axle (67). However, in another embodiment the translation is limited such that the forwardmost end does not extend forward of a front edge of the front tire. In other words, in one embodiment, in the storage configuration the mid base-segment portion (49) has translated such that the forwardmost end is located between the rear edge and the front edge of the front tire; while in a further embodiment the forwardmost end is located between the front axle (67) and the front edge of the front tire.

In another embodiment, as seen in FIGS. 215, 217, and 212, in the riding configuration the forwardmost end of the mid base-segment portion (49) extends no more than a projecting distance beyond the forward base-segment portion (45). In one embodiment the projecting distance is no more than 25% of the CGh dimension, while further embodiments reduce the percentage to no more than 20%, 15%, or 10%. In another embodiment the projecting distance is no more than 20% of the CGy dimension, while further embodiments reduce the percentage to no more than 15%, 10%, or 5%. In another embodiment, and again in the riding configuration, the forwardmost end of the mid base-segment portion (49) does not extend beyond the forward base-segment portion (45). The position of the forwardmost end balances the stability and durability of the base segment (42), with the safety of the rider. As seen in FIG. 231 the forward base-segment portion (45) may incorporate at least one slide-bushing (146), with each having a slide-bushing length. In one embodiment the slide-bushing length is at least 10% of the translation dimension (51), and in further embodiments at least 15% or 20%. In another embodiment at least each individual forward base-segment portion (45) incorporates at least two slide-bushings (146).

As illustrated in the figures, the base segment (42) may be reduced in length by a translation dimension (51), seen in FIG. 212. In one embodiment the translation dimension (51) is at least 15% of the wheelbase (510), and in further embodiments is at least 20%, 25%, or 30%. Another series of embodiments limits the translation dimension (51) to no more than 60% of the wheelbase (510), and no more than 55%, 50%, 45%, 40%, or 35% in additional embodiments. The forward base-segment portion (45) has a forward base-segment length, and the rear base-segment portion (47) has a rear base-segment length, which does not include a length of the mid base-segment portion (49). In one embodiment the translation dimension (51) is greater than the forward base-segment length and the rear base-segment length; and in a further embodiment the forward base-segment length is greater than the rear base-segment length.

The translation dimension (51) is within 30% of the front tire outer diameter in one embodiment, and the percentage is reduced to 25%, 20%, or 15% in further embodiments. In a further embodiment the translation dimension (51) is less than the front tire outer diameter, while in another embodiment the translation dimension (51) is greater than the rear tire outer diameter. In an alternative embodiment the translation dimension (51) is greater than the front tire outer diameter.

In one embodiment the wheelbase (510) is reduced by at least 8 inches from the riding configuration to the storage configuration, while in further embodiments it is reduced by 9, 10, 11, or 12 inches. As illustrated in FIG. 131, such designs may incorporate a pivoting running board (56) to thereby permit the rear wheel (86) and seat support (53) to move closer to the front wheel (66).

As seen in FIG. 219, an angle α1 is the angle of the frame tube (32), while angle α2 is the angle of a line connecting the forwardmost points at which a bag (12) contacts the upper and lower bag mounts, while α3 is the angle of the bag (12) itself, which is the longitudinal axis of the bag. In one embodiment angle α1 is less than at least one of angle α2 or angle α3. An angle α4 is a steering adjustment angle, as seen in FIG. 229, which in one embodiment is at least 15 degrees, and in further embodiments is at least 17.5, 20, 22.5, 25, 27.5, or 30 degrees. As seen in FIG. 227, the battery (102) and battery cradle (104) may be configured to be releasably locked together via at least one battery release (103), and optionally for rotational engagement whereby the lower end of the battery (102) engages the cradle (104) first and the battery (102) is rotated into the cradle (104) and an upper battery lock engages the cradle (104). The system may incorporate at least one control/communication cable length accommodation system (111), which is illustrated in FIG. 230 as a coiled section of cable to accommodate the translation dimension (51). Further, a control enclosure (113) may be located within the forward base-segment portion (45), as seen in FIG. 230.

The illustrated connector assembly (200) of FIGS. 205-208 includes a lever (260) and a pivot (270) to allow the steering column (35) to pivot through at least 90 degrees in one embodiment, and at least 95 degrees, 100 degrees, and 105 degrees in further embodiments. The connector assembly (200) of FIGS. 209-210 includes a plurality of receivers (280), with at least two spaced 180 degrees apart, which in the illustrated embodiment are located on the frame tube (32) with a fastener pivot (292) located on the base segment (42), however the configuration may be the opposite-namely with the receivers (280) on the base segment (42) and the fastener pivot (292) on the frame tube (32). The connector assembly (200) also may include a fastener (290) and a cam (295) to quickly and securely engage the fastener (290) within whichever receiver (280) has been rotated to align with the fastener (290). The cam (295) may be pivoted to release tension on the fastener (290) and allow it to rotate out of the receiver (280) about the fastener pivot (292), thereby allowing the frame tube (32) to rotate 180 degrees so that the opposite receiver aligns with the fastener (290), which can enter the receiver (280) and the cam (295) may be activated to tension the fastener (290) and secure the frame tube (32). The movement provided by the connector assembly(s) (200) of the figures is self-evident and may be included herein as full written disclosure.

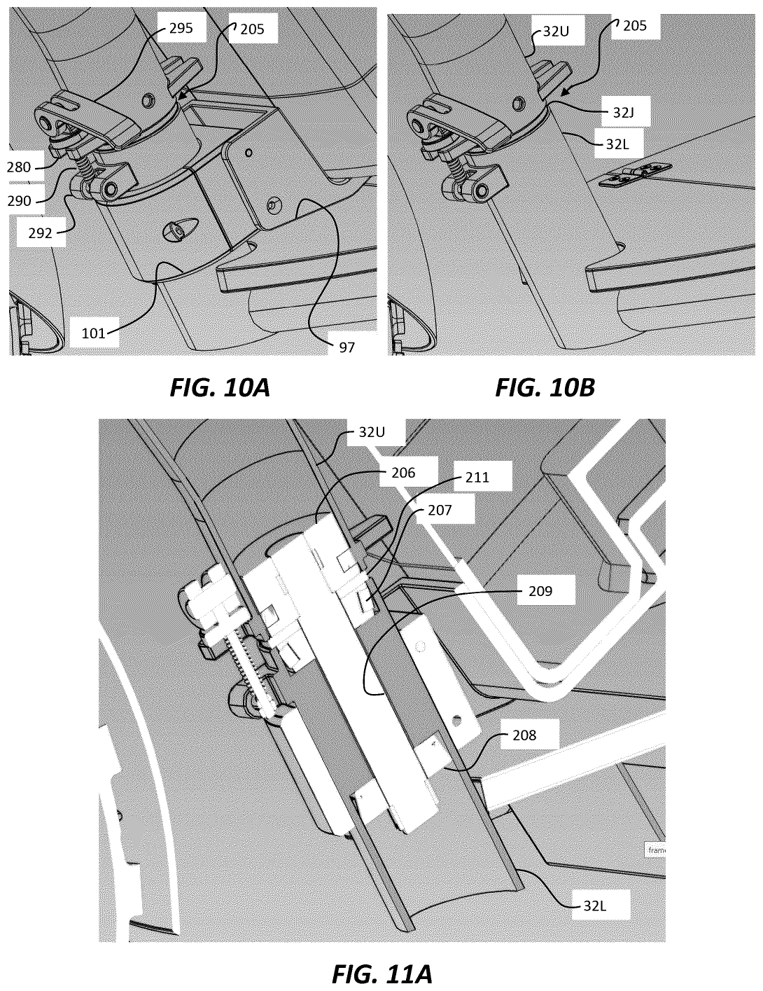

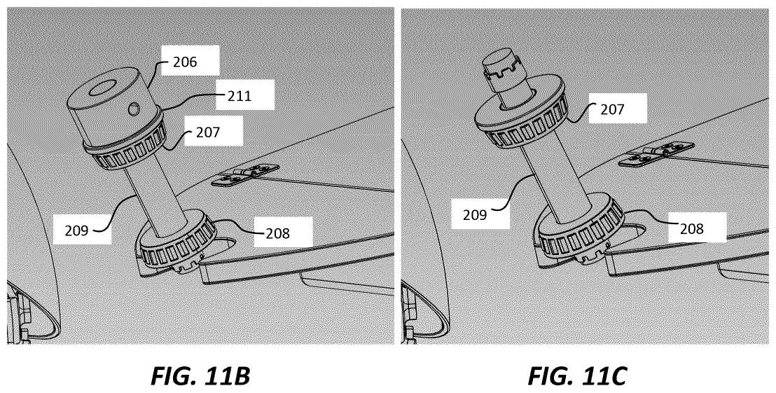

FIG. 10A illustrates the frame tube connector assembly (205) on the frame tube structure (32), as well as a support base bracket (101) connected to the frame tube structure (32) to support the bag support base (97). The support base bracket (101) and bag support base (97) have been removed for clarity in FIG. 10B, which illustrates the frame tube joint (32J) in the frame tube structure (32), thereby separating an upper frame tube (32U) and a lower frame tube (32L). FIG. 11A is a cross-sectional view through the frame tube connector assembly (205) illustrating an embodiment having an upper tube plug (206) in the upper frame tube (32U), an upper bearing (207), a lower bearing (208), and a fastener (209) joining the upper frame tube (32U) to the lower frame tube (32L) and passing through portions of the lower bearing (208), the upper bearing (207), and the upper tube plug (206). A further embodiment incorporates a washer (211) to separate the upper frame tube (32U) and the lower frame tube (32L). In one embodiment a portion of the lower frame tube (32L) is open to allow tool access to the frame tube connector assembly (205), and in one embodiment to remove an end nut from the fastener (209) to allow removal of the lower bearing (208) and the complete separation of the upper frame tube (32U) from the lower frame tube (32L). In one embodiment the upper bearing (207) and/or the lower bearing (208) is a tapered bearing. In another embodiment both the upper bearing (207) and the lower bearing (208) are located in the lower frame tube (32L). In one embodiment the upper tube plug (206) has a plug diameter and a plug length measured in the longitudinal direction of the fastener (209), and the fastener (209) has a fastener diameter and a longitudinal fastener length. Similarly the upper bearing (207) has an upper bearing diameter and an upper bearing longitudinal length, and the lower bearing (208) has a lower bearing diameter and a lower bearing longitudinal length. In one embodiment the plug length is greater than the fastener diameter, and the plug length is greater than the upper bearing length and/or the lower bearing length. FIG. 11B illustrates an embodiment of the frame tube connector assembly (205) with the upper frame tube (32U) and the lower frame tube (32L) removed from view for clarity; and FIG. 11C goes further with the upper tube plug (206) removed from view for clarity. The embodiment of FIG. 11A illustrates the lower frame tube (32L) having a reinforced region with a thickened tube wall having a reinforced region tube thickness that is at least 50% of the fastener diameter. In a further embodiment the reinforced region has a reinforced region length that is at least 50% of the fastener length. In another embodiment the support base bracket (101) is connected to the frame tube structure (32) within the reinforced region.

In one embodiment the rear wheel (86) is driven by a brushless, direct current, 48 volt, internal geared hub motor having a power rating of 1000-1500 watts. In another embodiment the internal geared hub motor has a sun gear with 3 planets, which in another embodiment produces a 5 to 1 reduction. In a further embodiment the RPM is about 360, and in a further embodiment the stall torque is at least 70 Newton meter (N-m), and at least 75, 80, 85, or 90 N-m in further embodiments. In one embodiment the battery is lithium battery with a capacity of at least 600 watt-hour. The internal geared hub motor performs better on the golf course, where high torque, not high speed, is required; and direct drive (aka gear less motors), require much bigger battery and motor capacities.

Many of the illustrated embodiments include a unique divided passageway golf bag (12), as illustrated in FIGS. 139 and 149-154. The bag (12) has a top (600), bottom (610), length (620), width (630), depth (640), passageway (650), front wheel side (680), and rear wheel side (690). The passageway (650) has a passageway width (660) and a passageway length (670). The bottom (610) may include a receiver (615) designed to cooperate and receive a support base projection (99) extending from the bag support base (97), as seen in FIG. 186. In one embodiment the depth (640) is greater than the width (630). In another embodiment the passageway length (670) is at least 30% of the length (620), and at least 35%, 40%, or 45% in further embodiments. Another series of embodiments limits the passageway length (670) to no more than 75% of the length (620), and in additional embodiments no more than 65%, 60%, or 55%. The depth that the passageway (650) extends into the bag (12) from the front wheel side (680) toward the rear wheel side (690) varies, with the depth increasing as the passageway (650) approaches the top (600). The passageway width (660) is at least 20% of the bag width (630) in one embodiment, and at least 25% and 30% in further embodiments. The passageway width (660) is less than 60% of the bag width (630) in another embodiment, and less than 55%, 50%, 45%, and 40% in further embodiments. The orientation of the passageway (650) is easily understood with reference to FIG. 190 and the column axis (35A), the column axis angle (35AA), and the support base angle (97A) of FIG. 180, thereby producing a bag (12) that fits securely on the bag support base (97) and around a portion of the steering column (35), while permitting the steering column (35) to rotate freely.

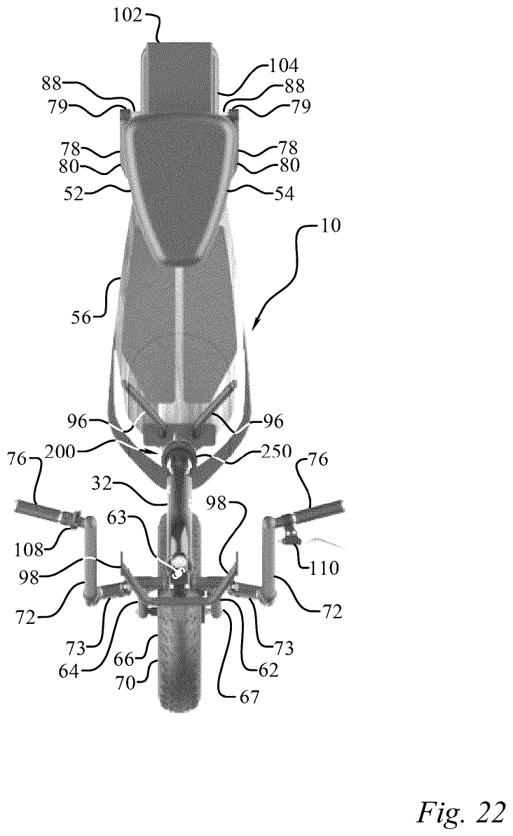

Now referring to an embodiment of rideable cart (10), as seen in FIGS. 12, 13, and 20-24, having a personal support sba (20), a front wheel and steering sba (22), a rear wheel sba (24), a frame tube (32), a base segment (42), a running board (56), as seen in FIG. 12.

The personal support sba (20) may include a seat (52) having a cushion (54) that may be made of polyurethane foam and or natural fiber fill, a battery cradle (104) which supports a rechargeable battery (102). However, the battery (102) and battery cradle (104) may be located in a number of locations as disclosed herein. For example, the battery (102) and/or battery cradle (104) may be located above the rear wheel (86) seen in FIGS. 12, 13, 16, 19-24, just to name a few such figures, or attached to, within, or created by the frame tube (32), as seen in FIGS. 54, 70, 78, 86, and 94, or attached to, within, or created by the seat support (53), as seen in FIG. 100, or attached to, within, or created by the base segment (42), as seen in FIG. 108, 116, 132, 169, 177.

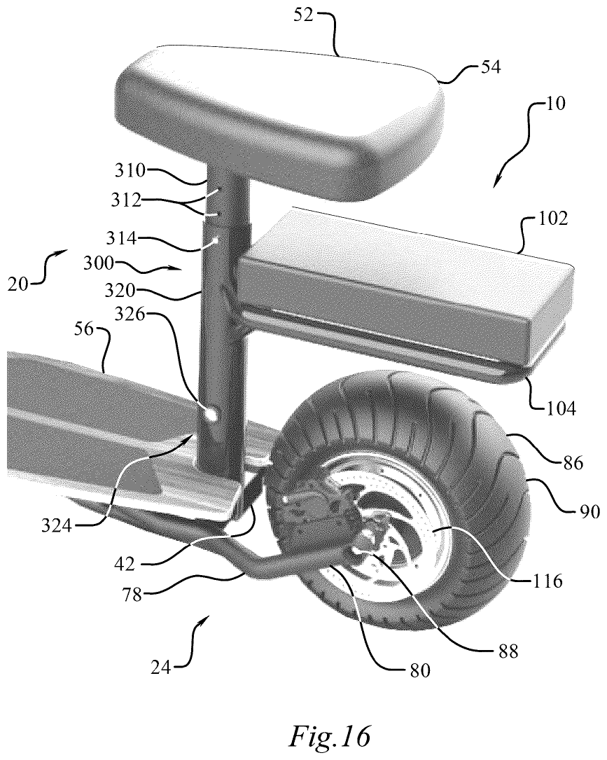

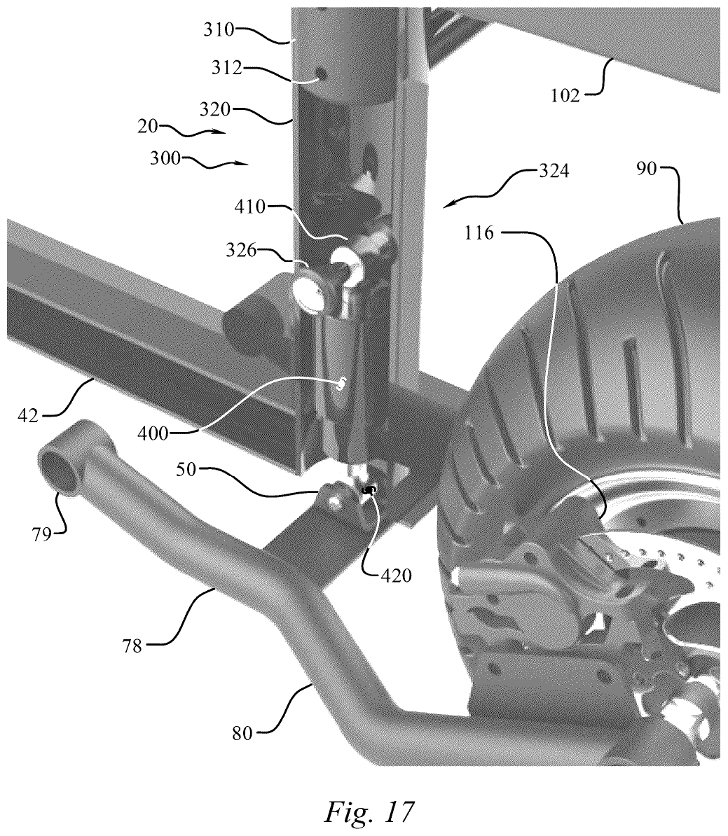

The personal support sba (20) may further include a shock mount housing (300), abbreviated as SMH, and a shock absorber (400) mounted therein, having a shock absorber proximal end (410) and a shock absorber distal end (420), best seen in FIGS. 16 and 17. In this embodiment, the shock absorber (400) helps reduce the jarring a golfer or rider (13) experiences while using the rideable cart (10). The shock mount housing (300) has a SMH upper portion (310) having at least one SMH upper portion adjustment apertures (312) and a SMH upper portion adjustment fastener (314) that cooperates with a SMH lower portion adjustment aperture (322) to allow adjustment of the seat (52) height, best seen in FIG. 16. The seat (52) height is set by aligning one of the SMH upper portion adjustment apertures (312) with the SMH lower portion adjustment aperture (322) and passing the SMH upper portion adjustment fastener (314) through the respective aligned apertures (312, 322). In one embodiment of shock mount housing (300), the SMH upper portion (310) telescopes from inside of a SMH lower portion (320) allowing linear height adjustments of the seat (52), best seen in FIGS. 12, 16, 17 and 21. In another embodiment, the SMH upper portion (310) may telescopically encompass the SMH lower portion (320), not illustrated in the drawings. Furthermore, the SMH upper portion (310) may also have an attached battery cradle (104), which holds a rechargeable battery (102), as seen in FIGS. 12, 13, 16, 19-21 and 23. The SMH lower portion (320) further includes a SMH lower portion shock proximal end mounting aperture (324), and a SHH lower portion shock proximal end mounting fastener (326) which is positioned through one side of the SMH lower portion shock proximal end mounting aperture (324) through an aperture located on the shock proximal end (410) and through the SMH lower portion shock proximal end mounting aperture (324) located on the opposite side of the SMH lower portion (320), as seen in FIG. 17. Additionally, the SHH lower portion shock proximal end mounting fastener (326) may be, but not limited to, a simple pin, a pin having a locking detent, a pin held in place with a cotter pin, and a nut and bolt combination. The shock distal end (420) is connected to a shock absorber bracket (50) that connects to a rear fork (78), also seen in FIG. 17.

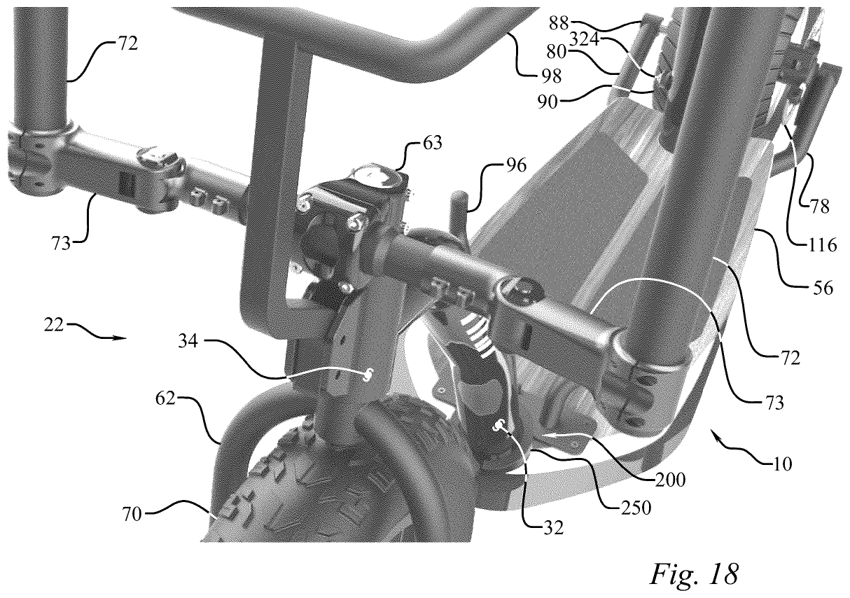

The front wheel and steering sba (22) in the current embodiment may include: a steering bracket (34) connect to pivot tubes (73) adapted to rotationally and lockable connect a set of handlebars (72) having handle grips (76) terminating the ends thereof, a control unit (108) connected to one of the handle grips (76), and a brake actuator (110) connected to the other handle grips (76), illustrated in FIGS. 12, 13 and 18. The front wheel and steering sba (22) may further include: a front fork bracket (63) that connects a front fork (62) having a pair of front fork arms (64) to the steering bracket (34), such that when the steering bracket (34) is rotated it causes the front fork bracket (63) to rotate. The front fork arms (64) may connect to a front axle (67) of a front wheel (66) having a front tire (70). The front tire (70) in one embodiment may be a typical pneumatic tire, while in another embodiment it may be a tubeless or non-pneumatic tire that may be solid, foam filled, or airless tires that use polymer spokes to maintain the tire's shape and structural integrity. Further, the front wheel and steering sba (22) may have a front brake (114), illustrated in FIG. 13, that may be mechanically, pneumatically, hydraulically or electrically connected to and actuated by the brake actuator (110). In addition, the front wheel and steering sba (22) may also incorporate an upper bag cradle (98) that functions as a part of a bag support sba (26), seen in FIGS. 12, 13, 20-24.

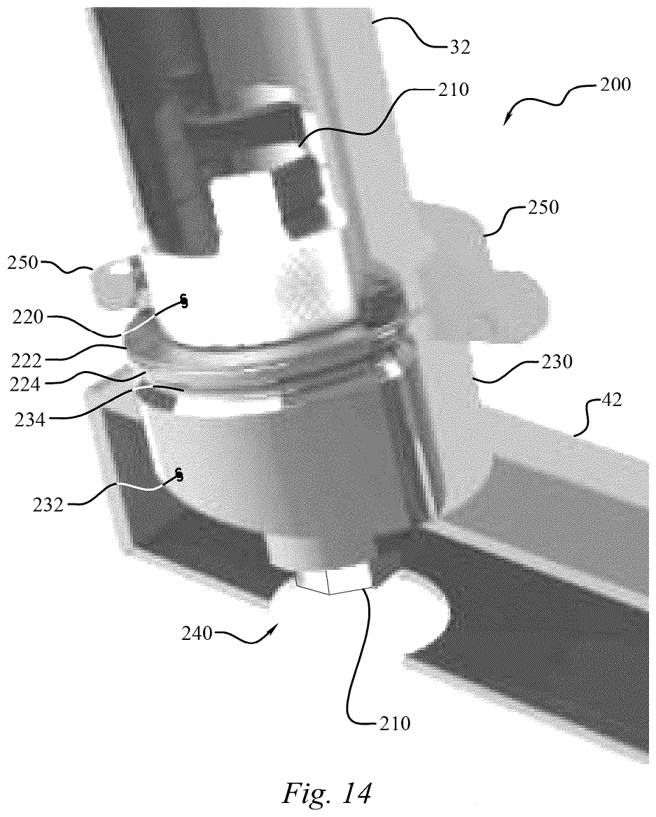

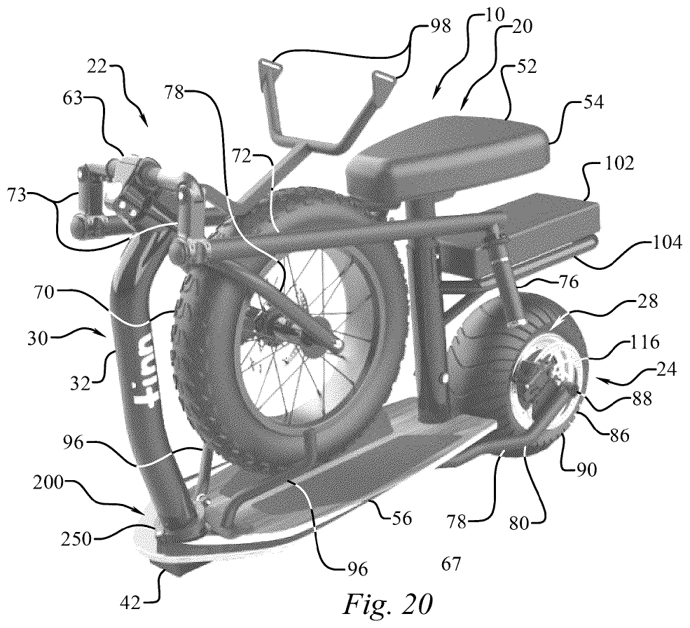

In the current embodiment, one end of the frame tube (32) is rotationally connected to the steering bracket (34), as seen in FIGS. 12, 13 and 19, and the opposite end of the frame tube (32) connects to a connector assembly (200), seen in FIGS. 14, 15, 19-23. One embodiment of connector assembly (200) may allow the frame tube (32) to rotate into a storage mode (30), as seen in FIGS. 20, 23 and 24. In this embodiment, the connector assembly (200) may include a frame tube end plug (220) that is fixedly positioned in the end of the frame tube (32), seen in FIG. 14, and a frame tube pivot plate (222) having a frame tube pivot plate surface (224). The connector assembly (200) may further include a base segment connection tube (230) connected to a base segment (42), illustrated in FIG. 14. Additionally, the base segment connection tube (230) may further have a base segment connection tube plug (232), having a base segment connection pivot surface (234), that is fixedly positioned in the base segment connection tube (230), shown in FIG. 14. The frame tube pivot plate surface (224) abuts against the base segment connection pivot surface (234) and allows slidable rotation in respect to each other. A connector fastener (210) may pass through the center of the frame tube end plug (220) and the base segment connection tube plug (232) to secure them together, and still allow rotation. The connector fastener (210) may be, but not limited to, a bolt and nut fastener combination, a riveted fastener, or a detent catch system. Additionally, the base segment (42) may have a base segment fastener aperture (240) that allows access to a portion of the connector fastener (210), as seen in FIG. 14. The connector assembly (200) may utilize a locking clamp (250) that may further include a locking clamp screw (252) that engages the locking clamp (250) to rotationally lock the connector assembly (200) and prevent the rotation of the frame tube (32) in respect to the base segment (42). In another embodiment, not illustrated, the connector assembly (200) may allow removal of the front wheel and steering sba (22) from the rideable cart (10) for storage purposes and lacks the rotational functionality of the former embodiment. In yet another embodiment, the connector assembly (200) may allow the frame tube (32) to pivot towards the personal support sba (20) after a locking mechanism is disengaged, not illustrated in the drawings.

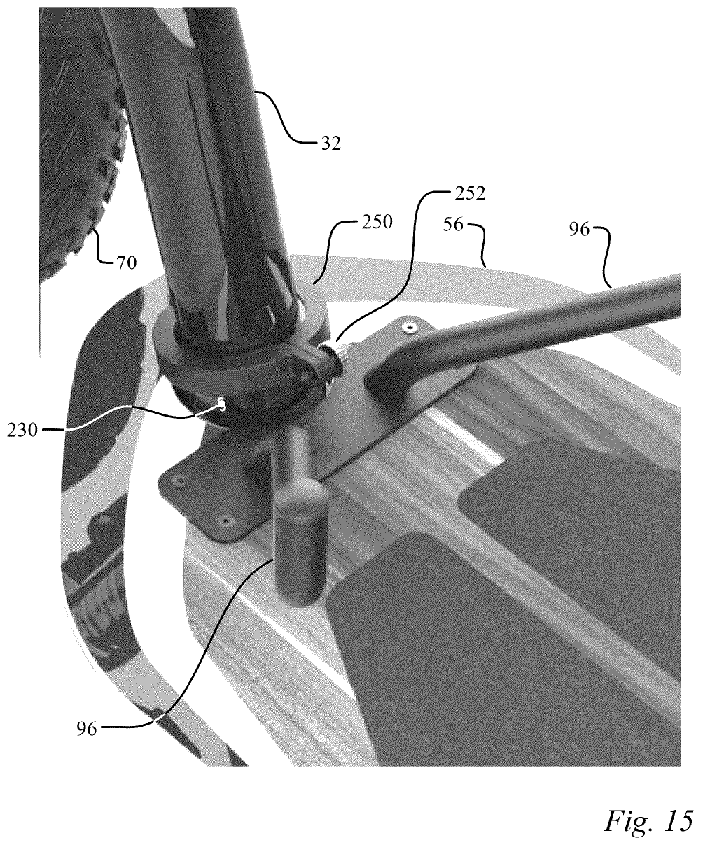

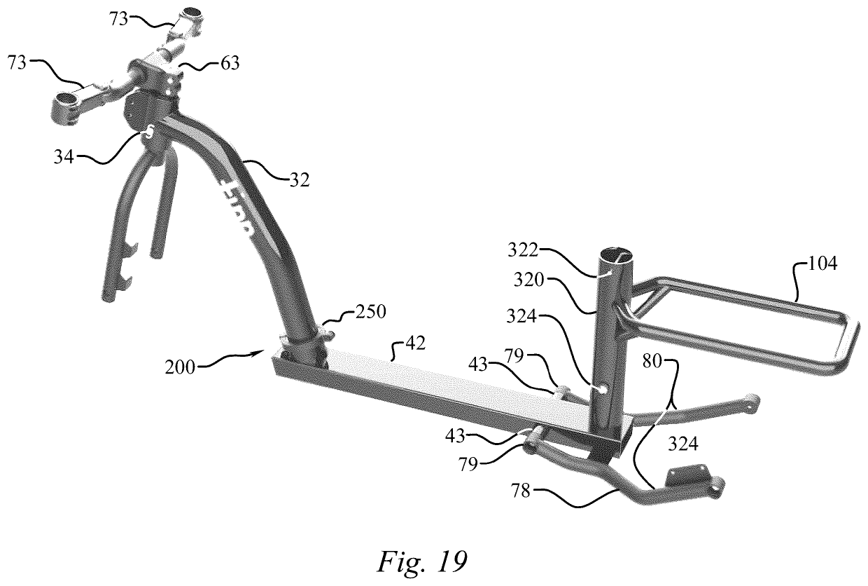

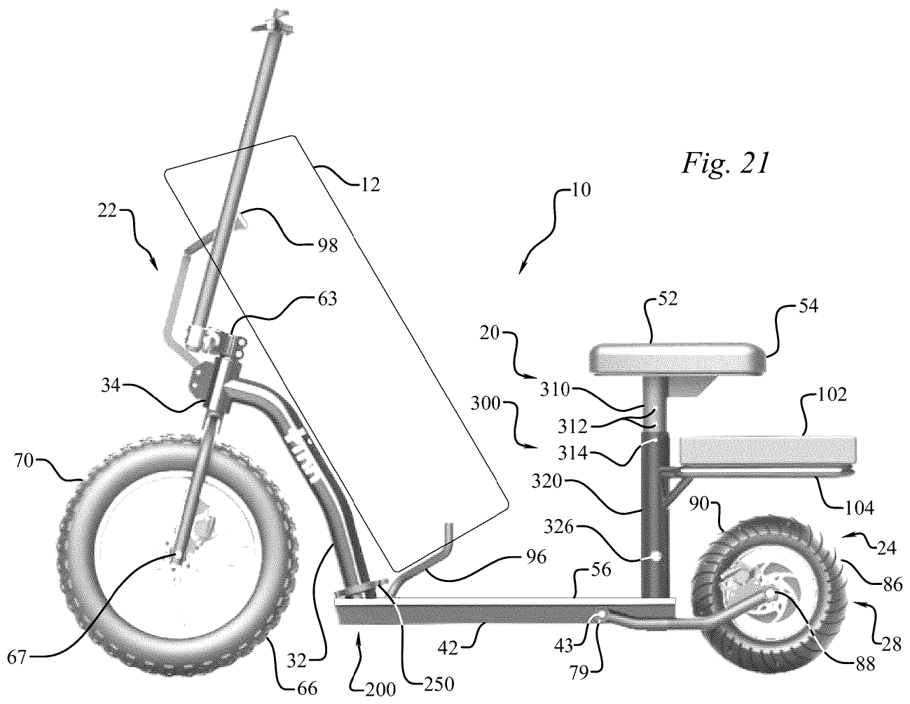

In the current embodiment, the base segment (42), best seen in FIG. 19, forms the foundational support for a golf bag (12) and golfer or rider (13). A running board (56) is attached to the upper surface of the base segment (42), best seen in FIGS. 15 and 21. A set of bag bottom rods (96) which secures the bottom of a golf bag (12) are located on the upper surface of the running board (56) near the frame tube (32), as seen in FIGS. 12, 13, 15 and 21-23. The bag bottom rods (96) work in tandem with the upper bag cradle (98) to secure the golf bag (12) to the rideable cart (10). The SMH lower portion (320) of the personal support sba (20) is permanently connected to the base segment (42) on the opposite side of from the frame tube (32), seen in FIG. 19. Additionally, base segment pivot rods (43) are permanently connected to the base segment (42) and allow a rear fork (78) to attach to the base segment (42) by rear fork pivots (79) located on a pair of rear fork arms (80), seen in FIG. 19.

The current embodiment of rear wheel sba (24) may include a rear fork (78) having a pair of rear fork arms (80), rear fork pivots (79) located on the front portion of the rear fork arms (80), a rear wheel (86) having a rear axle (88) that is connected to the rear portion of the rear fork arms (80), a rear tire (90), a rear brake (116), and a motive sba (28), seen in FIGS. 12, 13, 16, 17, 21 and 23. The rear fork pivots (79) are mounted and partially rotate on the base segment pivot rods (43), as seen in FIGS. 19, 21 and 23. Additionally, the rear fork (78) may have a shock absorber bracket (50) that is connected to each of the rear fork arms (80), and connects to the shock distal end (420), illustrated in FIG. 17. The rear tire (90) in one embodiment may be a typical pneumatic tire, while in another embodiment it may be a tubeless or non-pneumatic tire that may be solid, foam filled, or airless tires that use polymer spokes to maintain the tire's shape and structural integrity. The rear brake (116), in one embodiment, may be a disc caliper style brake, with the caliper mounted to one of the rear fork arms (80) and the disc mounted on the rear wheel (86), best seen in FIGS. 16, 17 and 23. Another embodiment of the rear brake (116) may use a shoe and brake drum system, not shown in the drawings. Regenerative braking, which slows the rideable cart (10) by converting movement into electricity, may also be utilized as the rear brake (116) or as a part thereof, not illustrated. Further, the rear brake (114) may be mechanically, pneumatically, hydraulically or electrically connected to, and actuated by, the brake actuator (110) which may be located on one of the handle bars (72) in one embodiment, as seen in FIG. 13, and maybe located on a foot switch in another embodiment, not shown in the drawings.

The motive sba (28) maybe located within the perimeter of the rear wheel (86) in one embodiment of the rideable cart (10), as illustrated in FIG. 16. Additionally, in another embodiment, not shown in the drawings, the motive sba (28) may be mounted to one side of the rear wheel (86) and the motive sba (28) body may be fixed to one of the rear fork arms (80) and the motive sba (28) drive shaft coupled to the rear axle (88). Furthermore, the rideable cart (10), motive sba (28) may be, but not limited to, a direct current (DC) brushed motor, an out-runner type brushless DC motor, also known as a hub-motor, an in-runner type brushless DC motor, a permanent magnet synchronous motor, a three phase alternating current (AC) induction motor, or a switched reluctance motor. DC brushed motors have high starting torque, and utilize a commutator and brush arrangement which switches the magnetic field of the armature. However, DC brushed motors are generally high maintenance because their brushes must be periodically replaced.

Out-runner type brushless DC motors do not suffer from the maintenance issues of DC brushed motors since it lacks the commutator and brush arrangement found in DC brushed motors. In brushless DC motors, the commutation is done electronically. Additionally, the rotor of the motor is present outside and the stator is present inside and the wheel is directly connected to the exterior rotor. Out-runner type brushless DC motors do not require external gear systems, but some may have an inbuilt planetary gearing system.

In-runner type brushless DC motors have the rotor located inside and the stator is outside like conventional motors. However, this results in the need of an external transmission system to convey power to the driving wheel or wheels. The in-runner type brushless DC motors also have expensive permanent magnets attached to the rotor. If in-runner type brushless DC motors are overloaded, it over heats the magnets and reduces their operating lifespan.

Permanent magnet synchronous motors are similar to brushless DC motors in that they have permanent magnets located on the rotors and have similar performance and efficiencies as brushless DC motors. The biggest difference between permanent magnet synchronous motors and brushless DC motors is that permanent magnet synchronous motors produce a sinusoidal back electric and magnetic fields (EMF). Whereas, brushless DC motors found in out-runner, and in-runner type brushless DC motors produce trapezoidal back EMF.

Three phase AC induction motors lack the high starting torque of DC brushed and brushless motors when operated with fixed voltage and fixed frequency operation. However, the lack the high starting torque of three phase AC induction motors can be mitigated by using a variable frequency drive system to drive the motors, allowing maximum torque when the motors start. Unfortunately, induction motors using a variable frequency drive systems require complex inverter circuits which increases the complexity and cost.

Switched reluctance motors are a type of variable reluctance motors which are not only simple in construction but also tough. The rotors found in switched reluctance motors utilize laminated steel and lacks windings and permanent magnets. As a result, rotor inertia of the motor is reduced during periods of high acceleration. Unfortunately, switch reluctance motors require complex and costly control and switching electronics to drive the motor.

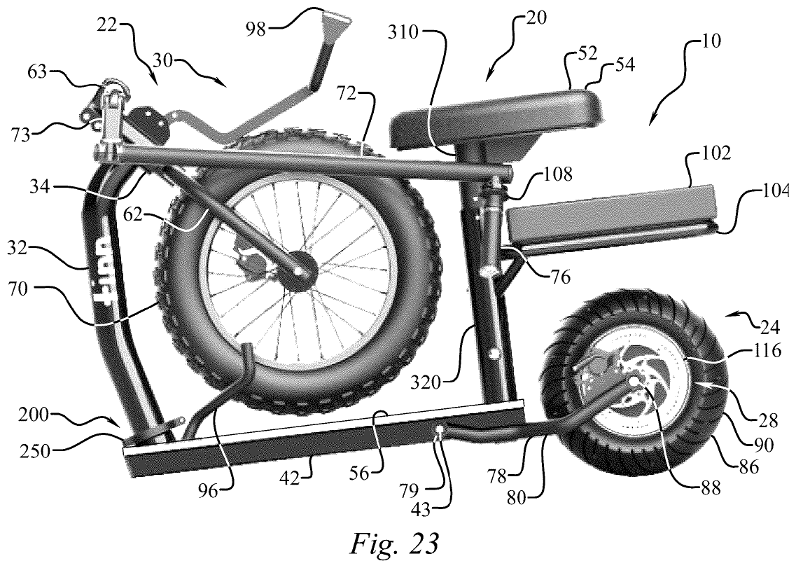

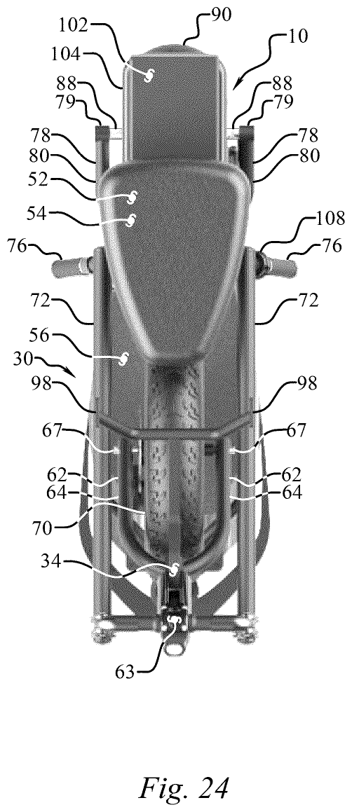

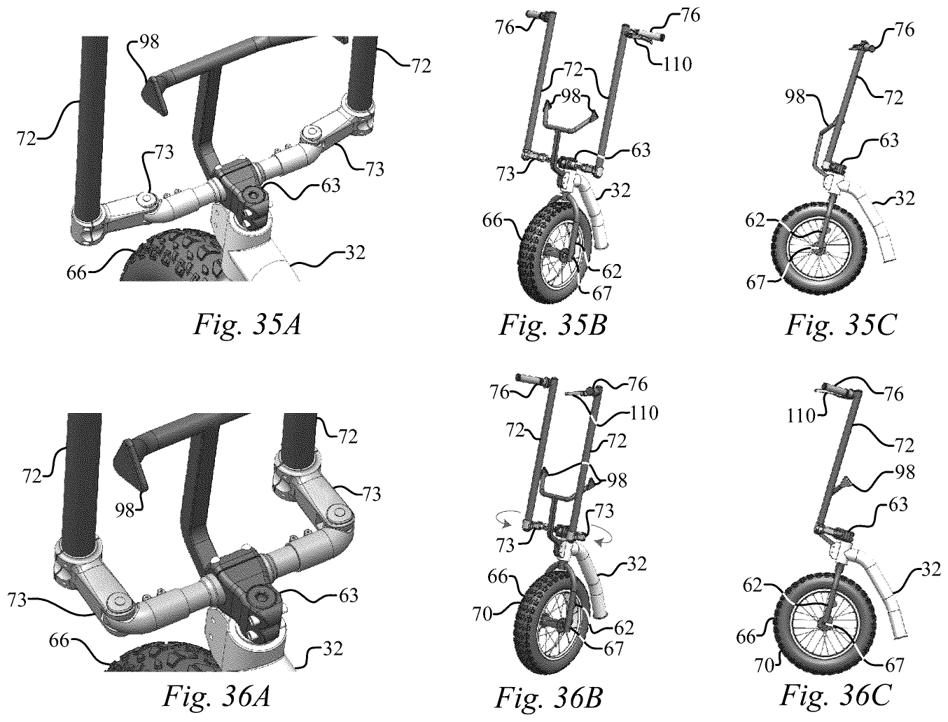

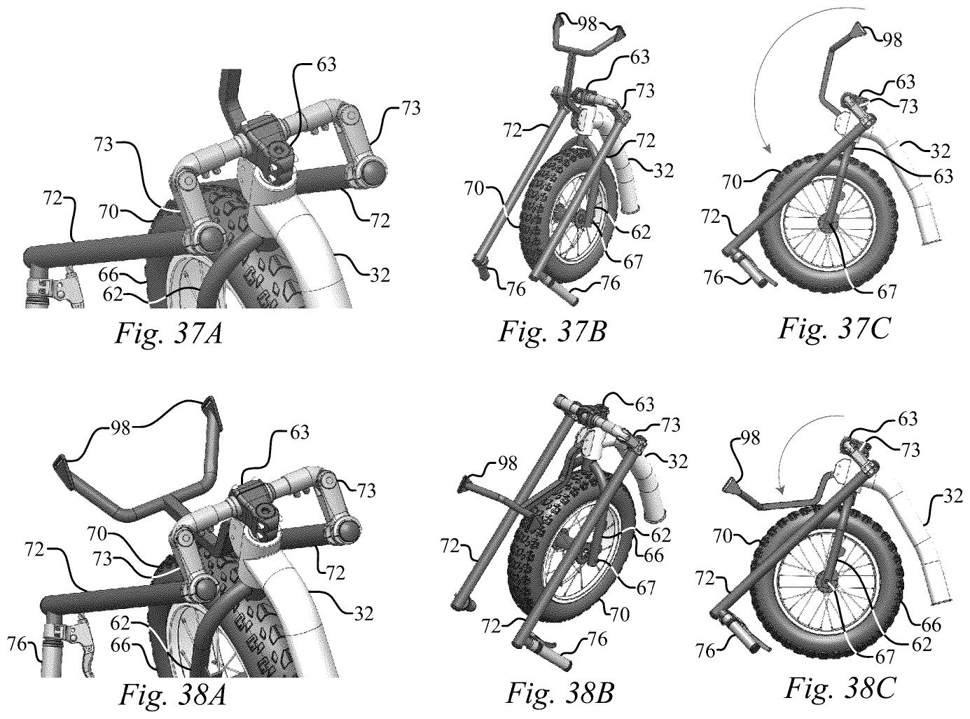

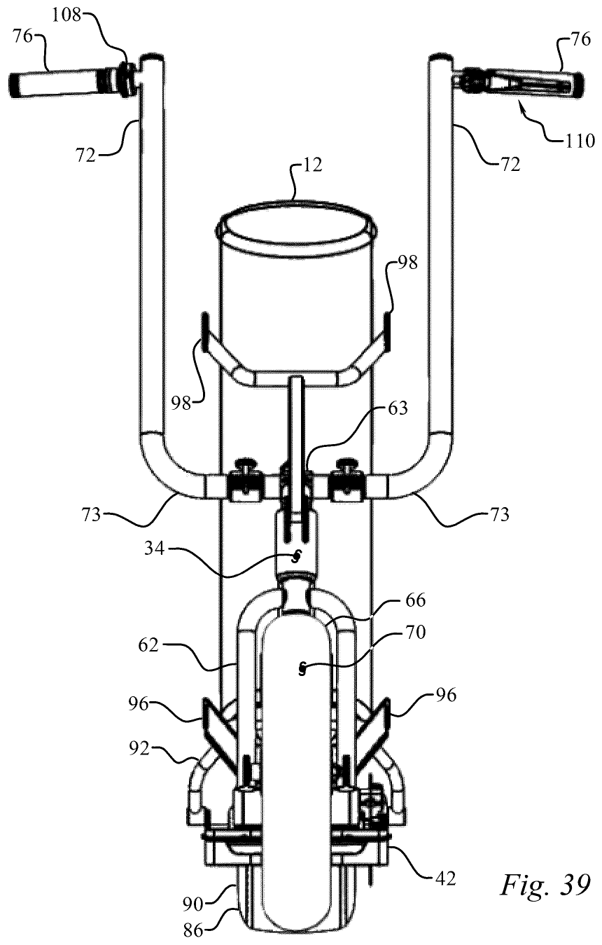

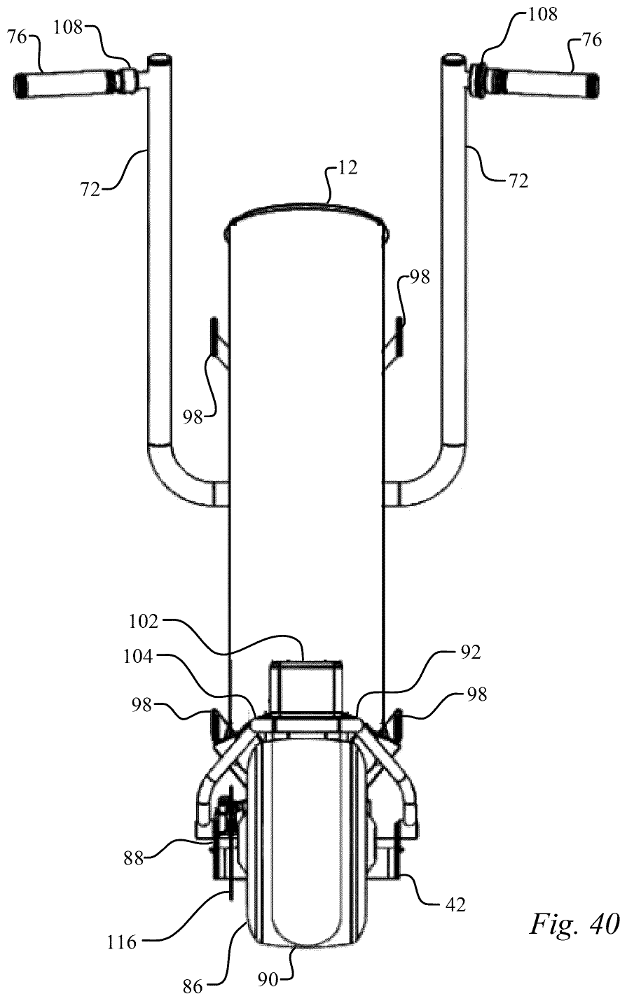

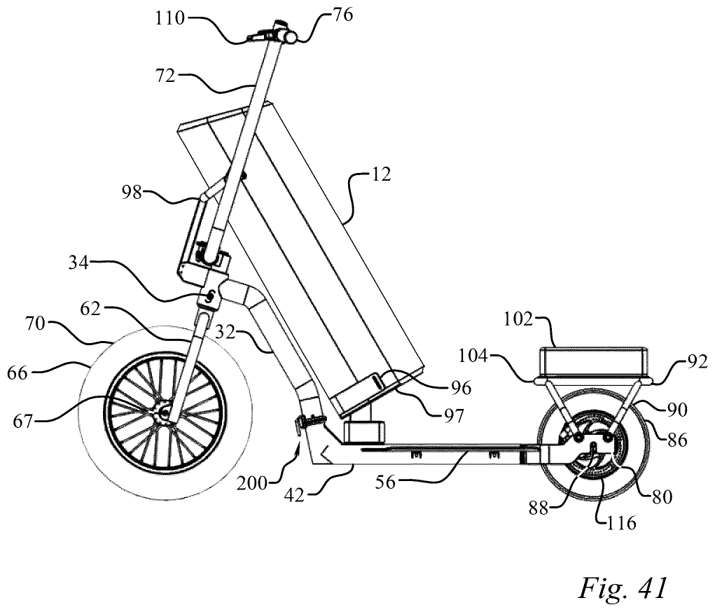

The current embodiment of rideable cart (10) may be configured to fold into a storage mode (30) for transport or storage, as seen in FIGS. 23, 24 and 35A-38C. FIG. 35A-35C show the rideable cart (10) in a state ready for usage by a golfer or rider (13), with the pivot tubes (73) locked outwards, thereby preventing the handlebars (72) from rotating about a vertical axis. Next, in FIGS. 36A-36C the pivot tubes (73) are in an unlocked state and the handlebars (72) have been rotated forward about a vertical axis. In FIGS. 37A-37C, the steering bracket (34) is in an unlocked state allowing the handlebars (72) to rotate about a horizontal axis forward. FIGS. 38A-38C show an unlocked upper bag cradle (98) that is rotated about a horizontal axis forward. FIGS. 23 and 24 shows the rideable cart (10) in a storage mode (30) state with the frame tube (32) being rotated 180 degrees following the preceding steps.

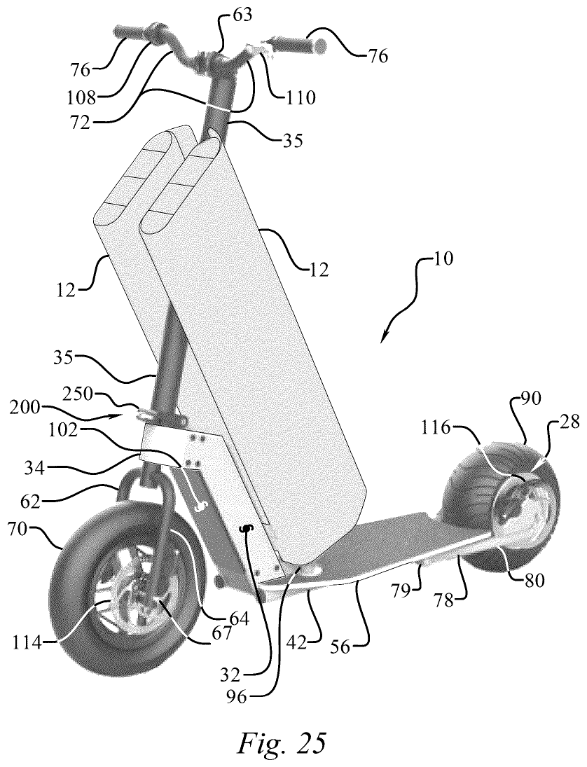

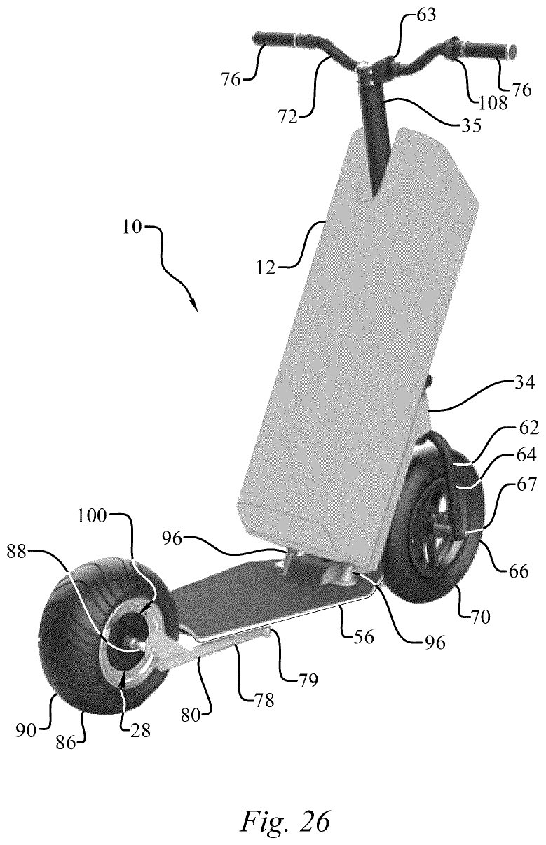

Now addressing a rideable cart (10) embodiment, as seen in FIGS. 25 and 26, which may have a pair of handlebars (72) with a pair of handle grips (76), a control unit (108) which allows a golfer or rider (13) to control the speed of the rideable cart (10), a brake actuator (110), a steering bracket (34) that connects the pair of handlebars (72) to a steering column (35). Furthermore, the current embodiment of rideable cart (10) may further have a connector assembly (200), seen in FIG. 25, which may further include a locking clamp (250), that may further include a locking clamp screw (252), which releasably connects the steering column (35) to a portion of a front fork bracket (63) which passes through a frame tube (32). The front fork bracket (63) connects to a front fork (62) having a pair of front fork arms (64), illustrated in FIG. 25. The current embodiment of rideable cart (10) may further have a front wheel (66) having a front tire (70) and a front axle (67) that connects to the front fork (62), and may further include a front brake (114), as seen in FIG. 25. The front brake (114), in one embodiment, may be a disc caliper style brake, with the caliper mounted to one of the front fork arms (64) and the disc mounted on the front wheel (66). Another embodiment of the front brake (114) may use a shoe and brake drum system, not shown in the drawings. Additionally, a regenerative braking system, which slows the rideable cart (10) by converting momentum into electricity, may also be utilized as the front brake (114) or as a part thereof, not illustrated. Further, the front brake (114) may be mechanically, pneumatically, hydraulically or electrically connected to and actuated by the brake actuator (110). Additionally, the frame tube (32) may also house a rechargeable battery (102) and may be permanently attached to one or more base segments (42), as seen in FIG. 25. A running board (56) may be located on the one or more base segments (42) and provides a place for a golfer or rider (13) to stand while using the rideable cart (10). Further, at least on bag bottom rods (96) may be located on the upper side of the running board (56) and couples with a bottom portion of a golf bag (12) to help stabilize and hold it in place, best seen in FIG. 26. The golf bag (12) in this embodiment is configured to be held at the bottom of the golf bag (12) by the bag bottom rods (96), and the top of the bag is configured to straddle the steering column (35), seen in FIGS. 25 and 26. Additionally, the current embodiment of rideable cart (10) may have a rear fork (78) having rear fork arms (80) each having rear fork pivots (79) that may attach to the one or more base segments (42). Further, the rear fork pivots (79) allow the rear fork (78) to rotationally pivot in relation to the one or more base segments (42), thereby acting as a rear suspension system. The rear portion of the rear fork (78) attaches to a rear axle (88) located on a rear wheel (86). Additionally, the rear wheel (86) may have a rear tire (90), a rear brake (116) and a motive sba (28). The rear brake (116), in one embodiment, may be a disc caliper style brake, with the caliper mounted to one of the rear fork arms (80) and the disc mounted on the rear wheel (86). Another embodiment of the rear brake (116) may use a shoe and brake drum system, not shown in the drawings. Additionally, a regenerative braking system, which slows the rideable cart (10) by converting momentum into electricity, may also be utilized as the rear brake (116) or as a part thereof, not illustrated. The rear brake (116) may be mechanically, pneumatically, hydraulically or electrically connected to and actuated by the brake actuator (110). The rideable cart (10) motive sba (28) may be, but not limited to, a direct current (DC) brushed motor, an out-runner type brushless DC motor, also known as a hub-motor, an in-runner type brushless DC motor, a permanent magnet synchronous motor, a three phase alternating current (AC) induction motor, or a switched reluctance motor.

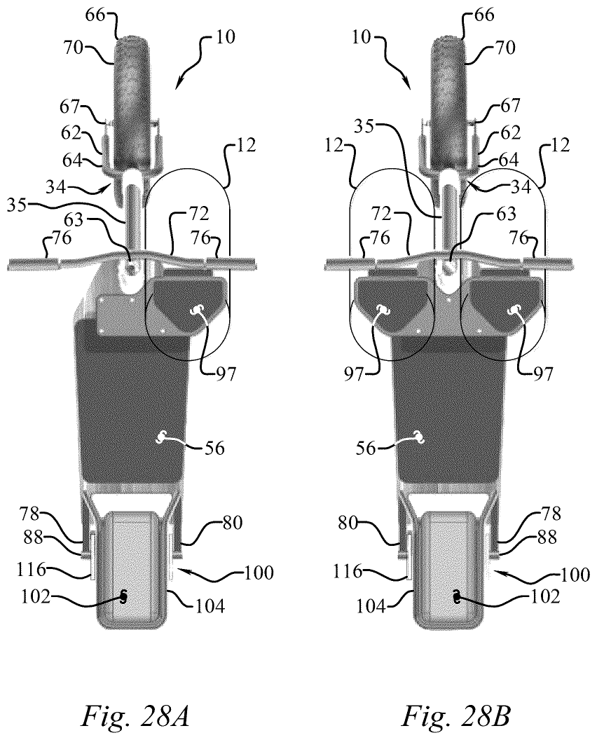

Now addressing a rideable cart (10) embodiment, as seen in FIGS. 27-28B, which may have a pair of handlebars (72) with a pair of handle grips (76), a control unit (108) which allows a golfer or rider (13) to control the speed of the rideable cart (10), a brake actuator (110), a steering bracket (34) that connects the pair of handlebars (72) to a steering column (35), and at least one a upper bag cradle attached to the steering column (35), as seen in FIG. 27. Furthermore, the steering column (35) may connect to a portion of a front fork bracket (63) that passes through a frame tube (32), also seen in FIG. 27. The front fork bracket (63) connects to a front fork (62) having a pair of front fork arms (64). The current embodiment of rideable cart (10) may further have a front wheel (66) having a front tire (70) and a front axle (67) that connects to the front fork (62), seen in FIG. 27, and may further include a front brake (114), not illustrated. The front brake (114), in one embodiment, may be a disc caliper style brake, with the caliper mounted to one of the front fork arms (64) and the disc mounted on the front wheel (66). Another embodiment of the front brake (114) may use a shoe and brake drum system, not shown in the drawings. Additionally, a regenerative braking system, which slows the rideable cart (10) by converting momentum into electricity, may also be utilized as the front brake (114) or as a part thereof, not illustrated. Further, the front brake (114) may be mechanically, pneumatically, hydraulically or electrically connected to and actuated by the brake actuator (110). A running board (56) may be attached to a base segment (42) and provides a place for a golfer or rider (13) to stand while using the rideable cart (10) as seen in FIG. 27. Further, at least one bag support base (97) may be located on the upper side of the running board (56) and supports a bottom portion of a golf bag (12), as seen in FIGS. 27-28B. The golf bag (12) in this embodiment is configured to be held at the bottom of the golf bag (12) by the bag support base (97), and the top of the bag is configured to be held by the upper bag cradle (98), to help stabilize and hold it in place off to one side of the steering column (35), as seen in FIGS. 27 and 28A. Additionally, as seen in FIG. 28 B, the current rideable cart (10) embodiment may also be configured to carry two golf bags (12) positioned on each side of the steering column (35), seen in FIG. 28B. The current embodiment of rideable cart (10) may further include a rear fork (78) having rear fork arms (80) that may attach to the base segment (42), as seen in FIG. 27. The rear portion of the rear fork (78) attaches to a rear axle (88) located on a rear wheel (86). Additionally, the rear wheel (86) may have a rear tire (90), a rear brake (116) and a motive sba (28). The rear brake (116), in one embodiment, may be a disc caliper style brake, with the caliper mounted to one of the rear fork arms (80) and the disc mounted on the rear wheel (86). Another embodiment of the rear brake (116) may use a shoe and brake drum system, not shown in the drawings. Additionally, a regenerative braking system, which slows the rideable cart (10) by converting momentum into electricity, may also be utilized as the rear brake (116) or as a part thereof, not illustrated. The rear brake (116) may be mechanically, pneumatically, hydraulically or electrically connected to and actuated by the brake actuator (110). The rideable cart (10) motive sba (28) may be, but not limited to, a direct current (DC) brushed motor, an out-runner type brushless DC motor, also known as a hub-motor, an in-runner type brushless DC motor, a permanent magnet synchronous motor, a three phase alternating current (AC) induction motor, or a switched reluctance motor. Additionally, the current rideable cart (10) embodiment may further include a rear fender (92) that also acts as a battery cradle (104) which holds a rechargeable battery (102) as seen in FIG. 27. As seen in FIG. 235, the steering column (35) may incorporate an offset (136), which has an offset distance that is the distance of the steering column (35) from the wheel plane (WP). In one embodiment the offset distance is no more than 105% of the front tire width, and in further embodiments no more than 100%, 95%, or 90%. In another embodiment the offset distance is at least 35% of the front tire width, and at least 40%, 45%, 50%, or 55% in additional embodiments.

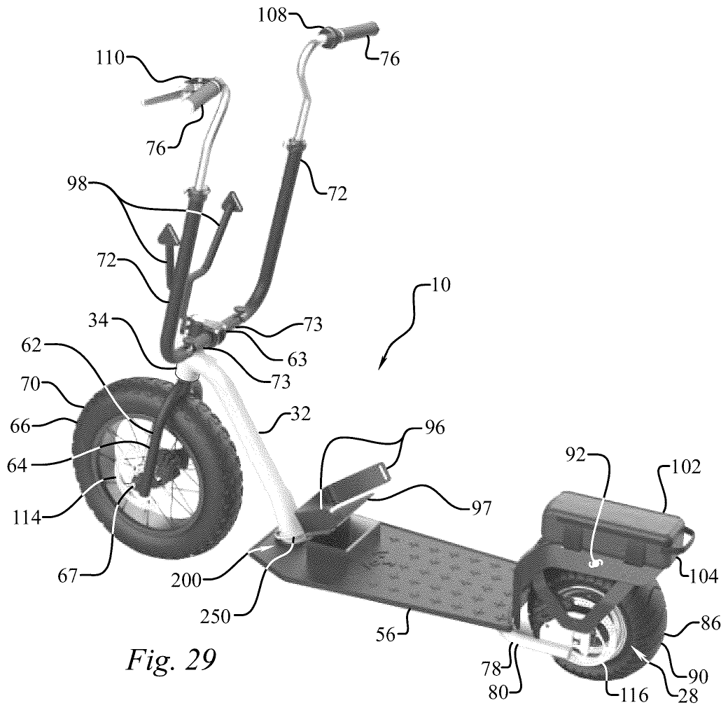

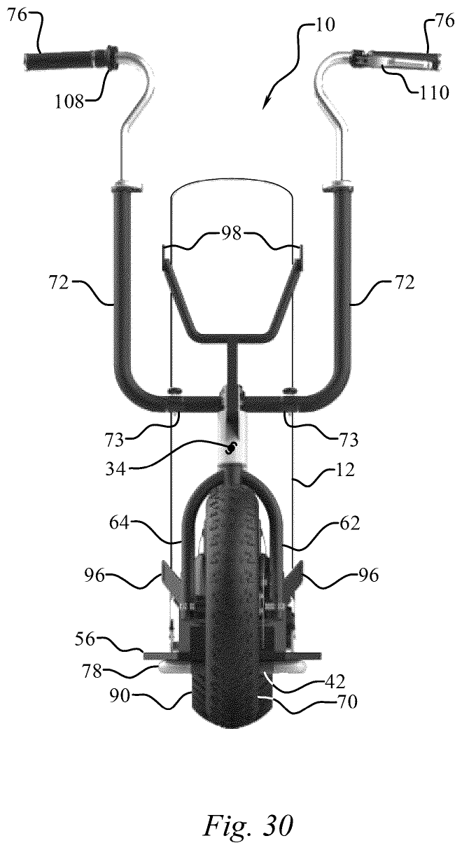

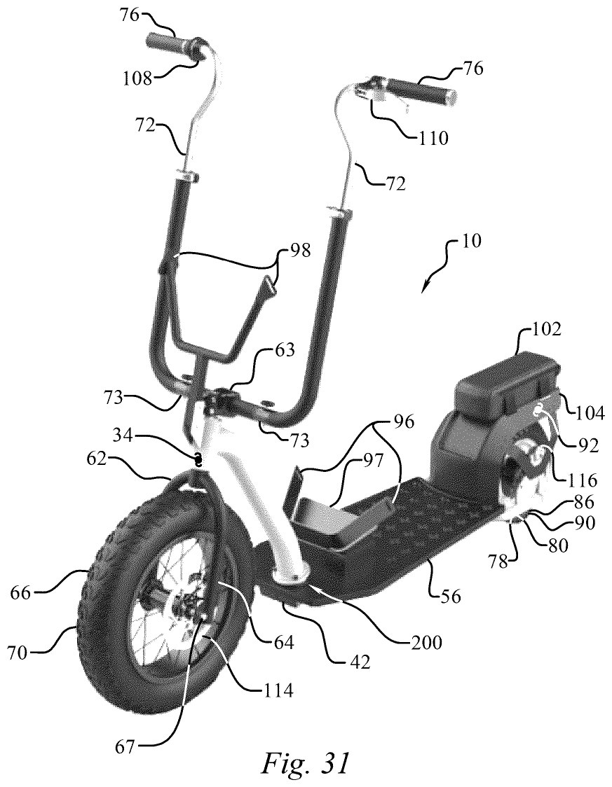

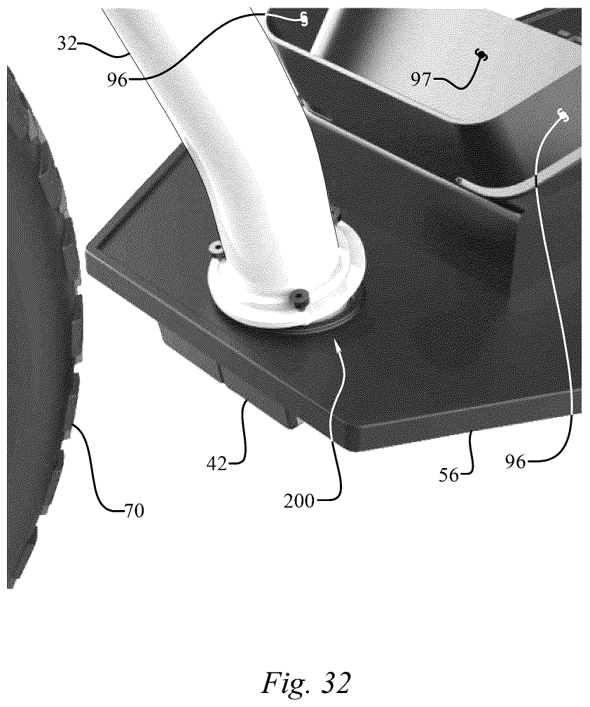

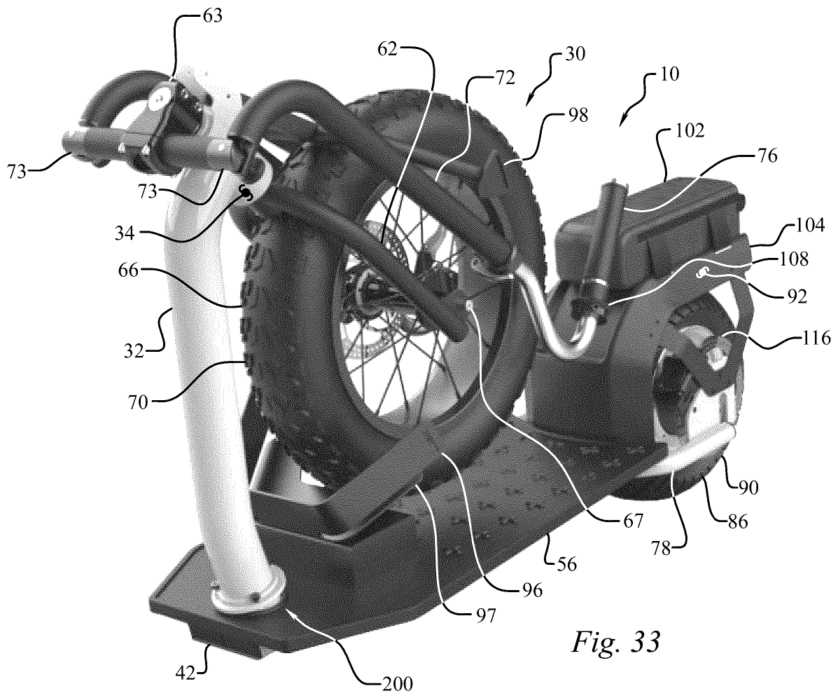

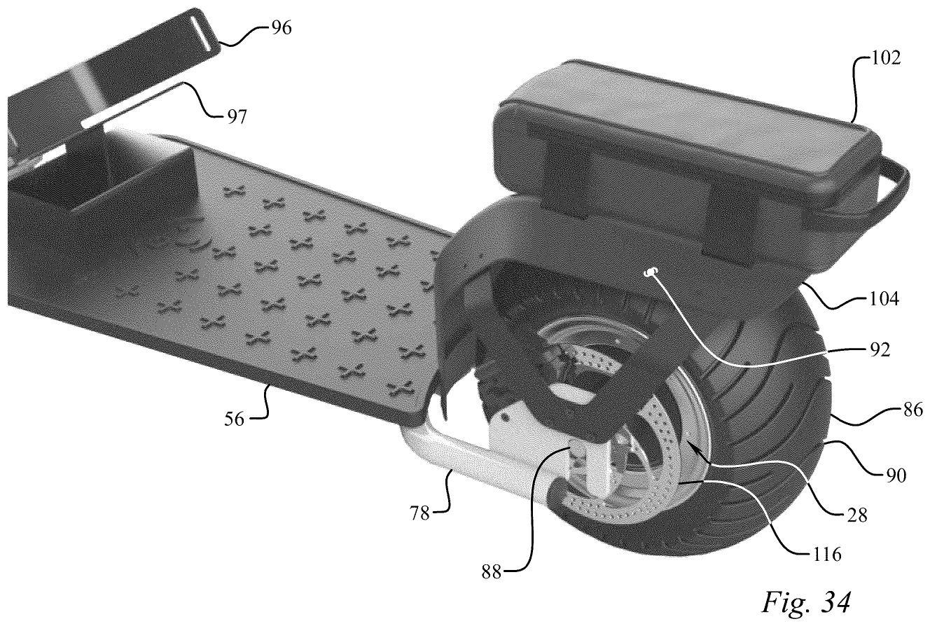

FIGS. 29-34 show another embodiment of a rideable cart (10), that may have a pair of handlebars (72) with a pair of handle grips (76), a pair of pivot tubes (73) with one side of each connected to the handlebars (72), a control unit (108) which allows a golfer or rider (13) to control the speed of the rideable cart (10), a brake actuator (110), a steering bracket (34) that connects to the pivot tubes (73) opposite of the handlebars (72), and a rechargeable battery (102) that is fixed to a battery cradle (104) that also serves as a rear fender (92), as seen in FIG. 29. Furthermore, the current embodiment of rideable cart (10) may further include a connector assembly (200), seen in FIGS. 29, 31-33, which may further include a locking clamp (250) which releasably connects a frame tube (32) to a base segment (42), best seen in FIG. 32. The front fork bracket (63) connects to a front fork (62) having a pair of front fork arms (64). The current embodiment of rideable cart (10) may further have a front wheel (66) having a front tire (70) and a front axle (67) that connects to the front fork (62), seen in FIG. 29, and may further include a front brake (114), best seen in FIGS. 29, and 31. The front brake (114), in one embodiment, may be a disc caliper style brake, with the caliper mounted to one of the front fork arms (64) and the disc mounted on the front wheel (66). Another embodiment of the front brake (114) may use a shoe and brake drum system, also not shown in the drawings. Additionally, regenerative braking, which slows the rideable cart (10) by converting movement into electricity, may also be utilized as the front brake (114) or as a part thereof, not illustrated. Further, the front brake (114) may be mechanically, pneumatically, hydraulically or electrically connected to and actuated by the brake actuator (110). A running board (56) may be fixed upon a base segment (42) and provides a place for a golfer or rider (13) to stand while using the rideable cart (10). Further, the bag bottom rods (96) may be located to each side of a bag base support (97) that is fixed to the upper side of the running board (56) and cradles and supports a bottom portion of a golf bag (12). The golf bag (12) in this embodiment is configured to be supported at the bottom of the golf bag (12) by the bag bottom rods (96) and the bag base support (97) while the top of the bag is configured to be secured in a upper bag cradle (98), as seen in FIGS. 29-31. Additionally, the current embodiment of rideable cart (10) may have a rear fork (78) having rear fork arms (80) that may attach to the base segment (42). In another variation of this embodiment, the rear fork arms (80) may have rear fork pivots (79) that allow the rear fork (78) to rotationally pivot in relation to the base segment (42), thereby acting as a rear suspension system. The rear portion of the rear fork (78) attaches to a rear axle (88) located on a rear wheel (86), best seen in FIG. 34. Additionally, the rear wheel (86) may have a rear tire (90), a rear brake (116) and a motive sba (28), illustrated in FIG. 29. The rear brake (116), in one embodiment, may be a disc caliper style brake, with the caliper mounted to one of the rear fork arms (80) and the disc mounted on the rear wheel (86). Another embodiment of the rear brake (116) may use a shoe and brake drum system, not shown in the drawings. Additionally, regenerative braking, which slows the rideable cart (10) by converting movement into electricity, may also be utilized as the rear brake (116) or as a part thereof, not illustrated. The rear brake (116) may be mechanically, pneumatically, hydraulically or electrically connected to and actuated by the brake actuator (110). The rideable cart (10), motive sba (28) may be, but not limited to, a direct current (DC) brushed motor, an out-runner type brushless DC motor, also known as a hub-motor, an in-runner type brushless DC motor, a permanent magnet synchronous motor, a three phase alternating current (AC) induction motor, or a switched reluctance motor.

The preceding embodiments may have further variations wherein the motive sba (28) may be configured in the front wheel (66) instead of the rear wheel (86). In other variations, the motive sba (28) may be configured in both the front wheel (66) and rear wheel (86). Additionally, the preceding embodiments may also have an additional rechargeable battery (102) located within the running board (56) to increase the total energy stored for usage. The preceding embodiments may yet further include an inductive charging system that would allow the rideable cart (10) to park on a charging station, thereby eliminating the need to physically plug the rideable cart (10) for charging the rechargeable battery (102).

This application incorporates U.S. Ser. No. 18/378,643, filed Oct. 10, 2023, by reference in its entirety.

Many modifications to the above embodiment may be made without altering the nature of the invention. The dimensions and shapes of the components and the construction materials may be modified for particular circumstances or types of bags to be carried.

While various embodiments have been described above, it should be understood that they have been presented by way of example only, and not as limitations. In view of the many possible embodiments to which the principles of this disclosure may be applied, it should be recognized that the illustrated embodiments are only preferred examples and should not be taken as limiting the scope of the inventions. Rather, the scope of the invention is defined by the following claims. We therefore claim all that comes within the scope and spirit of these claims. Whereas the invention has been described in connection with representative embodiments, it will be understood that the invention is not limited to those embodiments. On the contrary, the invention is intended to encompass all modifications, alternatives, and equivalents as may fall within the scope of the invention, as defined by the following claims.

### INDUSTRIAL APPLICABILITY

The rideable golf bag cart/cycle 10 of the present invention is intended for use primarily by golfers who desire physical exercise along with maximum convenience and safety while transporting a golf bag 12 and a rider 13 during a round of golf. The cart/cycle 10 is relatively lightweight and is suitable for transport in, or on, an automobile. Like any cycle having two wheels, the cart/cycle 10 is does require balancing by the rider 13 when in motion and tip-prevention by the kickstand 50 when not attended. The general symmetry of the cart/cycle 10 about the longitudinal plane 11 substantially aids in keeping the unit balance.

For typical use, the riding golf bag cart/cycle 10 will be in a rest position (collapsed mode 30) with the motor 108 off and the kickstand 50 activated. The rider 13 (or a worker) will then slide the golf bag 12 bottom to rest against and on the restraints defined by the bag bottom cradle 90, the pair of bag bottom wings 91, and/or the seat tube 38. The upper portion of the golf bag 12 will rest against the upper bag cradle 92 which will provide vertical support and at least some lateral restraint. The golf bag 12 will be maintained to be centered on the longitudinal plane 11 (balance-centered) to rest at about an optimal thirty degree angle from horizontal such that golf clubs will extend forward and upward over the front wheel 66 for easy access. The rider 13 will adjust the seat 52 on the mounting bracket 56 to the proper height, and mount the cart/cycle 10 to sit upon the seat 52. The legs of the rider 13 will straddle the bottom extent of the golf bag 12 and extend downward to the pedals 96.

In some embodiments, in order to move forward, the seated rider 13 may set the control unit 116 via the off control 118 and manually propel the cart/cycle 10 in pedal mode by using the pedals 96. In motor assist mode the motor assist control 120 is utilized to activate the control unit 116 to start the electric motor 108 while continuing the pedal operation and using the throttle control 124 to select the amount of assisted power to be provided to the force manually provided by the rider 13. In motor-only mode the motor-only control 122 is utilized to activate the motor and activate the decoupler 114 and the throttle control 124 is set to control the speed of rotation of the rear wheel 86 to drive the cart/cycle 10 forward at the desired speed. The brake actuators 128 will be activated to use the brake(s) 130 to slow or stop the travel when needed (such as on downslopes or on reaching the destination location). The rider 13 will then dismount, activate the kickstand 50 (or lean the cycle 10 against an object such as a tree or bench), play the next stroke(s) and repeat the process to proceed to the next location.

When the round is over, the golfer simply: dismounts; activates the kickstand 60 (or parks in a designated spot which prevents tipping); and removes the golf bag 12 from the cart 10, rotates the handlebars 72 or front wheel to the compact mode 30, and/or slides the rear wheel toward the front wheel to the compact mode 30, if desired, and either stores or transports the cart/cycle 10 to a storage location.

The extreme convenience, ease of operation, relative compactness, and light weight of the inventive cart/cycle 10 make it a joy to own and use and a desirable accessory for any golfer who wishes to traverse the course without carrying the weight of the bag. The wide and relatively soft front tire 70 and rear tire 86 minimize disruption of the turf on the course and facilitate access to the areas of the course upon which powered units are permitted.

For the above, and other, reasons, it is expected that the collapsible riding golf bag cart/cycle 10 of the present invention will have widespread industrial applicability. Therefore, it is expected that the commercial utility of the present invention will be extensive and long lasting.

We claim:

1. A motor-assisted rideable bag transport cart, comprising:
a cycle frame supporting a front wheel, a rear wheel aligned with the front wheel, and a seat;
a steering subassembly including a right handlebar and a left handlebar rotatably coupled to the cycle frame and configured to turn the front wheel;
an electric motor for providing rotation of said rear wheel, said electric motor being controlled by a control subassembly; and
a bag support subassembly on said cycle frame adapted to support and position a bag so that a portion of the bag extends over a portion of the front wheel.

2. The bag transport cart of claim 1, wherein the bag support subassembly includes a bag top support that is stationary with respect to the handlebars, with a portion of the bag top support located above an elevation of a top of the front wheel.

3. The bag transport cart of claim 2, wherein a portion of the bag top support is located vertically above a portion of the front wheel.

4. The bag transport cart of claim 3, wherein the bag support subassembly includes a bottom bag support located below an elevation of the seat.

5. The bag transport cart of claim 4, wherein at least a portion of the bag top support is located forward of the handlebars.

6. The bag transport cart of claim 5, wherein the right and left handlebars are pivotable such that they may be rotated downward about said front wheel to a collapsed position.

7. The bag transport cart of claim 6, wherein in the collapsed position the right and left handlebars are at an elevation below the top of the front wheel rotate and above a bottom of the front wheel.

8. The bag transport cart of claim 6, wherein a pair of fork arms separately attach to a fork bracket and the front wheel.

9. The bag transport cart of claim 4, wherein the right and left handlebars are individually coupled to a fork bracket.

10. A pedal powered bag transport cycle comprising;
a cycle frame having a front wheel, a rear wheel aligned with the front wheel, a seat, and handlebars for steering including a right handlebar and a left handlebar, wherein the right and left handlebars are rotatably coupled to the cycle frame;
a lower bag support and an upper bag support mounted on said frame to support and position a bag so that (a) the right handlebar and the left handlebar rotate relative to the stationary bag, and (b) a portion of the bag extends over a portion of the front wheel; and
a pedal subassembly including a pair of opposing pedals operatively joined to the rear wheel to move the cycle forward.

11. The bag transport cycle of claim 10, wherein a portion of the upper bag support is located vertically above a portion of the front wheel and the lower bag support is below an elevation of the seat.

12. The bag transport cycle of claim 11, wherein at least a portion of the upper bag support is located forward of the handlebars.

13. The bag transport cycle of claim 12, wherein the right and left handlebars are individually coupled to a fork bracket.

14. The bag transport cycle of claim 12, further including a motor for driving said rear wheel, wherein the pedal subassembly and the motor may be operated individually or in combination.

15. A bag transport cart/cycle for transporting a rider and a bag, comprising:
a cycle frame and having a front wheel and a rear wheel aligned with the front wheel, and a seat;
a lower bag support and an upper bag support, stationary with respect to the frame, for supporting a bag, with the lower bag support located at a lower support elevation and closer to the rear wheel than the front wheel, and the upper bag support is located at an upper support elevation and closer to the front wheel than the rear wheel, with the upper support elevation greater than the lower support elevation, and located such that a portion of the bag extends over a portion of the front wheel;
a right handlebar and a left handlebar, which rotate relative to the stationary bag and steer the front wheel; and
a highest point on the upper bag support is at an elevation above a highest point on the front wheel and below a highest point on the right and left handlebars, and a portion of the upper bag support is vertically above a portion of the front wheel; and
a motor for driving said rear wheel.

16. The bag transport cart/cycle of claim 15, wherein at least a portion of the upper bag support is located forward of the handlebars.

17. The bag transport cart/cycle of claim 15, further including a pedal subassembly including a pair of opposing pedals operatively joined to the rear wheel to move the cart/cycle forward.

18. The bag transport cart/cycle of claim 15, wherein the right and left handlebars are pivotable such that they may be rotated downward about said front wheel to a collapsed position.

19. The bag transport cart of claim 18, wherein in the collapsed position the right and left handlebars are at an elevation below the top of the front wheel rotate and above a bottom of the front wheel.

20. The bag transport cart/cycle of claim 19, wherein a pair of fork arms separately attach to a fork bracket and the front wheel.
